(19) United States
(12) Patent Application Publication
(10) Pub. No.: US 2026/0179842 A1
(43) Pub. Date: Jun. 25, 2026

(54) HIGH TEMPERATURE DIELECTRIC POLYMERS AND FILMS

(71) Applicants: THE SCRIPPS RESEARCH INSTITUTE, La Jolla, CA (US); THE REGENTS OF THE UNIVERSITY OF CALIFORNIA, Oakland, CA (US)

(72) Inventors: Yi LIU, San Ramon, CA (US); K. BARRY SHARPLESS, La Jolla, CA (US); Peng WU, San Diego, CA (US); He LI, Union City, CA (US); Hongbo ZHENG, San Diego, CA (US)

(73) Assignees: THE SCRIPPS RESEARCH INSTITUTE, La Jolla, CA (US); THE REGENTS OF THE UNIVERSITY OF CALIFORNIA, Oakland, CA (US)

(21) Appl. No.: 19/124,655

(22) PCT Filed: Oct. 27, 2023
(86) PCT No.: PCT/US2023/036140

§ 371 Date: Apr. 25, 2025

Related U.S. Application Data
(60) Provisional application No. 63/420,407, filed on Oct. 28, 2022.

(51) Int. Cl. H01G 4/14; C08G 75/24; H01G 4/33

(52) U.S. Cl. CPC H01G 4/14; C08G 75/24; H01G 4/33

(57) ABSTRACT

Dielectric polymer films and electronic energy storage devices (e.g., thin film capacitors) comprising the dielectric polymer films are described herein. The polymer films comprise aromatic polysulfates and polysulfonates of Formula I, as described herein: [—O-A¹-O—S(O)₂—X¹-A²-X¹—S(O)₂—]ₙ (I). Preferred polymers have glass transition temperatures of at least about 120° C. (e.g., 150 to 330° C.), and are useful as dielectric materials in electrostatic energy storage devices such as polymer film capacitors, which can operate under harsh electrification conditions, e.g., high electric field and elevated temperatures.

### CROSS-REFERENCE TO RELATED APPLICATIONS

This application claims the benefit of U.S. Provisional Application No. 63/420,407 filed on Oct. 28, 2022, which is incorporated herein by reference in its entirety.

### STATEMENT OF GOVERNMENT LICENSE RIGHTS

This invention was made with government support from the United States Department of Energy, Grant No. DE-AC02-05CH11231, the National Institutes of Health, Grant No. R35GM139643, and the National Science Foundation, Grant No. CHE-1610987. The government has certain rights in this invention.

### FIELD OF INVENTION

This invention relates to polymers, to polymeric films, and to electrostatic energy storage devices, such as polymeric film capacitors.

### BACKGROUND

Advanced dielectric materials that store energy efficiently and operate effectively under elevated temperature and high electric field conditions are indispensable for rapidly advancing electrification in electronics and power systems. High capacity polymer dielectrics that operate with high efficiencies under harsh electrification conditions, i.e., high electric fields and elevated temperatures, are important components for advanced electronics and power systems. It is however fundamentally challenging to design polymer dielectrics that can reliably withstand demanding temperatures and electric fields, which necessitate the balance of key electronic, electrical and thermal parameters.

While polymer-based dielectrics exhibit intrinsic characteristics of lightweight, greater processability, flexibility, and voltage tolerance capability compared to inorganic dielectric ceramics, achieving simultaneous electrical and thermal endurance has been a yet-to-be-solved bottleneck for their industrial applications in electric vehicles (EVs), avionics, space, underground oil and gas explorations, and certain military applications. For high capacity electrostatic energy storage, polymer dielectrics with both high dielectric constant (k) and high dielectric breakdown strength (E_{b}) are desired, as the stored energy density of a linear dielectric material is proportional to the k and the square of E_{b}.

In addition to energy density, charge-discharge efficiency (η) is another important performance factor for practical electrostatic energy storage. At elevated temperatures, both E_{b} and n are adversely impacted and may drop precipitously. Such temperature-limited performance dependence is exemplified by the electrostatic film capacitors used in power inverters of hybrid EVs. The benchmark dielectric polymer, biaxially oriented polypropylene (BOPP), reportedly is limited to operating temperatures below 105° C. For its use in hybrid EVs, an accompanying cooling system is necessary to lower the working temperature from about 140° C. to about 70° C., in order to deliver a reliable energy storage performance, which adds extra mass and volume that compromise the energy efficiency of hybrid EVs.

In the pursuit for reliable high-temperature dielectric polymers, one strategy focuses on leveraging aromatic groups to offer polymers with high glass transition temperature (T_{g}, i.e., ≥150° C.), such as poly(ether ether ketone) (PEEK), polyetherimide (PEI), fluorene polyester (FPE) and polyimide (PI). Although thermomechanical stability can be satisfied in those high-T_{g} polymers, electrothermal stability remains poor under critical electric fields, even at operative temperatures way below their T_{g}. This liability is attributed primarily to the exponentially increased leakage current that is a uniform problem across polymer dielectrics with rising temperature and electric field strength. Consequently, when operating under high electric fields and elevated temperatures, the existing high-T_{g} polymers usually display poor n, e.g., 37.1% for PEEK and 48.6% for FPE, at 150° C. and 400 MV m⁻¹. Such performance deficits motivate the development of new polymer dielectrics that can achieve concurrent high energy density and high n at high temperatures. Large k, E_{b} and T_{g} as well as low leakage currents are the linked properties that need to coexist in these polymers. Despite considerable efforts towards this end, as represented by dipolar glass polymers with high k values, olefin-based polymers exhibiting large bandgaps, crosslinked polymers, molecular semiconductor-doped polymers, polymer blends, and polymer-nanofiller composites, balancing k, E_{b} and T_{g} remains a fundamental materials challenge since two or more of these parameters often are mutually restrictive.

In evaluating polymers for dielectric applications optical bandgap (E_{g}) is another useful tool. The bandgap of a material refers to the energy difference between its valence band (where electrons normally reside) and its conduction band (where electrons are free to move and conduct electricity). A wide bandgap implies a larger energy barrier between the valence and conduction bands. Electrons require a certain amount of energy to move from the valence band to the conduction band and participate in electrical conduction. Wide bandgap polymers generally exhibit higher electrical insulating strength compared to polymers with narrower bandgaps. In wide bandgap polymers, this energy barrier is higher, making it more difficult for electrons to gain the necessary energy and move freely. In addition, wide bandgap polymers can withstand higher electric fields before reaching this breakdown voltage. The ability to withstand higher voltages is very important for electrical insulating materials, as they must prevent unintended electrical conduction. For most electrically insulating polymers (dielectrics), their optical bandgap is inversely proportional to their glass transition temperature T_{g}. For dielectric polymers with T_{g} of about 150° C., an E_{g}>4.5 eV is desirable, T_{g} of about 200° C., an E_{g}>4 eV is desirable, and for polymers with a T_{g} of 250° C. or greater, an E_{g}>3.5 eV is desirable.

There is an ongoing need for polymer dielectric materials, particularly materials that are suitable for high temperature and high energy density applications. The materials described herein address this need.

### SUMMARY

Described herein are polysulfate and polysulfonate dielectric polymers and polymer films having useful properties for a variety of applications in electrostatic energy storage devices such as capacitors, and the like. The polymer films can comprise a single polymer or a blend of different polymers, as described herein below. In some embodiments, films comprising a blend of polymers can comprise two or more different polymers mixed and coated together into a single layer film. In some other embodiments, the films can comprise two or more layers in which different layers are formed from different polymers. The polysulfate and polysulfonate polymers described herein have high electrical insulating properties across a wide range of temperatures.

High capacity polymer dielectrics that operate with high efficiencies under harsh electrification conditions, i.e., high electric fields and elevated temperatures, are important components for advanced electronics and power systems. It is, however, fundamentally challenging to design polymer dielectrics that can reliably withstand demanding temperatures and electric fields, which necessitate the balance of key electronic, electrical and thermal parameters. As described herein, polysulfate- and polysulfonate-type polymers comprising pendant aryl groups, synthesized by the highly efficient sulfur (VI) fluoride exchange (SuFEx) method, serve as high-performing dielectric polymers that overcome such bottlenecks. Free-standing thin films of these polysulfates exhibit superior insulating properties and dielectric stability at elevated temperatures, which are further enhanced when oxide coatings are deposited on the surfaces of the films. Electrostatic film capacitors comprising the polysulfate films display a high breakdown strength (>700 MV m⁻¹), and an unexpectedly high discharged energy density of 8.64 J cm⁻³ at 150° C., outperforming state-of-the-art commercial and synthetic dielectric polymers and nanocomposites at such high temperatures. Related polysulfonate analogs of the polysulfates described herein have similar properties. Consequently, the polysulfate and polysulfonate polymers described herein provide reliable electrification and energy storage operations in harsh environments. Inclusion of Al₂O₃ nanoparticles in a film of polymer P3 (see FIG. 1, panel (a)) increased the breakdown strength relative to the polymer, per se.

In some embodiments, a high-temperature dielectric polymer film has a thickness in the range of about 1 to about 15 μm (e.g., about 2 to 5 μm), and the polymer has a glass transition temperature of at least about 120° C. (e.g., at least about 140° C.), a dielectric constant of at least about 3 (e.g., at least about 3.3) measured at 30° C. at a frequency of 10⁴ Hz, a dielectric loss tangent of no more than about 0.05 (e.g., no more than about 0.02, or 0.01) measured at 30° C. at a frequency of 10⁴ Hz. In some embodiments, the films have a charge-discharge efficiency of at least 80% at 600 MV m⁻¹ when measured at 150° C. and 10⁴ Hz.

Films of dielectric polymers described herein have excellent dielectric properties. In some embodiments, the films typically have a thickness in the range of about 1 to about 15 μm, e.g., about 2 to 5 μm, and/or comprise a polymer having a glass transition temperature (T_{g}) of at least about 120° C. (e.g., at least about 150, 160, 170, 180, 190, 200, 210, 220, 230, 240, 250, 260, 270, 280, 290, or 300° C.; for example, about 140 to about 330° C.).

The polymers described herein are represented by Formula I:

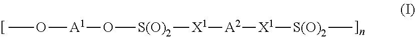

wherein:
A¹ is a first divalent aryl group;
A² is a second divalent aryl group;
X¹ is O or a covalent bond;
n is the average number of repeating units within the brackets of the formula and has a value sufficient to provide a number average molecular weight (Mₙ) of at least about 7,000 g mol⁻¹ (also referred to as Daltons); e.g., at least about 10,000, 15,000 20,000, 30,000, 50,000, 80,000, 100,000, 150,000, or 200,000 g mol⁻¹; as determined by size exclusion chromatography (SEC) using styrene-divinyl benzene columns, DMF/0.2% LiBr elution solvent, and polystyrene molecular weight standards; and
each divalent aryl group independently is unsubstituted or is substituted by one or more substituent selected from halogen (e.g., F, Cl, Br, and I), alkyl, aryl, arylalkyl, alkylaryl, alkoxy, and aryloxy.

Preferably the polydispersity index (PDI) of the polymer of Formula I is less than about 2.5, more preferably less than about 2.2, (e.g., less than about 2).

In some embodiments, A¹ is the same as A², and the polymers are homopolymers. In other embodiments, A¹ differs from A², and the polymers are AB-alternating copolymers.

In some embodiments, A¹ differs from A², A¹ is a divalent aryl group of formula -A³-X²-A³-; A² is divalent aryl group of formula -A⁴-X³-A⁴; A³ and A⁴ are divalent aryl (e.g., phenyl) moieties; X² is selected from S(O)₂, O, S, C(═O), a covalent bond, and Z(R¹)(R²); X³ is selected from S(O)₂, O, S, C(═O), a covalent bond, and Z(R³)(R⁴); Z is carbon or silicon (preferably carbon). R¹ is selected from the group consisting of aryl, arylalkyl, alkylaryl, and an alkyl comprising at least four carbons; and R² is selected from the group consisting of H, halogen, alkyl, aryl, arylalkyl, and alkylaryl. Alternatively, R¹ and R² together constitute a first divalent substituent which together with Z constitutes a 5-, 6-, or 7-membered hydrocarbon ring or heterocyclic ring. R³ is selected from the group consisting of aryl, arylalkyl, alkylaryl, and an alkyl comprising at least four carbons; and R⁴ is selected from the group consisting of H, halogen, alkyl, aryl, arylalkyl, and alkylaryl. Alternatively, R³ and R⁴ together constitute a first divalent substituent which together with Z constitutes a 5-, 6-, or 7-membered hydrocarbon ring or heterocyclic ring.

In some preferred embodiments, R¹ and R² together constitute the first divalent substituent, which comprises at least one aromatic moiety (an aromatic hydrocarbon or heterocyclic moiety) directly bonded to Z; the first divalent substituent and Z together constitute a 5-, 6-, or 7-membered hydrocarbon ring with the aromatic moiety fused to the hydrocarbon ring (e.g., a fluorene group and the like; see, e.g., Schemes 1 and 2, below), or the first divalent substituent and Z together constitute a 5-, 6-, or 7-membered heterocyclic ring with an aromatic moiety fused to the heterocyclic ring (e.g., a phthalide group and the like; see, e.g., Schemes 1 and 2, below).

In some preferred embodiments, R³ and R⁴ together constitute the second divalent substituent, which comprises at least one aromatic moiety (e.g., an aromatic hydrocarbon or heterocyclic moiety) directly bonded to Z; the second divalent substituent and Z together constitute a 5-, 6-, or 7-membered hydrocarbon ring with the aromatic moiety fused to the hydrocarbon ring (see, e.g., Schemes 1 and 2, below), or the second divalent substituent and Z together constitute a 5-, 6-, or 7-membered heterocyclic ring with the aromatic moiety fused to the heterocyclic ring (see, e.g., Schemes 1 and 2, below).

Some of the polymers of Formula I are polymers represented by polysulfates of Formula II and polysulfonates of Formula III:

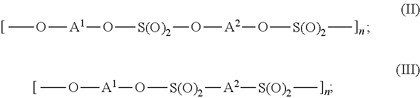

in which each A¹, A², and n is as defined in Formula I.

Another example of a polymer of Formula I is represented by Formula IV:

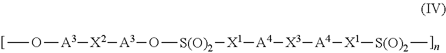

wherein:
A³ and A⁴ independently are divalent aryl moieties;
   X¹ is O or a covalent bond;
   X² is selected from S(O)₂, O, S, C(═O), a covalent bond, and Z(R¹)(R²);
   X³ is selected from S(O)₂, O, S, C(═O), a covalent bond, and Z(R³)(R⁴);
   Z is carbon or silicon (preferably carbon);
   R¹ is selected from the group consisting of alkyl (preferably an alkyl of at least four carbons), aryl, arylalkyl, and alkylaryl; R² is selected from the group consisting of H, halogen, alkyl, aryl, arylalkyl, and alkylaryl; or R¹ and R² together constitute a first divalent substituent which together with Z constitutes a 5-, 6-, or 7-membered hydrocarbon ring or heterocyclic ring, as described above for Formula I;
   R³ is selected from the group consisting of alkyl (preferably an alkyl of at least four carbons), aryl, arylalkyl, and alkylaryl; R⁴ is selected from the group consisting of H, halogen, alkyl, aryl, arylalkyl, and alkylaryl; or R³ and R⁴ together constitute a second divalent substituent which together with Z constitutes a 5-, 6-, or 7-membered hydrocarbon ring or heterocyclic ring as described above for Formula I; and
   and n has the same meaning as in Formula I.

In some preferred embodiments of Formula IV,
X² is Z(R¹)(R²); X³ is Z(R³)(R⁴); R¹ and R² together constitute a first divalent substituent, which comprises at least one aromatic moiety directly bonded to Z; and the first divalent substituent and Z together constitute a 5-, 6-, or 7-membered hydrocarbon ring fused to the aromatic moiety, or the first divalent substituent and Z together constitute a 5-, 6-, or 7-membered heterocyclic ring fused to the aromatic moiety; and
R³ and R⁴ together constitute a second divalent substituent, which comprises at least one aromatic moiety directly bonded to Z; the second divalent substituent and Z together constitute a 5-, 6-, or 7-membered hydrocarbon ring fused to the aromatic moiety, or the second divalent substituent and Z together constitute a 5-, 6-, or 7-membered heterocyclic ring fused to the aromatic moiety. The aromatic moieties of the first and second divalent substituents can be aromatic hydrocarbon groups or aromatic heterocyclic groups. See, e.g., Schemes 1 and 2, below for non-limiting examples of divalent substituents.

In some embodiments of Formula IV, X¹ is O. In yet other embodiments of Formula IV, X¹ is O and X² is Z(R¹)(R²). In some embodiments of Formula (VI), A³-X²-A³ is different from A⁴-X³-A⁴, while in other embodiments, A³-X²-A³ is identical to A⁴-X³-A⁴.

In some embodiments, the first divalent aryl group and/or the second divalent aryl group (A¹ and/or A²) are independently selected from the group consisting of divalent phenyl (—C₆H₄—), divalent naphthyl (—C₁₀H₆—), divalent anthracenyl (—C₁₄H₁₀—) divalent biphenyl (—C₆H₄—C₆H₄—), divalent binaphthyl (—C₁₀H₆—C₁₀H₆—), and divalent heteroaryl.

Preferred polymers of Formulas I, II, III, and IV are thermoplastic materials with excellent thermal properties, such as a high T_{g} of at least about 130° C. (preferably at least about 150° C.), and decomposition temperature of greater than 250° C., preferably greater than about 300° C.).

Coated dielectric films comprising a layer of an inorganic dielectric material on one or both faces of a dielectric polymer film are also described herein, wherein the dielectric polymer film comprises a polymer of Formula I. Non-limiting examples of such inorganic dielectric materials include, for example Al₂O₃, HfO₂, ZrO₂, SnN, TaN, Y₂O₃, TiO₂, ZnO, SnO₂, SiO₂, MgO, BN, AlN, and the like. A preferred inorganic dielectric material is Al₂O₃. Such inorganic dielectric materials can be deposited as a thin (e.g., about 1 to about 500 nm) layer on each face of the film by techniques such as atomic layer deposition.

An electrostatic energy storage device, as described herein, such as a capacitor, comprises a first conductive layer and a second conductive layer, with a layer of the polymeric dielectric film comprising at least one polymer of Formula I disposed between the conductive layers to constitute a multilayer structure. The layer of dielectric film electrically insulates the first and second conductive layers from each other. Preferably, the layer of polymeric dielectric film is a composite film including a layer of inorganic dielectric material (e.g., Al₂O₃) on at least one face of the polymer film, preferably on each face. The conductive layers, sometimes referred to as electrodes, are metal plates (e.g., metal foils) or a metalized coating of a metal such as aluminum, tantalum, niobium, gold, platinum, copper, and the like). In addition, capacitors typically include conductive leads contacting the electrodes so that the capacitor can be connected in an electrical circuit and/or a power supply.

Optionally, the polymer films can comprise fillers of high dielectric materials such as nanoparticles of Al₂O₃, HfO₂, ZrO₂, SnN, TaN, Y₂O₃, TiO₂, ZnO, SnO₂, TiO₂, SiO₂, MgO, BN, AlN, CaF₂, CaCO₃, BaTiO₃, SrTiO₃, ZrTiO₃, NaNbO₃ and the like.

Polymers of Formula I represent a class of high performing dielectrics. The tested polymers P1, P2 and P3 (see FIG. 1, panel (a)) exhibited desirable k (3.4-3.8), high E_{b} (≥650 MV m⁻¹) and high T_{g} (153-225° C.). This combination of physical characteristics endows thin films of the polymers of Formula I with superior dielectric and energy storage properties at elevated temperatures, with notably higher energy density and efficiency than other state-of-the-art commercial dielectric polymers. Moreover, upon coating of the films with nanometer layers of Al₂O₃, the E_{b} and electrostatic energy storage performance is further augmented, giving rise to an unexpectedly high discharged energy density (Ud) of 8.64 J cm⁻³ obtained at 750 MV m⁻¹ and 150° C., for P3, which exceeds the performance of free-standing film-based dielectric polymers and nanocomposites.

### BRIEF DESCRIPTION OF THE FIGURES

FIG. 1 shows in panel (a) a schematic of the synthesis of polysulfates P1, P2 and P3; in panel (b) Frequency-dependent dielectric spectra of dielectric loss tangent (tan δ) and dielectric constant (k) of polysulfates P1, P2 and P3 obtained at 30° C., in panel (c) Correlation between glass transition temperature (T_{g}) and optical E_{g} of polysulfates P1, P2 and P3 and commercial aromatic dielectric polymers; and in panel (d) Direct discharged energy density to a 100 kΩ load resistor as a function of time of polysulfate P3 at 200 MV m⁻¹ and 150° C.

FIG. 2 shows temperature-dependent dielectric spectra of: loss tangent (tan δ) in panel (a) dielectric constant (k) of polysulfate P3 and commercial dielectric polymers obtained at 10⁴ Hz in panel (b); temperature coefficient (C_{T}) of the dielectric constant of polysulfate P3 and commercial dielectric polymers at various temperature ranges obtained at 10⁴ Hz in panel (c); discharged energy density (U_{d}) in panel (d); charge discharge efficiency (η) of polysulfate P3 and commercial dielectric polymers measured at 150° C. in panel (e); and maximum U_{d} at above 95% n of polysulfate P3, commercial dielectric polymers and the state-of-the-art reported dielectric polymers at 150° C.: POFNB: polyoxafluorinated norbornene; m-POFNB: meta-POFNB; o-POFNB: ortho-POFNB; ht-PEKNA (heat-treated poly (naphthalene ether ketone amide)) in panel (f).

FIG. 3 shows: in panel (a) temperature-dependent breakdown electric field of uncoated polysulfate P3 and 5.1 nm Al₂O₃ coated P3 films; in panel (b) discharged energy density (U_{d}) and charge-discharge efficiency (η) of uncoated polysulfate P3 and 5.1 nm Al₂O₃ coated P3 films measured at 150° C.; and in panel (c) Charging/discharging cyclic test results of 5.1 nm Al₂O₃ coated polysulfate P3 film measured at 150° C. and 200 MV m⁻¹ over 50,000 cycles.

FIG. 4 shows electrical conduction and charge transport behavior in segmented fittings of leakage current density versus electric field of uncoated polysulfate P3 and 5.1 nm Al₂O₃ coated P3 films measured at 150° C.; dashed curves represent fittings to hyperbolic sine. Solid curves represent linear fittings.

FIG. 5 shows normalized size exclusion chromatography (SEC) molecular weight distributions characterization and calculated molecular weight parameters of polysulfates P1, P2 and P3.

FIG. 6 shows glass transition temperature (T_{g}) derived from differential scanning calorimetry (DSC) curves of polysulfates P1, P2 and P3.

FIG. 7 shows thermal decomposition temperatures (T_{d95}%, defined as 5% weight loss) derived from thermogravimetric analysis (TGA) curves of polysulfates P1, P2 and P3.

FIG. 8 shows UV-vis spectra of polysulfates P1, P2 and P3. E_{g} represents the experimental optical bandgap (E_{g}). The optical E_{g} is calculated by E_{g} (eV)=1240/λ_{g}, where λ_{g} is the cut-off wavelength corresponding to the absorption onset of the linear region.

FIG. 9 shows temperature-dependent dielectric spectra of the dielectric constant (k) in panel (a) and dielectric loss tangent (tan δ) in panel (b) of polysulfates P1, P2 and P3 measured at 10⁴ Hz.

FIG. 10 shows discharged energy density (U_{d}) and charge-discharge efficiency (η) of polysulfates P1, P2 and P3 as a function of electric field measured at 25° C.

FIG. 11 shows discharged energy density (U_{d}) of polysulfates P1 in panel (a), P2 in panel (c) and P3 in panel (e) as a function of electric field measured at varied temperatures; panel (b) shows Charge-discharge efficiency (η) of polysulfates P1, (d) P2 and (f) P3 as a function of electric field measured at varied temperatures.

FIG. 12 shows charge-discharge efficiency (η) of polysulfates P1, P2 and P3 as a function of temperature measured at 200 MV m⁻¹ in panel (a), 300 MV m⁻¹ in panel (b), 400 MV m⁻¹ in panel (c) and 500 MV m⁻¹ in panel (d).

FIG. 13 shows: frequency-dependent dielectric spectra of the dielectric loss tangent (tan δ) and dielectric constant (k) of polysulfate P3 and P3 coated with 5.1 nm Al₂O₃ measured at 30° C. in panel (a); and temperature-dependent dielectric spectra of the tan δ and k of polysulfate P3 and P3 coated with 5.1 nm Al₂O₃ films measured at 10⁴ Hz in panel (b).

FIG. 14 shows discharged energy density ((Ja) of polysulfate P3 and P3 coated with 5.1 nm Al₂O₃ measured at 25° C. in panel (a) and 150° C. in panel (c). Charge discharge efficiency (η) of polysulfate P3 and P3 coated with 5.1 nm Al₂O₃ measured at 25° C. in panel (b) and 150° C. in panel (d).

FIG. 15 shows discharged energy density (U_{d}) in panel (a) and charge-discharge efficiency (η) of polysulfate P3 and Al₂O₃ coated P3 films with different coating thicknesses measured at 150° C. in panel (b).

FIG. 16 shows in panel (a) electric displacement-electric field (D-E) loops of polysulfate P3 coated with 5.1 nm Al₂O₃ film measured at 150° C. versus biaxially oriented polypropylene (BOPP) film measured at 105° C., under 200 MV m⁻¹; and in panel (b) discharged energy density (U_{d}) of polysulfate P3 coated with 5.1 nm Al₂O₃ film measured at 150° C. versus BOPP film measured at 105° C.

FIG. 17 shows in panel (a) discharged energy density (Ud) and in panel (b) charge-discharge efficiency (η) derived from 50,000 consecutive charging/discharging cycles of polysulfate P3 and P3 coated with 5.1 nm Al₂O₃ measured at 150° C. and 200 MV m⁻¹.

FIG. 18 shows in panel (a) change ratio of discharged energy density (Cu) and in panel (b) change ratio of charge-discharge efficiency (Cn) across 50,000 consecutive charging/discharging cycles of polysulfate P3 and P3 coated with 5.1 nm Al₂O₃ measured at 150° C. and 200 MV m⁻¹.

FIG. 19 shows leakage current density of Al₂O₃ coated P3 films as a function of coating thickness measured at 150° C. and 200 MV m⁻¹.

FIG. 20 shows leakage current density of polysulfate P3 and P3 coated with 5.1 nm Al₂O₃ measured at 150° C. under varied electric fields. The solid curves represent fitting to the Schottky emission models. The grey dashed curves only represent the extension for visual effects and has no physical meaning.

FIG. 21 shows leakage current density of polysulfate P3 and P3 coated with 5.1 nm Al₂O₃ measured at 150° C. under varied electric fields. The solid curves represent fitting to the Ohm's law and space-charge-limited conduction (SCLC) theory models.

FIG. 22 shows leakage current density of polysulfate P3 and P3 coated with 5.1 nm Al₂O₃ measured at 150° C. under varied electric fields. The solid curves represent fitting to the Poole-Frenkel emission models.

FIG. 23 shows in panel (a) strain-stress curves of films composed of polysulfate P3 and P3 coated with about 5.1 nm Al₂O₃ on each face of the film; and in panel (b) Young's modulus of polysulfate P3 and P3 coated with about 5.1 nm Al₂O₃ on each face of the film, derived from the strain-stress curves.

FIG. 24 shows Weibull plot of dielectric breakdown strength of polysulfate P3, panel (a); and P3 coated with about 5.1 nm Al₂O₃ on each face of the film without bending tests and after 5,000 consecutive bending cycles measured at 150° C., panel (b).

FIG. 25 shows a schematic cross-sectional view of a dielectric polymer film with a coating of an inorganic dielectric material on each face of the film.

FIG. 26 shows a schematic cross-sectional view of an embodiment of a film capacitor.

FIG. 27 shows a schematic cross-sectional view of a rolled film capacitor.

FIG. 28 shows a schematic cross-sectional view of another embodiment of a film capacitor.

FIG. 29 shows plots of discharged energy density (J cm⁻³) versus electric field (MV m⁻¹) for five films of polymer P12 (labeled devices 1 through 5), measured at 150° C.

FIG. 30 shows plots of charge-discharge efficiency (%) versus electric field (MV m⁻¹) for five films of polymer P12 (labeled devices 1 through 5), measured at 150° C.

FIG. 31 shows plots of discharged energy density (J cm⁻³) versus electric field (MV m⁻¹ for four films of polymer P12 (labeled devices 1 through 4), measured at 200° C.

FIG. 32 shows plots of charge-discharge efficiency (%) versus electric field (MV m⁻¹) for four films of polymer P12 (labeled devices 1 through 4), measured at 200° C.

FIG. 33 shows plots of discharged energy density (J cm⁻³) versus electric field (MV m⁻¹) for polymer P12 (average of the five films from FIG. 29) compared to films of polymer P3 and alumina-coated polymer P3, measured at 150° C.

FIG. 34 shows plots of charge-discharge efficiency (%) versus electric field (MV m⁻¹) for polymer P12 (average of the five films from FIG. 29) compared to films of polymer P3 and alumina-coated polymer P3, measured at 150° C.

FIG. 35 shows a plot of discharged energy density (J cm⁻³) versus electric field (MV m⁻¹) for polymer P12 (average of the four films), measured at 200° C.

FIG. 36 shows a plot of charge-discharge efficiency (%) versus electric field (MV m⁻¹) for polymer P12 (average of the four), measured at 200° C.

### DETAILED DESCRIPTION

The terms “alkyl” and “aryl” refer to unsubstituted and substituted aliphatic and aromatic organic groups, respectively comprising an open valence on a carbon atom thereof. As used herein, the term “alkyl” encompasses cyclic and linear saturated organic groups which comprise carbon and hydrogen. Non-limiting examples of alkyl groups include, e.g., methyl, ethyl, propyl, butyl, isopropyl, cyclohexyl, and the like. As used herein, the term “aryl” encompasses organic groups which comprise an aromatic hydrocarbon or an aromatic heterocyclic ring (i.e., a heteroaromatic or “heteroaryl” group) comprising a 5 or 6-membered aromatic ring with one or more nitrogen, oxygen or sulfur heteroatoms in the aromatic ring. Non-limiting examples of hydrocarbon-type aryl groups include, e.g., phenyl, naphthyl, anthracenyl, pyrenyl, and the like. Non-limiting examples of heteroaryl groups include, e.g., pyridyl, imidazolyl, oxazolyl, indolyl, carbazolyl, thiopheneyl, furanyl, and the like.

The term “arylalkyl” refers to an alkyl group, as described above, bearing one or more aryl substituent. Non-limiting examples of arylalkyl groups include, e.g., phenylmethyl (i.e., benzyl), 1-phenylethyl, 2-phenylethyl, (4-pyridyl)methyl, 2-(2-furanyl)ethyl, and the like.

The term “alkylaryl” refers to an aryl group, as described above, bearing one or more alkyl substituent on an aromatic portion thereof. Non-limiting examples of alkylaryl groups include, e.g., 4-methylphenyl (i.e., tolyl), 2-methylphenyl, 4-ethylphenyl, 4-methylnaphthyl, 2,3,6-trimethylphenyl, 4-methylpyridyl, 2-methylfuranyl, 2-ethylthiophenyl, 2-(t-butyl)-1,3-oxazolyl, 2-methyl-imidazolyl, 2,6-dimethylphenyl, and the like.

The terms “alkoxy” and “aryloxy” refer to unsubstituted or substituted alkyl and aryl groups, respectively, as described above, attached to oxygen, such as methoxy (CH₃O), trifluoromethoxy, ethoxy (CH₃CH₂O), phenoxy (C₆H₅O), 2-pyridyloxy, and the like.

The term “divalent” refers a substituent, moiety or group with two open valences. For example, a divalent aliphatic substituent, moiety, or group includes, e.g., methylene (—CH₂—), ethylene (—CH₂CH₂—), and the like. Similarly, a divalent substituent, moiety, or group has two open aromatic valences, such as, e.g., a 1,4-phenylene group (i.e., having open valences at carbons 1 and 4), a 2,6-naththylene (i.e., having open valences at carbons 2 and 6), and the like.

In the polymers described herein, any alkyl, aryl, arylalkyl, alkylaryl, alkoxy, and aryloxy groups can be unsubstituted (i.e., comprise only carbon and hydrogen) or can be substituted by one or more halogen, alkoxy, or aryloxy, substituent on a carbon atom thereof. In addition, the terms alkyl, aryl, arylalkyl, alkylaryl, and alkoxy encompass alkyl, aryl, arylalkyl, alkylaryl, and alkoxy groups in which a silicon atom replaces a tertiary aliphatic carbon atom.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As described above, various polymers described herein are useful in applications, including electronics, packaging, structural polymers, ion exchange, and the like, and are represented by Formula I:

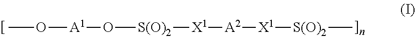

wherein:
A¹ is a first divalent aryl group;
A² is a second divalent aryl group;
X¹ is O or a covalent bond;
n is the average number of repeating units within the brackets of the formula and has a value sufficient to provide a number average molecular weight (Mₙ) of at least about 7,000 g mol⁻¹ (e.g., at least about 10,000, 15,000, 20,000, 30,000, 50,000, 80,000, 100,000, 150,000, or 200,000 g mol⁻¹), e.g., an Mn in the range of about 15,000 g/mol to about 200,000 g mol⁻¹; or 15,000 g mol⁻¹ to about 150,000 g mol⁻¹; or about 15,000 g mol⁻¹ to about 100,000 g mol⁻¹; or about 15,000 to about 80,000 g mol⁻¹; or about 18,000 to about 60,000 g mol⁻¹; or about 20,000 g mol⁻¹ to about 50,000 g mol⁻¹, or about 25,000 g mol⁻¹ to about 40,000 g mol⁻¹; as determined by size exclusion chromatography (SEC) using styrene-divinyl benzene columns, DMF/0.2% LiBr elution solvent, and polystyrene molecular weight standards; and
each divalent aryl group independently is unsubstituted or is substituted by one or more substituent selected from halogen (e.g., F, Cl, Br, and I), alkyl, aryl, arylalkyl, alkylaryl, alkoxy, and aryloxy.

Some non-limiting exemplary divalent aryl groups A¹ and A² in Formula I are independently selected from the group consisting of divalent phenyl (—C₆H₄—), divalent naphthyl (—C₁₀H₆—), divalent anthracenyl (—C₁₄H₁₀—), divalent biphenyl (—C₆H₄—C₆H₄—), divalent binaphthyl (—C₁₀H₆—C₁₀H₆—), a divalent heteroaryl group, a divalent aryl group of formula -A³-X²-A³-, and a divalent aryl group of formula -A⁴-X³-A⁴-;
wherein each A³ and A⁴ independently is a divalent aryl moiety;
X² is selected from S(O)₂, O, S, C(═O), and Z(R¹)(R²);
X³ is selected from S(O)₂, O, S, C(═O), and Z(R³)(R⁴);
Z is carbon or silicon;
R¹ is aryl; R² is selected from H, halogen, alkyl, aryl, arylalkyl, alkylaryl, alkoxy and aryloxy; or R¹ and R² together constitute a first divalent substituent which together with Z constitutes a 5-, 6-, or 7-membered hydrocarbon or heterocyclic ring;
R³ is aryl; R⁴ is selected from H, halogen, alkyl, aryl, arylalkyl, alkylaryl, alkoxy and aryloxy; or R³ and R⁴ together constitute a second divalent substituent which together with Z constitutes a 5-, 6-, or 7-membered hydrocarbon or heterocyclic ring;
and wherein the first and second divalent substituents optionally are substituted by one or more substituent selected from halogen, alkoxy, and aryloxy.

In some preferred embodiments, the first and second divalent substituents together with the Z to which they are attached constitute a 5-, 6-, or 7-membered hydrocarbon ring or heterocyclic ring, which can be fused to an aromatic moiety. In some embodiments, the first divalent substituent and/or the second divalent substituent together with the Z to which they are attached constitute a cyclic group selected from an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, a xanthene group, and the like (see e.g., Scheme 1, below). Optionally, the cyclic group is substituted by one or more substituent selected from halogen, alkoxy, and aryloxy.

Scheme 1 provides non-limiting examples of cyclic groups comprising the first or second divalent substituents together with Z, as described above, in which Z is carbon.

Any of the groups described in Scheme 1 can optionally be substituted by one or more halogen (e.g., F, Cl, Br, and/or I), alkyl, aryl, arylalkyl, alkylaryl, alkoxy, or aryloxy, as well as halogen-substituted alkyl, aryl, arylalkyl, alkylaryl, alkoxy, and aryloxy groups.

Scheme 2, below, provides some non-limiting examples of first and second divalent substituents useful in the polymers of Formula IV. Any of the divalent substituents described in Scheme 2 can optionally be substituted by one or more halogen (e.g., F, Cl, Br, and/or I), alkyl, aryl, arylalkyl, alkylaryl, alkoxy, and aryloxy as well as halogen-substituted alkyl, aryl, arylalkyl, alkylaryl alkoxy, and/or aryloxy.

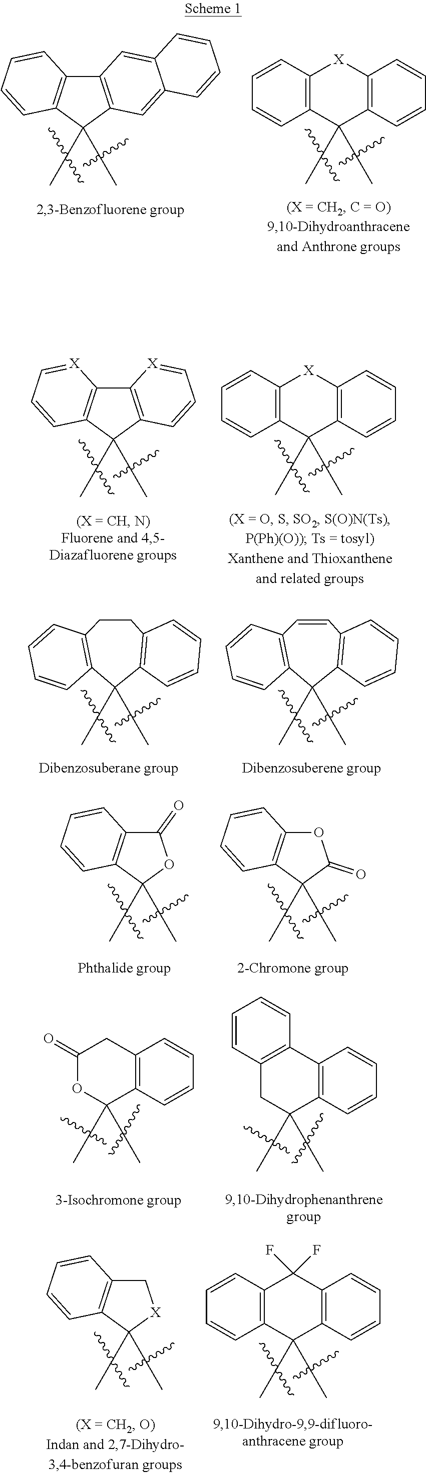

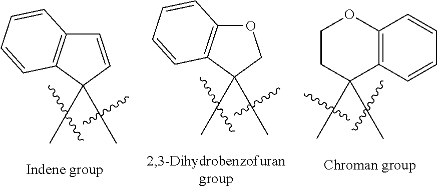 [SMILES: *C1(*)C=Cc2ccccc21 ; *C1(*)COc2ccccc21 ; *C1(*)CCOc2ccccc21]

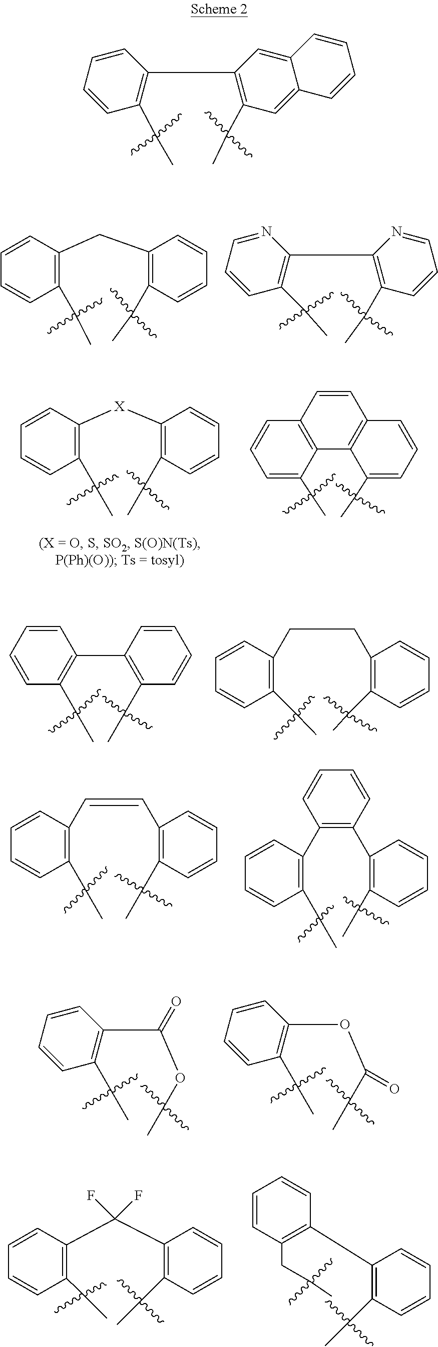

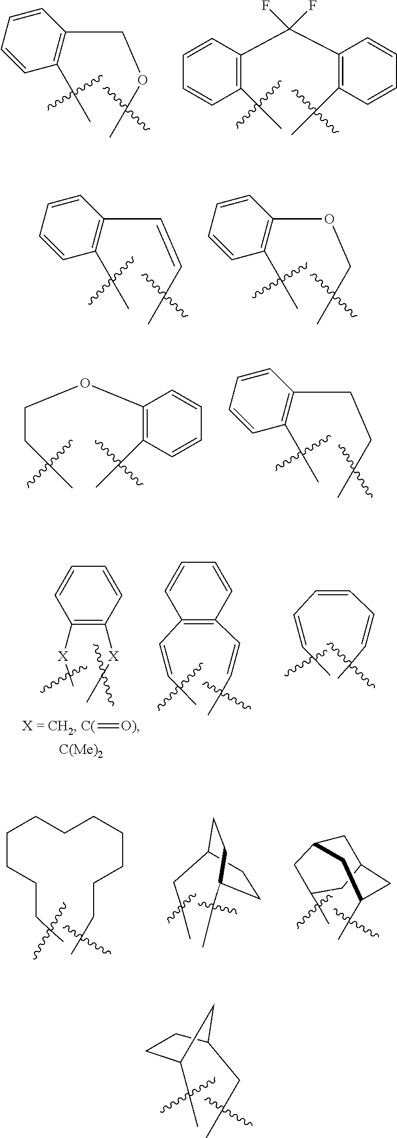

Some non-limiting exemplary polymers of Formula IV include polymers P5, P6, and P7 shown in Scheme 3.

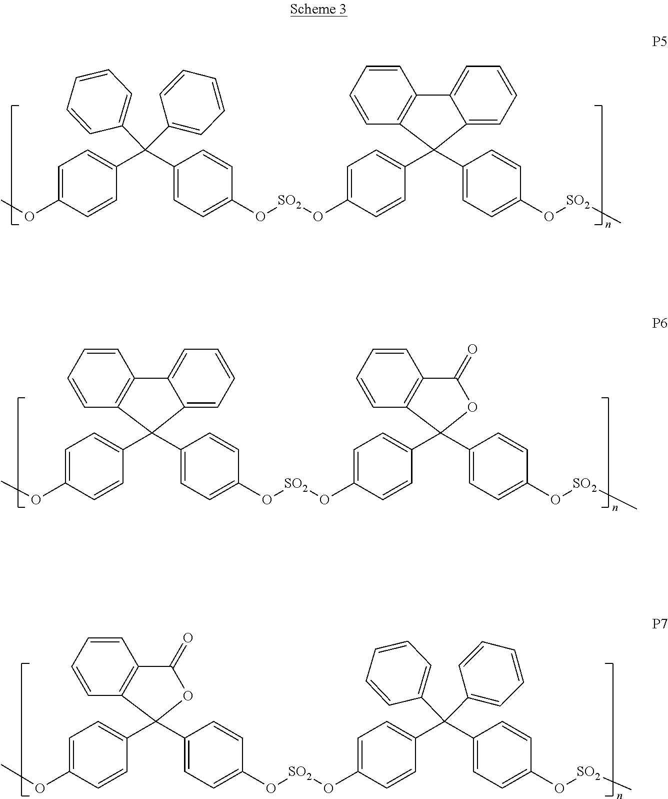

Polymers of Formula I in which X¹ is O, e.g., polysulfates of Formula II, can be prepared by a SuFEx click chemistry method comprising adding a catalyst to a stirring solution comprising a first monomer of formula (R^{x})₃Si—O-A¹-O—Si(R^{x})₃ and a second monomer of formula F(O)₂S—O-A²-O—S(O)₂F or SO₂F₂, dissolved in a polar aprotic solvent; stirring the resulting mixture for a period of time sufficient to form the polymer; and isolating the polymer, wherein each R^{x} independently is an alkyl or aryl group and the catalyst comprises at least one material selected from an amidine, a guanidine, a phosphazene, a nitrogen heterocyclic carbene, a tertiary alkoxide, a fluoride salt, and a salt of formula (R⁺) (F(HF)_{w}⁻), wherein R⁺ is an organic cation or a chelated metal cation, and w is 1 or greater.

Non-limiting examples of divalent aryl groups (A¹ and A²) include divalent phenyl (—C₆H₄—; e.g., 1,4-phenylene), divalent naphthyl (—C₁₀H₆—; e.g., 1,4-naphthylene, or 2,6 naphthylene), divalent anthracenyl (—C₁₄H₁₀—; e.g., 1,4-anthracenylene or 2,7-anthracenylene), a divalent biphenyl group (—C₆H₄—C₆H₄—), divalent binaphthyl (—C₁₀H₆—C₁₀H₆—), and divalent heteroaryl, and the like.

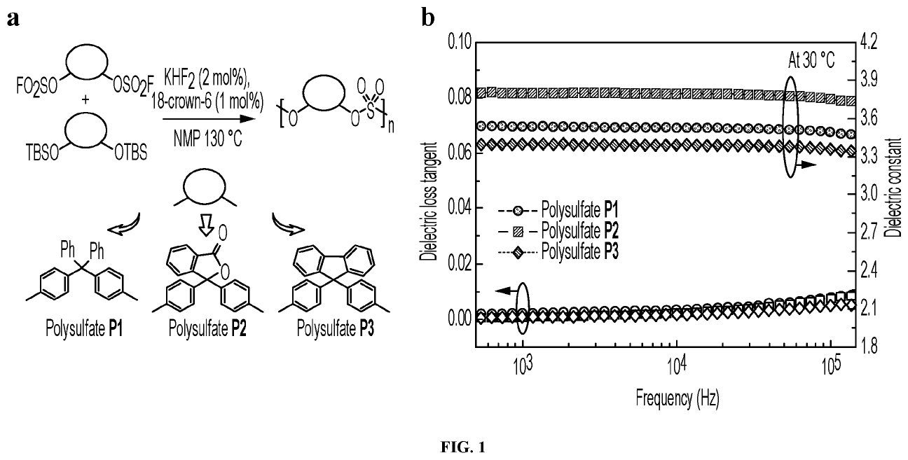

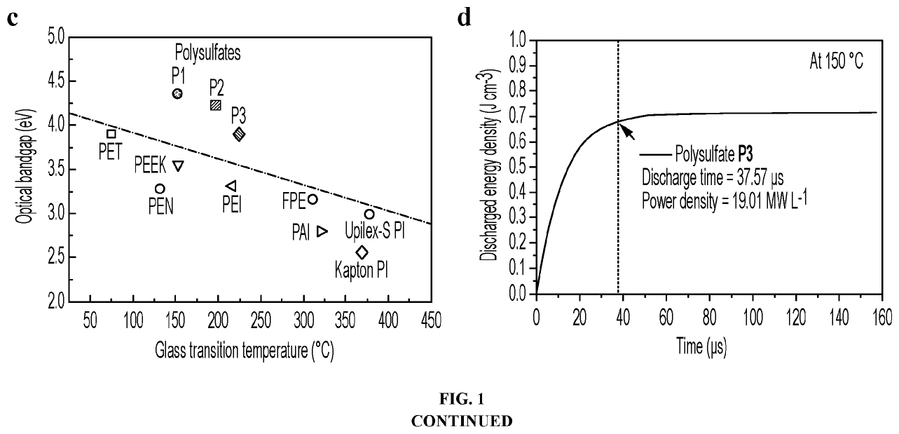

Exemplary polymers of Formula II formed by such methods are polysulfates P1 (Mn: 24,605 g mol⁻¹; PDI: 1.689), P2 (Mn: 24,866 g mol⁻¹; PDI: 1.621), and P3 (Mn: 38,270 g mol⁻¹; PDI: 1.463) shown in FIG. 1, panel (a).

Polymers of Formula I in which X¹ is a covalent bond (i.e., polysulfonates such as polymers of Formula III) can be prepared by a SuFEx click chemistry method comprising adding a catalyst to a stirring solution comprising a first monomer of formula (R^{x})₃Si—O-A¹-O—Si(R^{x})₃ and a second monomer of formula F(O)₂S-A²-S(O)₂F dissolved in a polar aprotic solvent; stirring the resulting mixture for a period of time sufficient to form the polymer; and isolating the polymer. Each RX independently is an alkyl or aryl group; and the catalyst comprises at least one material selected from an amidine, a guanidine, a phosphazene, a nitrogen heterocyclic carbene, a tertiary alkoxide, a fluoride salt, and a salt of formula (R⁺)(F(HF)_{w}), wherein R⁺ is an organic cation or a chelated metal cation, and w is 1 or greater. Biproduct F—Si(R^{x})₃ (two moles of which are formed for each Si(R^{x})₃ in the silylated monomer) generally remains in solution, while the polymer may precipitate or can be triturated by adding a solvent in which the polymer is insoluble. F—Si(R^{x})₃ generally can be recovered from the solvent by distillation. An exemplary polymer of Formula III formed by such a method is polysulfonate P4 (Mn: 64,578 g mol⁻¹, PDI: 1.5; T_{g} 176.2° C.; Ta (5% weight loss) 392.8° C.) shown in Scheme 4.

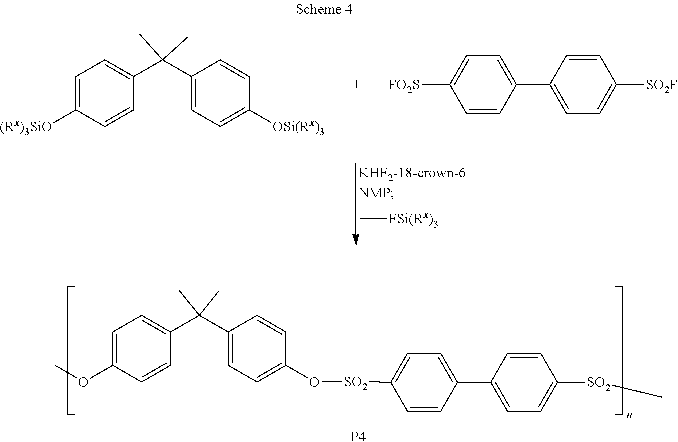

Polymers of Formula IV can be prepared by a SuFEx click chemistry method comprising adding a catalyst to a continuously stirred solution comprising a first monomer of formula (R^{x})₃Si—O-A³-X²-A³-O—Si(R^{x})₃ and a second monomer of formula F(O)₂S—X¹-A⁴-X³-A⁴-X¹—S(O)₂F dissolved in a polar aprotic solvent; stirring the resulting mixture for a period of time sufficient to form polymer of Formula VIII; and isolating the polymer. Each RX independently is an alkyl or aryl group; and the catalyst comprises at least one material selected from an amidine, a guanidine, a phosphazene, a nitrogen heterocyclic carbene, a tertiary alkoxide, a fluoride salt, and a salt of formula (R⁺) (F(HF)_{w}⁻), wherein R⁺ is an organic cation or a chelated metal cation, and w is 1 or greater. Biproduct F—Si(R^{x})₃ (two moles of which are formed for each Si(R^{x})₃ in the silylated monomer) generally remains in solution, while the polymer may precipitate or can be triturated by adding a solvent in which the polymer is insoluble. F—Si(R^{x})₃ generally can be recovered from the solvent by distillation.

Scheme 5 shows the synthesis of an exemplary polysulfate polymer of Formula IV, referred to herein as P6.

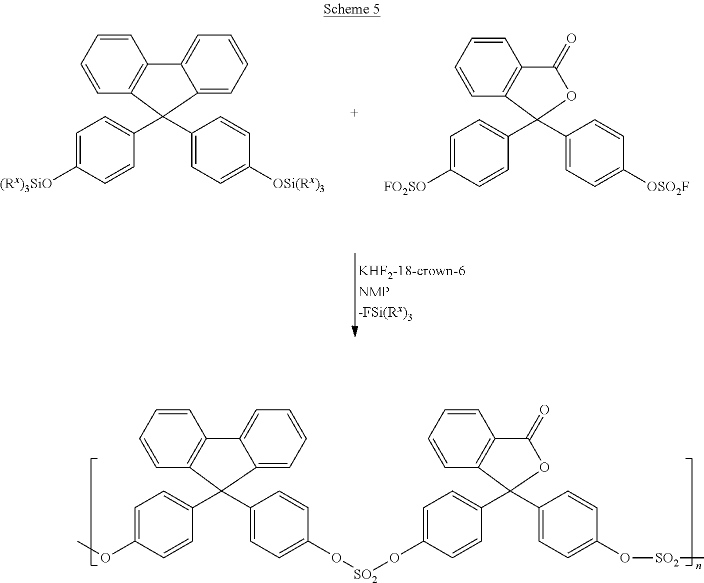

SuFEx click chemistry methods for preparing polysulfates and polysulfonates are also described, e.g., in U.S. Pat. Nos. 9,447,243; 10,717,820; Dong, J., Krasnova, L., Finn, M. & Sharpless, K. B. Sulfur (VI) fluoride exchange (SuFEx): another good reaction for click chemistry. Angew. Chem. Int. Ed. 53, 9430-9448 (2014); and Gao, B. et al. Bifluoride-catalysed sulfur (VI) fluoride exchange reaction for the synthesis of polysulfates and polysulfonates. Nat. Chem. 9, 1083-1088 (2017); each of which is incorporated herein by reference in its entirety, including Supplemental Information associated therewith.

In some embodiments, the catalyst for forming polymers of Formula I comprises an amidine, a guanidine, a phosphazene, a nitrogen-heterocyclic (N-heterocyclic) carbene, a tertiary alkoxide, and a fluoride salt. For example, the basic catalyst can comprise an amidine base (e.g., 1,8-diazabicyclo[5.4.0]undec-7-ene (DBU), and the like), a guanidine (e.g., 1,1,3,3-tetramethylguanidine (TMG), 1,5,7-triazabicyclo[4.4.0]dec-5-ene (TBD), 7-methyl-1,5,7-triazabicyclo-[4.4.0]dec-5-ene (MTBD), 2-tert-butyl 1,1,3,3-tetramethylguanidine (BTMG), and the like), a phosphazene base (e.g., 2-tert-butylimino-2-diethylamino-1,3-dimethylperhydro-1,3,2-diazaphosphorine (BEMP), 1-tert-butyl-4,4,4-tris-(dimethylamino)-2,2-bis[tris(dimethylamino)-phosphoranylidenamino]-225.4% 5-catenadi(phosphazene) (P₄-t-Bu), and the like), a nitrogen-heterocyclic carbene (e.g., an imidazole-2-ylidene, a 1,2,4-triazole-5-ylidene, a thiazole-2-ylidene, an imidazolin-2-ylidene, and the like), a tertiary alkoxide (e.g., potassium tert-butoxide and the like), or a fluoride-containing salt (e.g., CsF, CsHF₂, KF, KHF₂, tetrabutylammonium fluoride (TBAF), tris(dimethylamino)sulfonium-difluorotrimethylsilicate (TASF), and the like), or a combination of two or more thereof.

In some embodiments, the catalyst for forming polymers of Formula I comprises an HF-fluoride salt of formula (R⁺)(F(HF)_{w}⁻), wherein R⁺ is an organic cation or a chelated metal cation as described herein above, and w is 1 or greater, as well as cationic polymers, including both insoluble and soluble polymers (e.g., cationic polystyrene beads with appended quaternary ammonium groups). Chelated metal cations preferably comprise a monovalent metal ion (e.g., an alkali metal such as potassium and the like, or a monovalent transition metal, etc.) complexed with a chelating ligand, preferably a neutral (non-charged) ligand such as a crown ether (e.g., 18-crown-6, 12-crown-4, 15-crown-5, dibenzo-18-crown-6, and the like) and/or an azacrown ether (e.g., diaza-18-crown-6, and the like).

Scheme 6, below, provides some non-limiting examples of bis-silylated bisphenol-type monomers, (R^{x})₃Si—O-A¹-O—Si(R^{x})₃, useful in preparing the polysulfate and polysulfonate polymers of Formulas I, II, and III.

Scheme 7, below, provides some non-limiting examples of bis-fluorosulfate bisphenol-type monomers, F(O)₂S—O-A²-O—S(O)₂F, useful in preparing the polysulfate polymers of Formulas I and II.

Scheme 8, below, provides some non-limiting examples of bis-fluorosulfonyl bisphenol monomers, F(O)₂S-A²-S(O)₂F, useful in preparing the polysulfonate polymers of Formulas I and III. The bis-silylated monomers can be readily obtained by silylation of the corresponding bisphenol with ClSi(R^{x})₃ in the presence of a base. Similarly, the bis-fluorosulfate monomers can be readily formed by reaction of the corresponding bisphenol with SO₂F₂.

Scheme 9 provides some additional bis-silylated bisphenol monomers and bis-fluorosulfate bisphenol monomers which are useful for preparing polymers of Formula (1) in combination with a second monomer.

Scheme 10 provides additional examples of bis-silylated, bis-fluorosulfonyl, and bis-fluorosulfate monomers useful for preparing the polymers described herein.

In Schemes 6, 7, and 8, Y is O, S, SO₂, CH₂, CF₂, or CO; Y₁ is CH or N, Y₂ is CH₂ or O, and R^{x} is alkyl or aryl.

In Scheme 9, Ry is trialkyl silyl (i.e., for bis-silyl monomers) or fluorosulfonyl (i.e., for bis fluorosulfate monomers).

In Scheme 10, Y is a covalent bond, CH₂, CH(R⁷), C(R⁷)₂, CH(R⁷), C(R⁸)₂, O, S, SO₂, NH, or N(R⁷); each R⁸ independently is H, halogen (e.g., Br), alkyl, aryl, arylalkyl, or alkylaryl; and E is —OSi(R^{x})₃, —OSO₂F; or —SO₂F.

Some non-limiting exemplary polysulfate polymers of Formula I are formed by SuFEx polymerization of a bis-silylated monomer from Scheme 6, Scheme 9, or Scheme 10 with a bis-fluorosulfate monomer of Scheme 7, Scheme 9, or Scheme 10. Some non-limiting exemplary polysulfonate polymers of Formula I are formed by SuFEx polymerization of a bis-silylated monomer from Scheme 6, Scheme 9, or Scheme 10 with a bis-fluorosulfonyl monomer of Scheme 8 or Scheme 10.

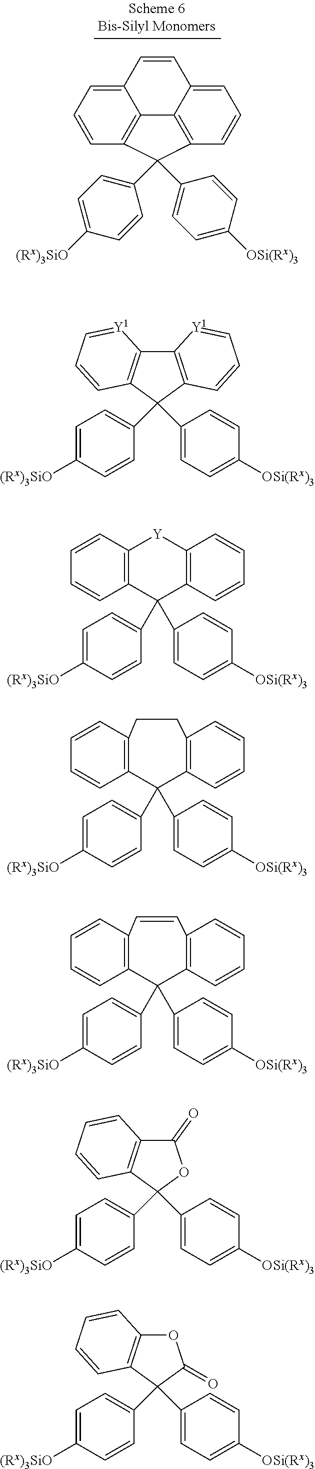

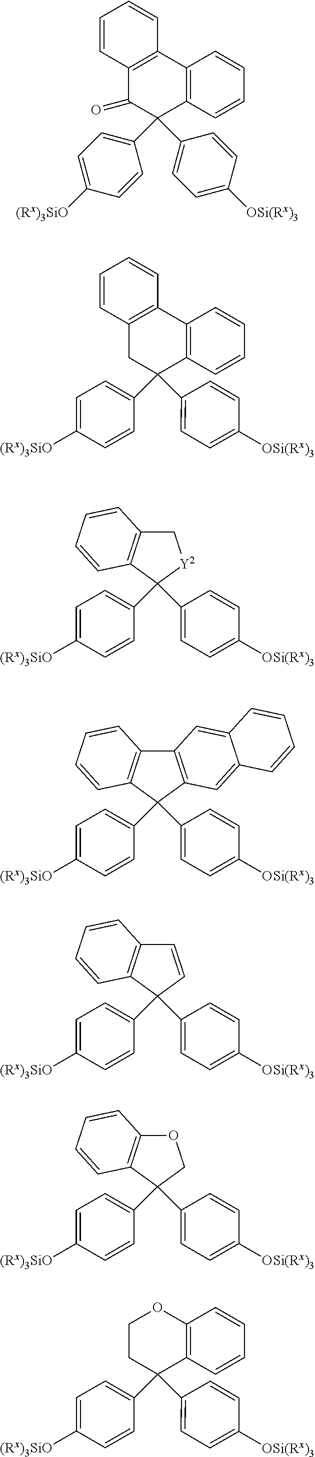

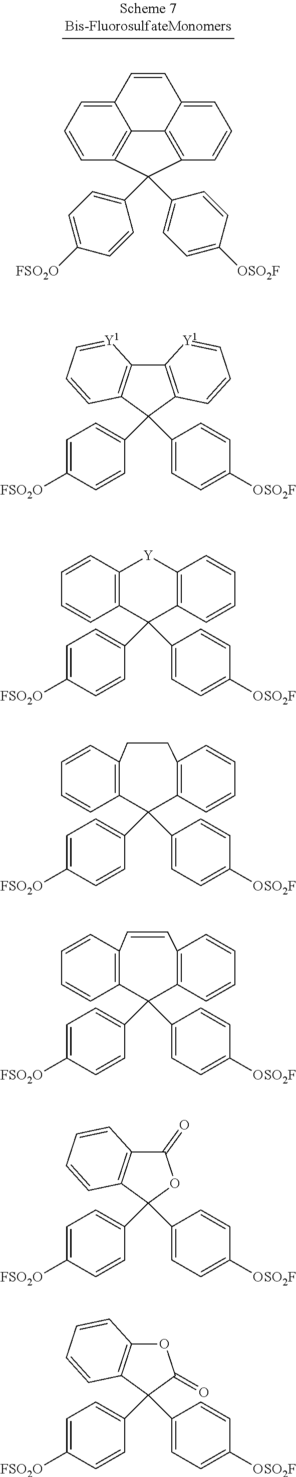

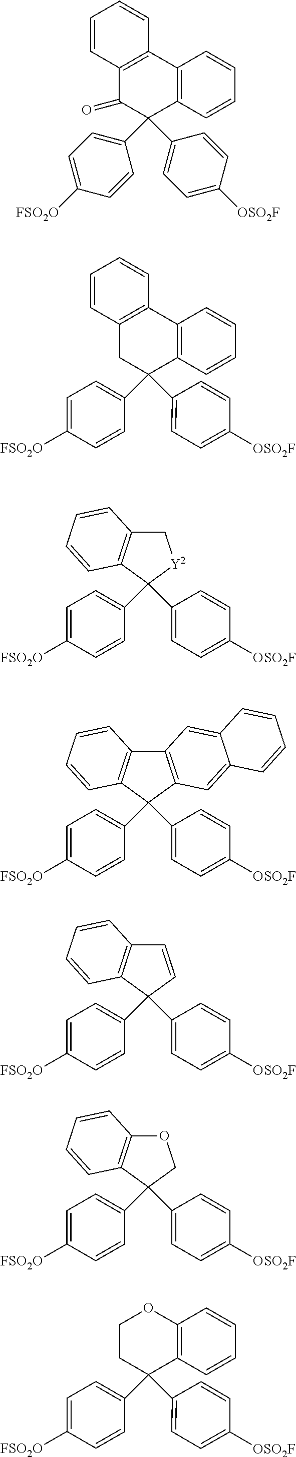

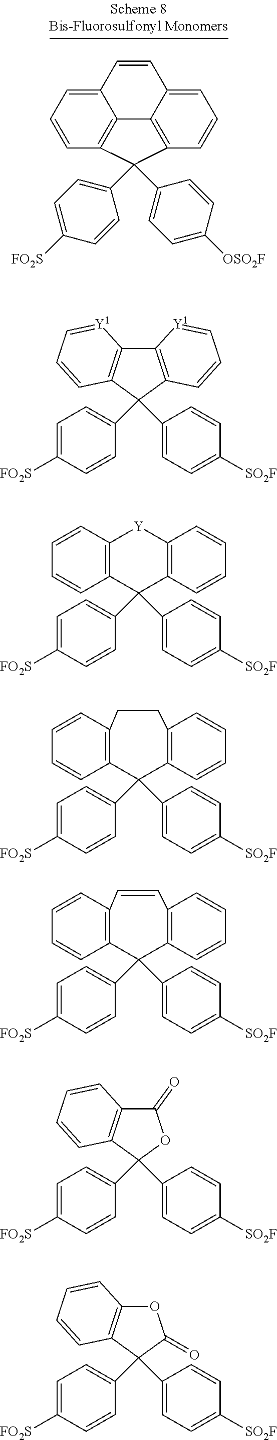

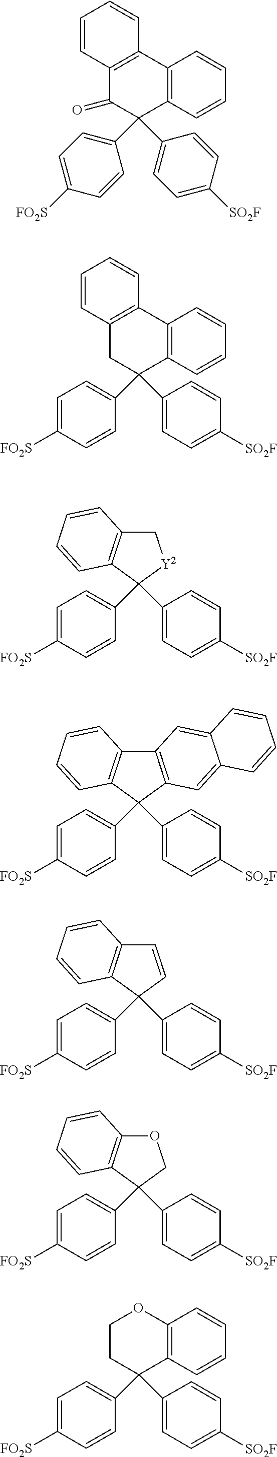

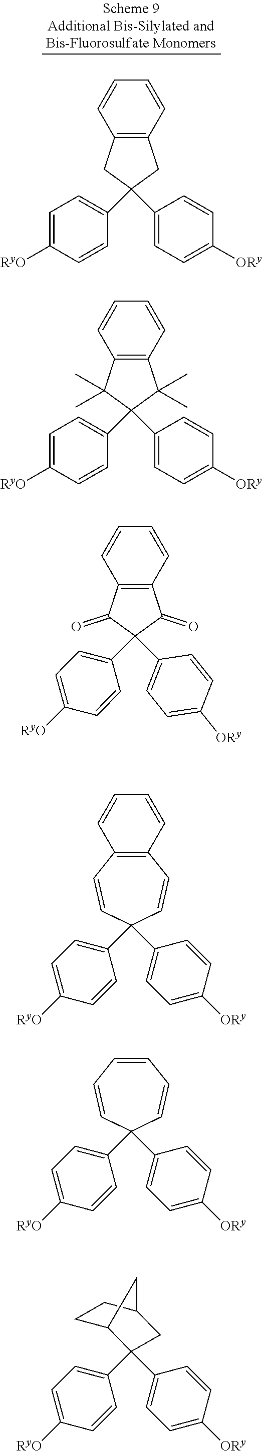

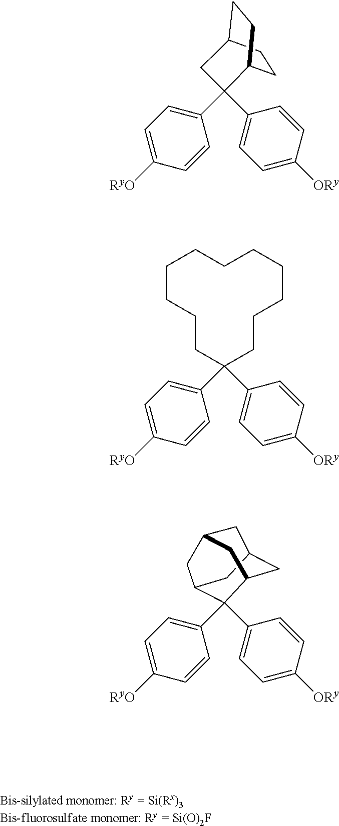

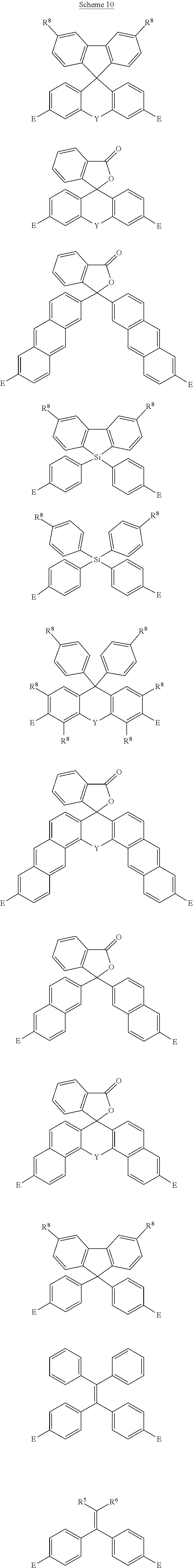

Electrostatic energy storage devices (e.g., polymer film capacitors) described herein, utilize at least one polymer of Formula I as a dielectric material. In some embodiments, the device comprises one or more first conductive layers and an equal number of second conductive layers alternatingly interleaved with the first conductive layers; wherein each first conductive layer is electrically insulated from each adjacent second conductive layer by a dielectric polymer film comprising at least one dielectric polymer of Formula I as described herein, thereby constituting a stacked, multilayer structure, with alternating conducting and dielectric layers. When there is more than one first conductive layer, the first conductive layers are in electrically conductive contact with one another other (e.g., by a first conductive end plate) connected, and the second conductive layers are in electrically conductive contact with one another other (e.g., by a second conductive end plate). The conductive layers can be, for example, metal plates, metal foils, or metal coatings on each surface of the dielectric polymer film. Suitable metals for the conductive layers include, for example A¹, Ta, Nb, Au, Pt, and Cu. In some embodiments, the dielectric polymer film comprises at least one polymer of Formula II, III, IV, or a combination thereof as described herein. Preferably, the polymer film includes a coating of an inorganic dielectric material as described herein, above. Typically, alternate conductive layers are connected to separate leads for connection into a circuit.

FIG. 25 shows a schematic cross-sectional view of a dielectric composite film 100, which comprises a dielectric polymer film layer 102, with inorganic dielectric coating 104 on one face of film 102 and the same or a different inorganic dielectric coating 106 on the opposite face of film 102. Film 102 comprises a film of at least one polymer of Formula I. The inorganic dielectric material can be, e.g., Al₂O₃, HfO₂, ZrO₂, SnN, TaN, Y₂O₃, TiO₂, ZnO, SnO₂, SiO₂, MgO, BN, AlN, and the like. Optionally, film 102 can comprise inorganic dielectric nanoparticles embedded within a matrix of the polymer, such as, e.g., nanoparticles of Al₂O₃, HfO₂, ZrO₂, SnN, TaN, Y₂O₃, TiO₂, ZnO, SnO₂, SiO₂, MgO, BN, AlN, CaF₂, CaCO₃, BaTiO₃, SrTiO₃, ZrTiO₃, or NaNbO₃.

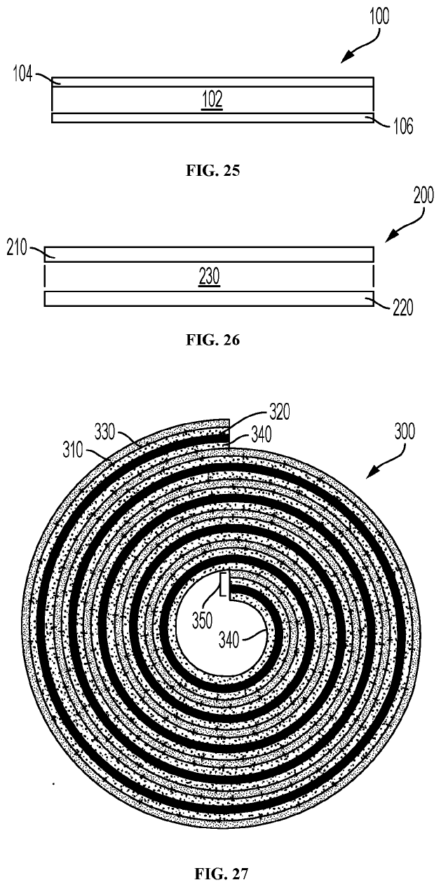

FIG. 26 provides a schematic cross-sectional view of an electrostatic energy storage device commonly referred to as a film capacitor. Multilayer material 200 comprises a first conductive layer 210 and a second conductive layer 220 with a dielectric film layer 230 between first conductive layer 210 and second conductive layer 220. Layer 230 can be, e.g., a film of a polymer of Formula I, or a dielectric composite film such as the composite film illustrated in FIG. 25. Typically, the capacitor is connected into an electric circuit by leads attached to the conductive layers. The conductive layers typically are a metal foil or a metal coating comprising a metal such as A¹, Ta, Nb, Au, Pt, Cu, and the like.

FIG. 27 illustrates a schematic cross-sectional view of a rolled capacitor configuration. Rolled capacitor 300 comprises a composite structure 350 comprising first dielectric polymer film 340 contiguous with one face of first conductive layer 310, second conductive layer 320, and second dielectric polymer film layer 330 contiguous with and between first conductive layer 310, and second conductive layer 320. This composite structure is rolled into a cylindrical configuration. In some embodiments, layers 310, 320 and 330 are a film capacitor as depicted in FIG. 26. The dielectric polymer films 330 and 340 preferably comprise a polymer of Formula I, or a dielectric composite film such as the composite film illustrated in FIG. 25. Typically, the capacitor is connected into an electric circuit by conductive leads attached to the conductive layers. The conductive layers typically are metal foils or metal coatings comprising a metal such as A¹, Ta, Nb, Au, Pt, Cu, and the like.

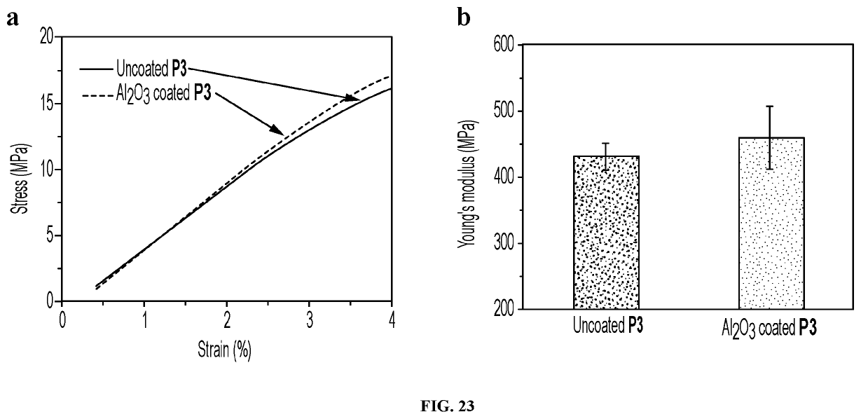

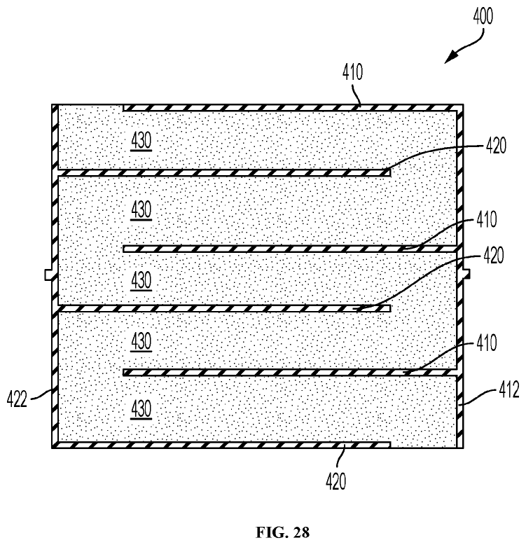

FIG. 28 illustrates another schematic cross-sectional view of an electrostatic energy storage device sometimes referred to an interdigitated capacitor. Device 400 comprises conductive layers 410 interleaved with conductive layers 420, with layers of dielectric polymer film 430 between conductive layers 410 and 420 so as to electrically insulated layers 410 from layers 420. Conductive layers 410 are connected together by conductive endplate 412, and conductive layers 420 are connected together by conductive end plate 422. The layers of dielectric polymer film 430 comprises a polymer of Formula I, or a dielectric composite film such as the composite film illustrated in FIG. 23. Typically, the capacitors connected into an electric circuit by conductive leads attached to the conductive layers. The conductive layers and end plates typically are a metal foil or a metal coating comprising a metal such as Al, Ta, Nb, Au, Pt, Cu, and the like.

The dielectric polymer design concept described herein, i.e., introducing sulfate and sulfonate groups into the polymer backbone enhances dielectric constant to yield high-dielectric-constant polymers. The device processing concept described herein, i.e., introducing wide bandgap oxide coatings onto polymer film surface impedes charge injection from electrodes, which in turn helps to improve dielectric breakdown strength and electrostatic energy storage performances. These two concepts led to the development of high-performance dielectric film capacitors with rationally-designed structure and enhanced dielectric properties at elevated temperatures.

High performance non-ionic polymer films are described herein with excellent electrical insulating properties even at relatively high temperatures of about 150° C. Films comprising high performance aryloxy polysulfate dielectrics exhibit desirable k (3.4-3.8), high E_{b} (≥650 MV m⁻¹) and high T_{g} (about 153-225° C.). This combination of physical characteristics endows aryloxy-polysulfate thin films, in particular, with superior dielectric and energy storage properties, with notably higher temperature ranges than other state-of-the-art dielectric polymers and polymer nanocomposites. Moreover, upon coating of the polymeric films with nanolayers of Al₂O₃ (e.g., 5 to 500 nm coating thickness) the E_{b} and electrostatic energy storage performance are further augmented, giving rise to an unexpectedly high discharged energy density (Ud) of 8.64 J cm⁻³ obtained at 750 MV m⁻¹ and 150° C. for polymer P3 described herein with a thin (about 5 nm) Al₂O₃ layer on each face of the film, which exceeds the performance of the majority of known free-standing high temperature polymer-based dielectric films.

Polysulfates P1, P2, and P3 (polymers of Formula II having number average molecular weights, Mₙ, of about 24,605, 24,855, and 38,270 g mol⁻¹, respectively, corresponding to approximately 70, 65 and 92 monomer units per polymer, respectively) are demonstrated herein to have k values in the range of about 3.4 to about 3.8, which is higher than most of the commercially available dielectric polymers such as polypropylene (PP, about 2.2), polyethylene (PE, about 2.6), polystyrene (PS, about 2.7), polycarbonate (PC, about 3) and polyetherimide (PEI, about 3.2). In addition, the sulfate groups of the polysulfates are exclusively presented on the polymer main chains (also referred to as the “polymer backbone”), which can largely reduce dielectric loss, compared to the polymers with side chain-containing polar or polarizable groups, due to the restricted dipole rotation under the electric field. For instance, the polysulfates exhibit relatively low dielectric loss tangent (tan δ) of less than 0.02 across a wide range of operating frequencies, even at 105 Hz. Polysulfonate polymer P4 also is demonstrated herein to have excellent dielectric properties (dielectric constant: 3.55 by D-E Loop at 100 MV m⁻¹) and thermal properties (T_{g}: 176.2° C., Ta (5% weight loss) 392.8° C.).

The co-presence of rigid aryl rings on the polymer backbone contributes to the high glass transition temperature (T_{g}) (e.g., typically about 150 to about 230° C. for the polysulfates and polysulfonates) and high thermal decomposition temperature (T_{d95}%, defined as 5% weight loss) (e.g., typically >350° C.) of these polymers, which can withstand extreme operating conditions, such as those found in some high-temperature capacitor applications. The high polarizability of sulfate and the inability of sulfur to pi-bond with oxygen, nitrogen, or carbon contribute to improved dielectric and thermal properties of the polysulfate polymers. Polysulfates P12, and P31 to P36, described herein below, have even higher T_{g} values than polymer P3, (see Table 5) and optical band gap values (E_{g}) of about 3.57 to 3.94 MV m⁻¹. Thus, polymer thin film capacitors comprising these polymers may have significant advantages in high temperature environments.

Moreover, in sharp contrast to conventional polymer composites in which the enhanced dielectric constant is mainly reliant on the introduced high-dielectric-constant inorganic fillers, the inherently high dielectric constants of these polymers described herein enable homogenous microstructures of the resulting dielectric films. Compared to conventional polymer composites, in which defects can be easily found at the organic/inorganic interfaces, the molecular approach of introducing sulfate and sulfonate groups into polymer chains effectively reduces physical interface defects, which are known to deteriorate dielectric properties, such as breakdown strength. The resultant films show relatively high dielectric breakdown strength across a wide range of operation temperatures in capacitor applications.

From the device fabrication perspective, the polymers of Formula I can be easily dissolved in polar solvents such as dimethylformamide (DMF), N, N-dimethylacetamide (DMAc) and N-methyl pyrrolidone (NMP), allowing for efficient cast film formation. In addition, the thermoplastic nature of the polymers described herein provides great opportunities for melt extrusion-processing by the most mainstream film capacitor manufacturing techniques in the industry. Based on performance tests, the presence of sulfate groups in the backbone not only improves the dielectric constant, but also introduces some conduction loss in the polymer films, particularly at higher temperatures, thereby reducing the charge-discharge efficiencies of the resulting film capacitors at high temperature. Thin wide-bandgap inorganic oxide coatings, such as Al₂O₃, HfO₂, and ZrO₂, coatings, also can be introduced on both sides of polymer films to impede charge injection, which effectively reduces electrical conduction across the polymeric film devices. For example, the dielectric breakdown strength, discharged energy density, and charge-discharge efficiency of polysulfate P3 were synergistically improved by the presence of the ultrathin Al₂O₃ coatings.

The surface modification (coating) of the polymer films by plasma-assisted atomic layer deposition (ALD) with trimethylaluminum (TMA) as an Al₂O₃ precursor is facile, scalable, and environmentally friendly. The entire coating process neither involves any toxic chemicals nor generates any hazardous by-products. More importantly, the general and scalable ALD technique is further extendable to other metal-containing precursors to yield coatings such as HfO₂, ZrO₂, SnN, TaN, Y₂O₃, TiO₂, ZnO, and SnO₂, e.g., as described by Steven W. George, Chem. Rev. 2010, 110:111-131.

Other techniques for introducing an inorganic dielectric layer on the polymer films include, for example, thermally-assisted ALD, chemical vapor deposition (CVD), and physical vapor deposition (PVD).

The uncoated polysulfate P3 film capacitors deliver unexpectedly high energy storage performances compared to current dielectric polymers, i.e., discharged energy density of about 6 J cm⁻³ obtained at 600 MV m⁻¹ at 150° C. Upon the incorporation of ultrathin Al₂O₃ coatings, the performance can be further improved, i.e., discharged energy density of about 8.64 J cm⁻³ obtained at 750 MV m⁻¹ at 150° C., which is superior to the most state-of-the-art high-temperature polymer-based dielectric films.

Furthermore, the present materials are superior compared to the conventional inorganic particle-doping (filler) approaches to enhance dielectric properties of polymer film capacitors. The presence of sulfate or sulfonate functional groups in the polymer backbones results in excellent homogeneity of microstructure, while the facile surface modification utilizing wide-bandgap oxides also shows great processability and scalability. In addition, there is evidence that at least some polysulfate polymers of Formula I can adopt higher order helical coil structures with discernable helical repeats. Such ordered structures may also play a role in the dielectric properties of the polymers.

### Materials Design, Synthesis and Characterization

The polymers described herein can be readily synthesized in large quantities. For high-temperature applications of dielectric polymers, it is important to possess a T_{g} above the operation temperature, because drastically enhanced segmental motion of polymeric chains at temperatures close to T_{g} will result in significantly increased current leakage and reduced mechanical strength, and consequently deteriorated electrical insulation properties. It is equally important for the material to possess a wide bandgap (E_{g}) to minimize electrical conduction within the polymer. Incorporating aromatic repeat units in the polymer backbone can effectively improve T_{g} but often reduces E_{g} due to conjugation effects of aromatic groups. Such an inverse T_{g} E_{g} correlation has been commonly observed in conventional high temperature polymers containing aromatic groups, rendering them unsuitable for high-temperature electrification applications. As the physical properties of polymers are also highly dependent on the chemical nature of the linkage groups, we envision that the employment of appropriate nonconjugated linkages between aromatic repeat units may offer a simple approach to effectively modulating a wide E_{g} while preserving the excellent thermal properties of aromatic polymers. In this regard, the highly stable and rotatable diaryl sulfate linkage stands out as a unique candidate. Compared to other common linkages such as imide, amide, ketone, ether, ester and sulfone, the tetragonal sulfur (VI)-based sulfate functions as a nonplanar hub with more degrees of rotational freedom that connects the aromatic groups with interrupted conjugation and minimized x-stacking, satisfying the E_{g} considerations. Additionally, the inability of sulfur to pi-bond with carbon, nitrogen or oxygen, the high polarizability and rotational freedom associated with the S—O—C bonds in the sulfate linkages in the polymer backbone chains of the polysulfates are desirable to engender high k value with synchronous low dielectric losses, which is distinctive from polymers bearing sulfonyl substituents that are not part of the polymer backbone.

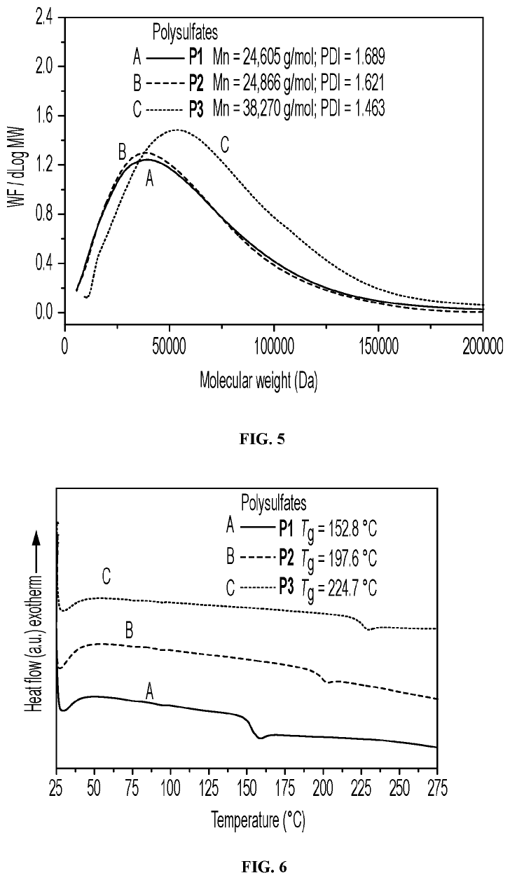

The metal-free synthetic route to the polymers of Formula I also minimizes concerns over deterioration of insulation strength and operational reliability of the polymer dielectrics caused by residual metal catalysts. Polymers (P1, P2 and P3) exhibited high T_{g} values (ranging from 153° C. to 225° C.) and high thermal decomposition temperatures (T_{d95}%, defined as 5% weight loss, >350° C.) (FIGS. 5, 6, and 7). These polysulfates display good solubility in conventional polar solvents such as N-methylpyrrolidone (NMP) and N,N-dimethylformamide (DMF) at room temperature, allowing facile solution-based casting of flexible free-standing thin films that are desirable for practical electrostatic energy storage applications.

Polysulfates P1-P3 display desirable k values (i.e., 3.4-3.8 at 10⁴ Hz) and low loss tangents (tan δ), as revealed by the frequency-dependent dielectric spectra (FIG. 1, panel (b)). The experimental optical E_{g}s (obtained by UV-Vis spectroscopy) of the polysulfates are in the range between 4.36 and 3.90 eV and follow the order of P1>P2>P3 (FIG. 8). When comparing the E_{g}s and T_{g}s against the major commercial dielectric polymers containing aromatic repeat units, including PEEK, PEI, FPE, polyethylene terephthalate (PET), polyethylene naphthalate (PEN), polyamideimide (PAI), and PIs (KAPTON PI and UPILEX-S PI) (which follow an empirical inverse correlation between E_{g} and T_{g}), the polysulfates show apparent deviation with decent T_{g}s despite their larger E_{g}s (FIG. 1, panel (c)). In addition, the polysulfates P1-P3 display lower computed mass densities (about 1.1-1.20 g cm⁻³) than those of commercial dielectric polymers. The combination of lightweight, wide E_{g}, large k, low tan d, along with high T_{g} is highly desirable for high-temperature film capacitor applications.

### Temperature-Dependent Dielectric and Capacitive Energy Storage Properties

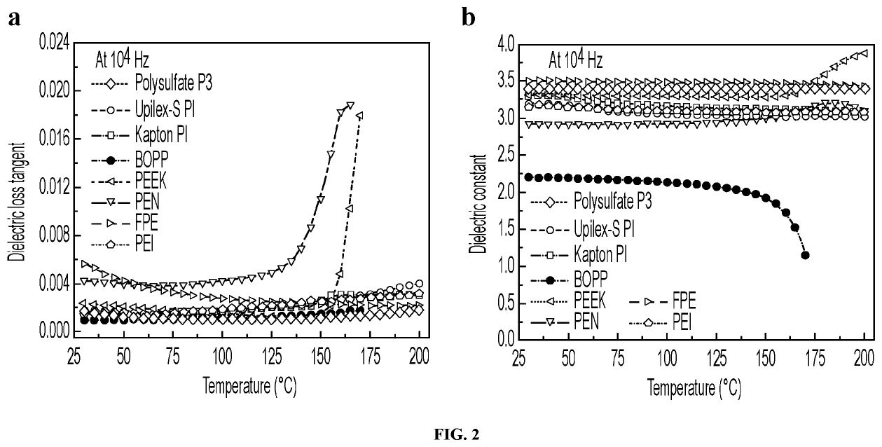

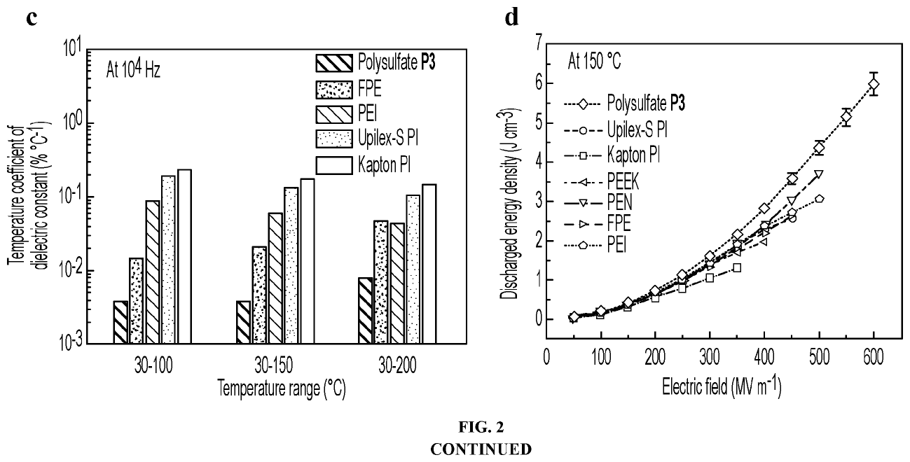

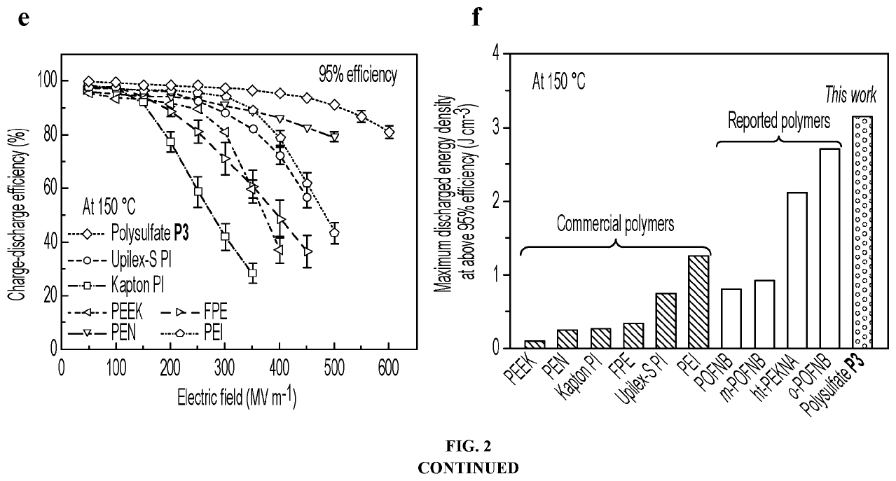

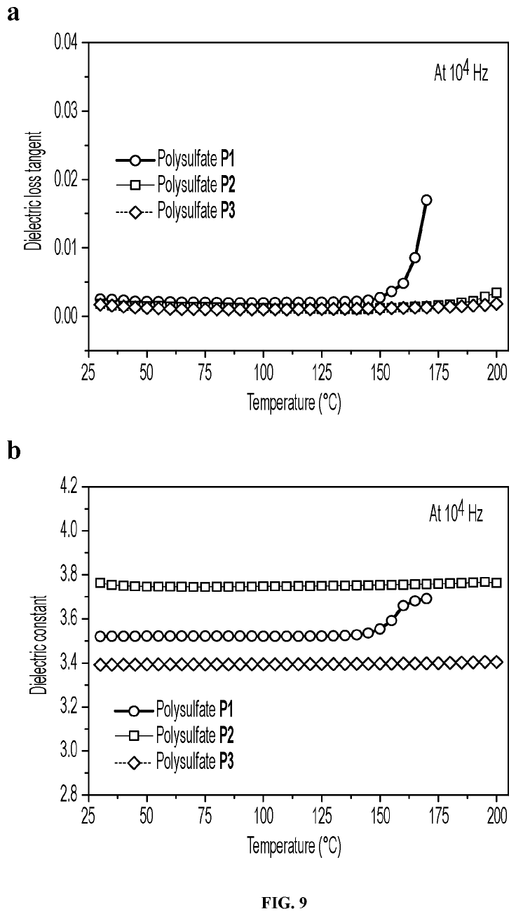

To evaluate dielectric stability of polysulfates, the temperature-dependent dielectric spectra were recorded across a wide temperature range and are shown in FIG. 9. As the polysulfate P3 with the highest T_{g} also holds the most stable dielectric spectra up to 200° C., the k and tan δ of polysulfate P3 are compared with the state-of-the-art capacitor-grade polymer films including BOPP, PEN, PEEK, PEI, FPE, KAPTON PI and UPILEX-S PI (Table 1) as a function of temperature at 10⁴ Hz (FIG. 2, panels a-b), which is the frequency of interest for common power conditioning. The tan δ of polysulfate P3 is among the lowest reported (<0.02) and even comparable to BOPP, which is known as the dielectric polymer with the smallest dielectric loss.

TABLE 1
The state-of-the-art dielectric capacitor
films investigated in this study.

| Polymer | Film type | Film thickness (μm) | |
|---|---|---|---|
| UPILEX-S PI | PI film | 8.8 | μm |
| KAPTON PI | PI film | 7.8 | μm |
| BOPP | high crystallinity BOPP film | 3 | μm |
| VICTREX PEEK | PEEK extruded film | 8.5-9 | μm |
| PEN | PEN biaxially oriented film | 2.5-4 | μm |
| FPE | FPE solvent cast film | 5-6 | μm |
| ULTEM 1000 PEI | PEI extruded film | 10-12 | μm |

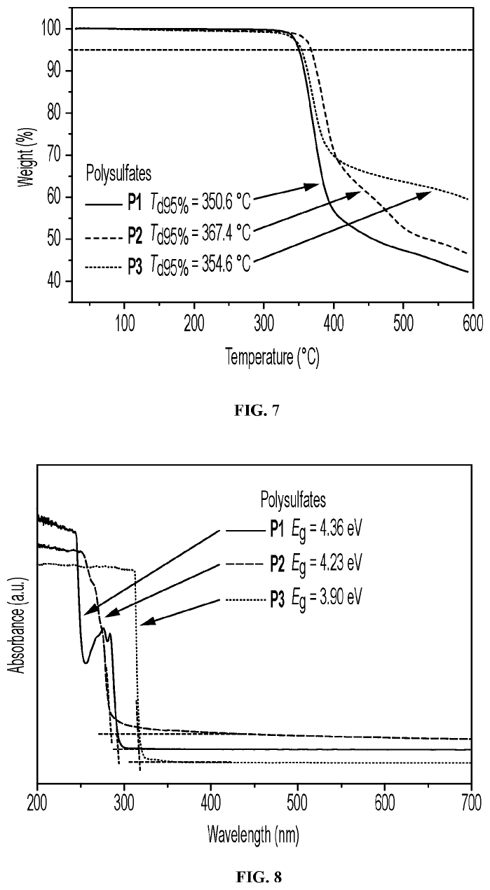

The ultra-low tan δ is associated with the coexistence of both flexible sulfate linkages and rigid aromatic subunits on the polymer backbone. The rigid aromatic subunits are believed to be responsible for lowering the backbone motions and enhancing T_{g}, while the sulfate linkers easy rotational excursions can absorb the friction energy between rigid aromatic segments, leading to suppressed dielectric loss. The dielectric constant, k, of polysulfate P3 remains remarkably stable at about 3.4 across a wide temperature range from 30° C. to 200° C., corresponding to a temperature coefficient (CT, see Methods and FIG. 7) of 0.008%° C.⁻¹, the smallest when compared to FPE, PEI, UPILEX-S PI and KAPTON PI measured at the same temperature range (FIG. 2, panel (c)), and also lower than that of the state-of-the-art high-temperature dielectric polymer polyoxafluorinated norbornene (POFNB, C_{T} of 0.016%° C.⁻¹ for the temperature range 20-180° C.) and the dielectric nanocomposites c-BCB/Al₂O₃ nanoplates and c-BCB/BN nanosheets (CTs of about 0.023%° C.⁻¹ and about 0.025%° C.⁻¹, respectively, for the temperature range 30-200° C.) (c-BCB: cross-linked divinyltetramethyldisiloxane bis(benzocyclobutene)).

The E_{b} of the polysulfates were measured at various temperatures. A two-parameter Weibull distribution function (see Methods) has been utilized to assess experimental results, e.g., as shown in Table 2. All of the tested polysulfate polymers delivered ultrahigh Weibull E_{b} (≥650 MV m⁻¹) at 25° C., and showed a typical drop in E_{b} with temperature. In comparison to polysulfates P1 and P2, polysulfate P3 had the highest T_{g} and also exhibited the highest Weibull E_{b} at elevated temperatures. For instance, at 125° C. and 150° C., the Weibull E_{b} of polysulfate P3 is 664 and 604 MV m⁻¹, respectively, compared to 617 and 488 MV m⁻¹ of the polysulfate P2 with the second-best T_{g}. In contrast, polysulfate P1 delivers a notably reduced Weibull E_{b} of 366 MV m⁻¹ at 125° C., which is limited by T_{g} to withstand higher temperatures. At the same time, the thickness dependence of E_{b} was demonstrated using polysulfate P3 films with various thicknesses, where only minor variation (<3%) of Weibull E_{b} has been observed across the investigated thickness range of 2-14 μm. To be consistent with the thickness of BOPP films used in commercial dielectric capacitors (i.e., about 3 μm), the thickness of the free-standing polysulfate films is carefully controlled to be around 2-5 μm in the bulk of the work described herein.

TABLE 2
Weibull breakdown parameters of polysulfates P1, P2 and P3.

| | Temperature | Weibull E_{b} | |
|---|---|---|---|
| Polymer | (° C.) | (MV m⁻¹) | β |
| Polysulfate P1 | 25 | 649 | 14.1 |
| | 75 | 599 | 15 |
| | 100 | 540 | 10.5 |
| | 125 | 366 | 4.9 |
| Polysulfate P2 | 25 | 747 | 15.9 |
| | 75 | 735 | 16.9 |
| | 100 | 657 | 15.7 |
| | 125 | 616 | 13.0 |
| | 150 | 488 | 7.74 |
| Polysulfate P3 | 25 | 733 | 17.2 |
| | 75 | 719 | 18.0 |
| | 100 | 700 | 16.7 |
| | 125 | 664 | 15.6 |
| | 150 | 604 | 13.4 |
| | 175 | 493 | 6.94 |

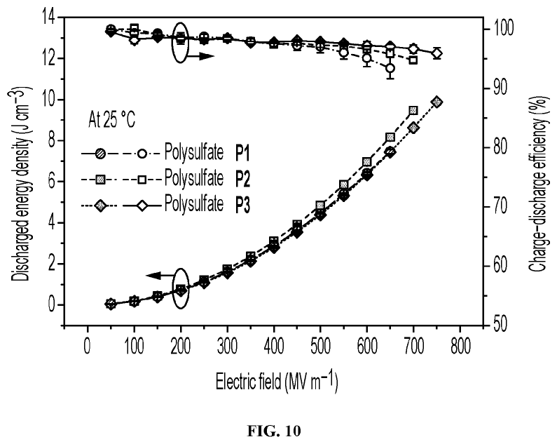

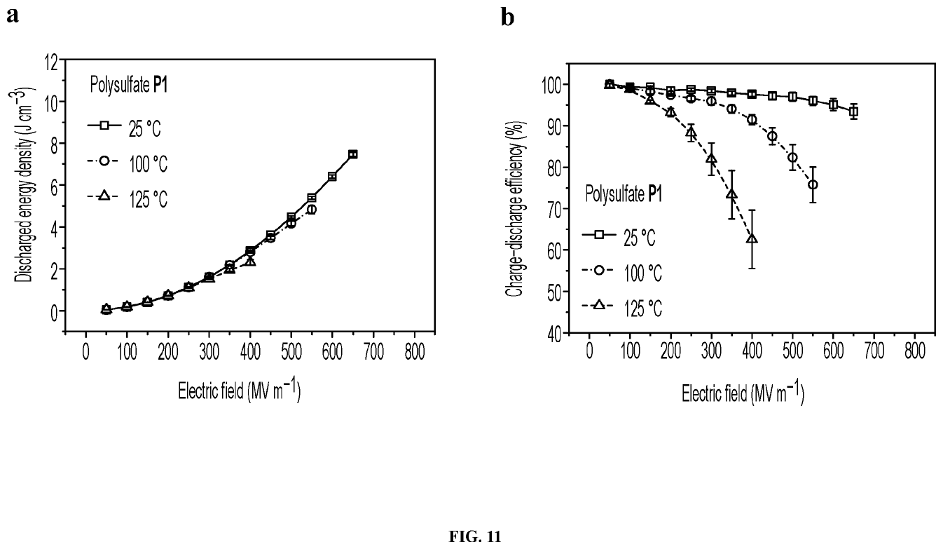

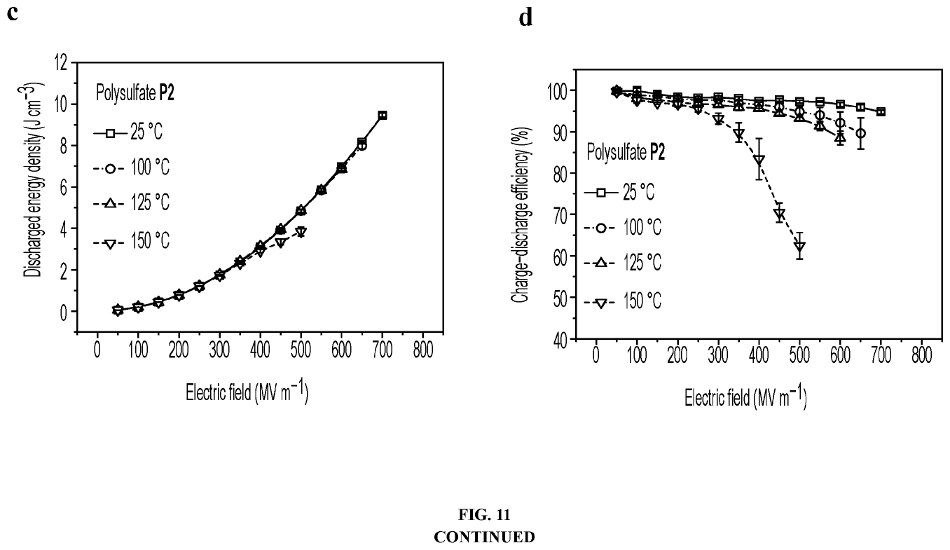

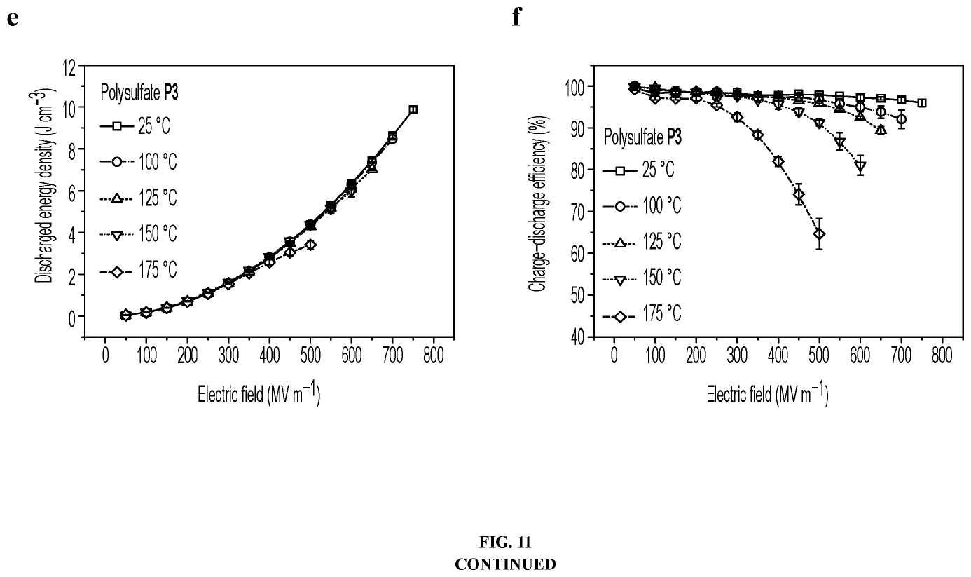

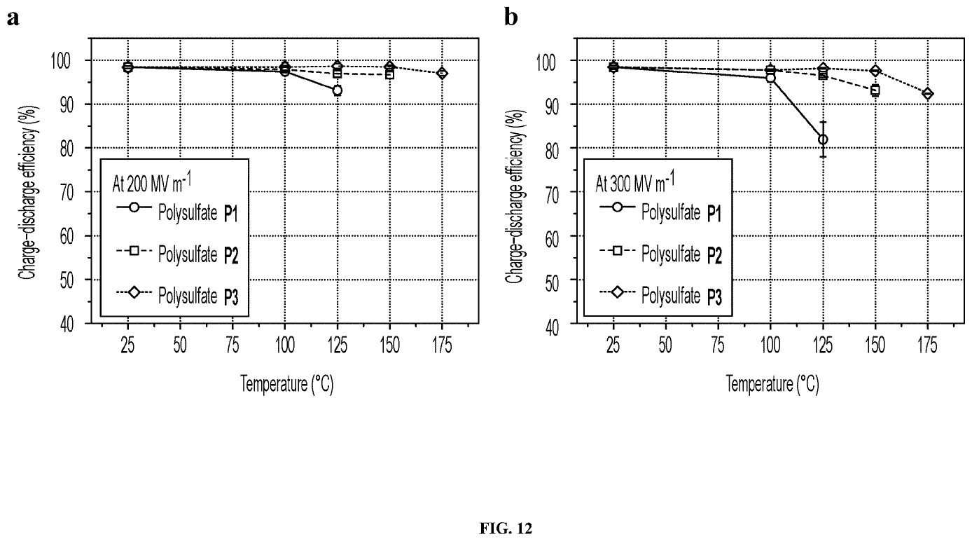

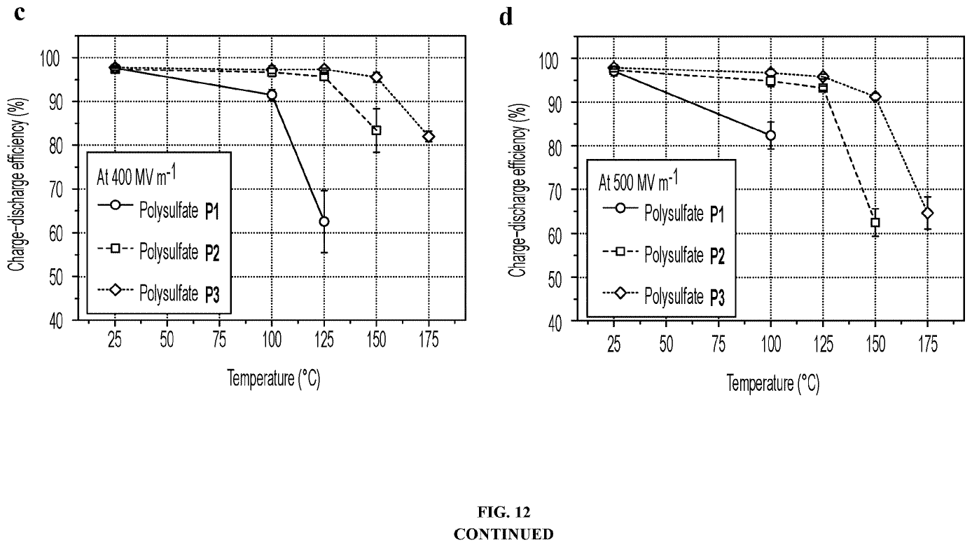

The electrostatic energy storage capability of polysulfate-based capacitors has also been evaluated. The U_{d} and n are derived from unipolar electric displacement-electric field (D-E) loops. At 25° C., all the polysulfates exhibited excellent n values >93% over the entire applied electric field range up to 750 MV m⁻¹. The U_{d} at the same electric field follows the rank of P2>P1>P3 (e.g., at 400 MV m⁻¹, 3.09, 2.86, 2.79 J cm⁻³ for P2, P1 and P3, respectively), which is in line with the descending trend of k (i.e., 3.80, 3.53 and 3.40 for P2, P1 and P3, respectively) (FIG. 1, panel (b) and FIG. 10). At elevated temperatures reaching 150° C. and above, the polysulfate P3 maintains the greatest capacitive performance among the three polysulfates (FIGS. 11 and 12), thanks to its highest T_{g} and Weibull E_{b} coupled with the relatively high k. P3 also far outperforms all the known high-T_{g} dielectric polymers at 150° C. in terms of the U_{d} and the n (FIG. 2, panels d-e). For example, at 150° C., polysulfate P3 can discharge an U_{d} of about 6 J cm⁻³ under 600 MV m⁻¹ with an n of higher than 80%. Comparatively, PEN and PEI, the next-best dielectric polymers evaluated in this study, deliver a U_{d} of 3.71 and 3.06 J cm⁻³ along with an of 79.2% and 43.5%, respectively, at their maximum tolerable field of 500 MV m⁻¹. A low n implicates a substantial portion of the charged energy that is converted into waste heat, which reduces the operational reliability and lifespan of capacitors. The U_{d} achieved at above 95% n and 150° C. is summarized in FIG. 2, panel (f), in which the polysulfate P3 stands out from the commercially available capacitor films and the latest reported dielectric polymers. For instance, with 5% energy loss during their charge and discharge processes, the U_{d} values of polysulfate P3 is 3.14 J cm 3, comparing favorably to about 2.7 J cm⁻³ of ortho-polyoxafluorinated norbornene (o-POFNB), about 2.1 J cm⁻³ of heat-treated poly (naphthalene ether ketone amide) (ht-PEKNA) and 1.25 J cm 3 of PEI, while other polymers display U_{d}s<1 J cm⁻³.

Surface Coating of Al₂O₃ Layers on Polymer Films

Substantial improvement of high temperature dielectric and energy storage properties are achieved by introducing wide-E_{g} Al₂O₃ nanocoatings onto both sides of the polysulfate P3 films via plasma-assisted atomic layer deposition (ALD) (see Examples, below). The thickness of Al₂O₃ nanocoatings was regulated from about 1.8 to 168 nm by varying deposition cycles, and confirmed by scanning transmission electron microscopic imaging (STEM) in conjunction with energy-dispersive spectroscopy (EDS) mapping analysis, from which the inorganic layers can be well distinguished according to the elemental distribution of C, O, Al and S. The conformal deposition of Al₂O₃ was verified by atomic force microscopy (AFM). The root mean square roughness (RMS) of the coating layers, ranging between 0.8 and 2.7 nm, is comparable to that of the pristine solution-cast polymer film. Such conformal coating is advantageous not only for facilitating the subsequent metallization, but also for alleviating local electric field distortion to ensure high insulation strength.

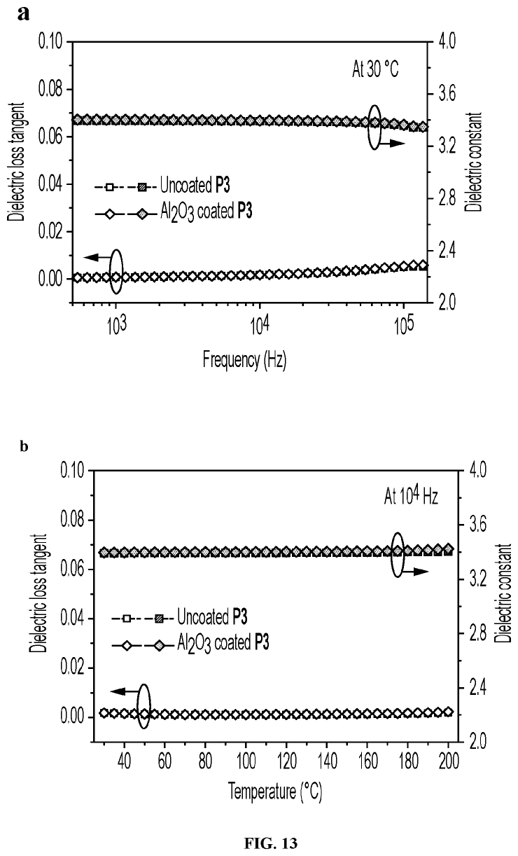

As shown in FIG. 13, the incorporation of Al₂O₃ coating has a marginal impact on the low-field dielectric properties (i.e., k and tan δ) of the polysulfate P3 films over the entire range of frequency and temperature. In stark contrast, the high-field properties of the polymer films are strongly dependent on the presence of Al₂O₃ nanocoatings. The influence of the coating thickness on the E_{b} of polysulfate P3 films (Table 3) was investigated.

TABLE 3
Weibull breakdown parameters of polysulfate P3
and Al₂O₃ coated polysulfate P3 films with different
coating thicknesses measured at 150° C.

| | Weibull E_{b} | |
|---|---|---|
| Sample | (MV m⁻¹) | β |
| Polysulfate P3 | 604 | 13.4 |
| P3 with 1.8 nm Al₂O₃ coating | 674 | 17.1 |
| P3 with 5.1 nm Al₂O₃ coating | 714 | 17.2 |
| P3 with 21.4 nm Al₂O₃ coating | 697 | 14.0 |
| P3 with 51.6 nm Al₂O₃ coating | 681 | 12.1 |
| P3 with 168 nm Al₂O₃ coating | 664 | 11.4 |

The Weibull E_{b} of the polysulfate P3 films peaks at about 5 nm of Al₂O₃ coating, i.e., 714 MV m⁻¹ at 150° C., amounting to an 18% improvement over the uncoated polysulfate P3. The optimized coating thickness also induces a higher 8 value derived from Weibull statistics, i.e. 17.2 for Al₂O₃ coated sample versus 13.4 for neat polymer, denoting a narrower distribution of experimental results and improved dielectric reliability of the surface-coated films. The E_{b} of Al₂O₃ coated and uncoated polysulfate P3 films was compared at varying temperatures (Table 4).

TABLE 4
Weibull breakdown parameters of polysulfate P3 and P3 coated
with 5.1 nm Al₂O₃ measured at varied temperatures.

| | Temperature | Weibull E_{b} | |
|---|---|---|---|
| Sample | (° C.) | (MV m⁻¹) | β |
| Polysulfate P3 | 25 | 733 | 17.2 |
| | 100 | 700 | 16.7 |
| | 150 | 604 | 13.4 |
| | 175 | 492 | 6.94 |
| P3 with 5.1 nm | 25 | 747 | 17.0 |
| Al₂O₃ coating | 100 | 735 | 16.6 |
| | 150 | 714 | 17.2 |
| | 175 | 631 | 13.0 |

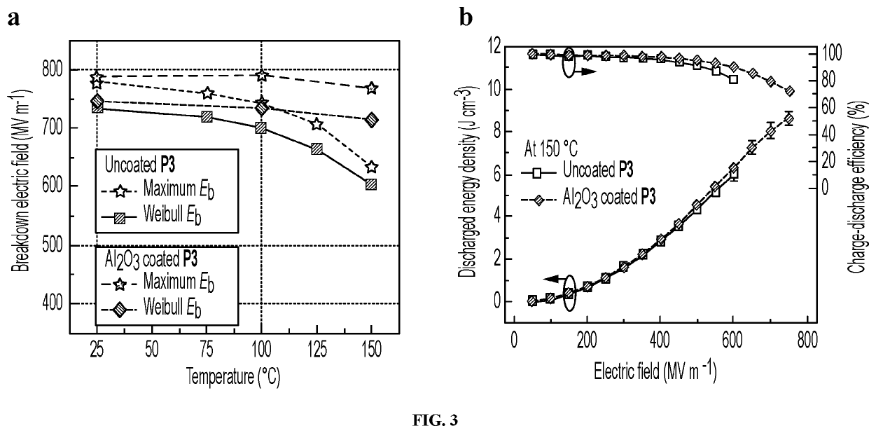

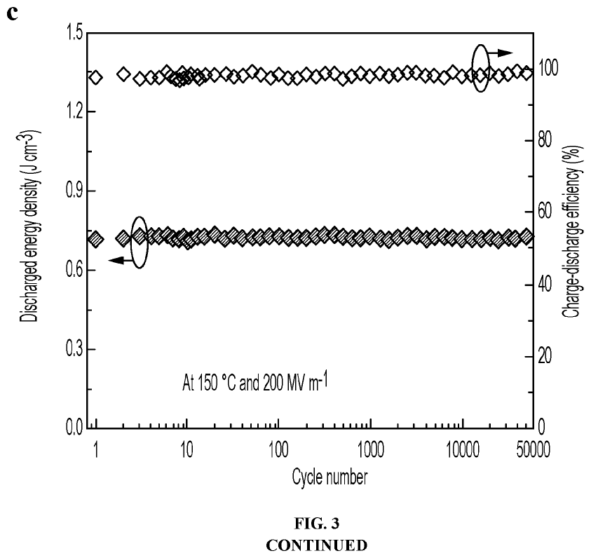

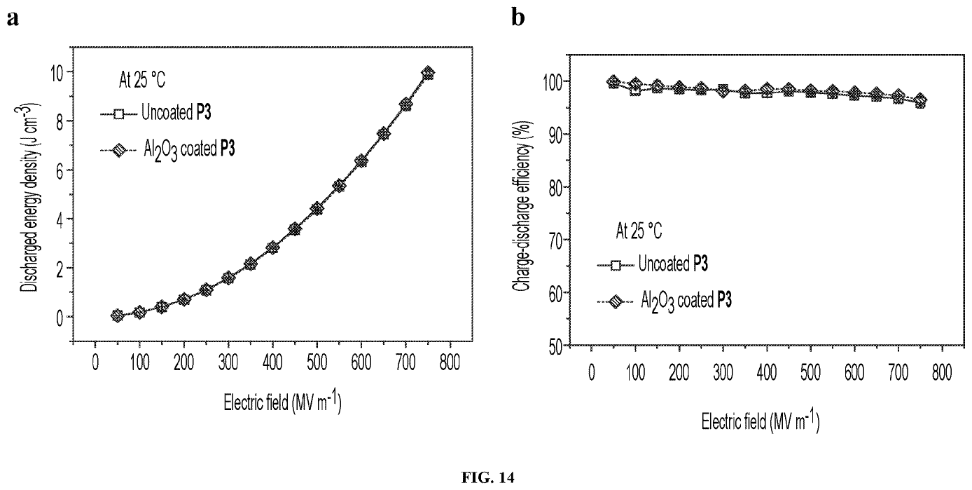

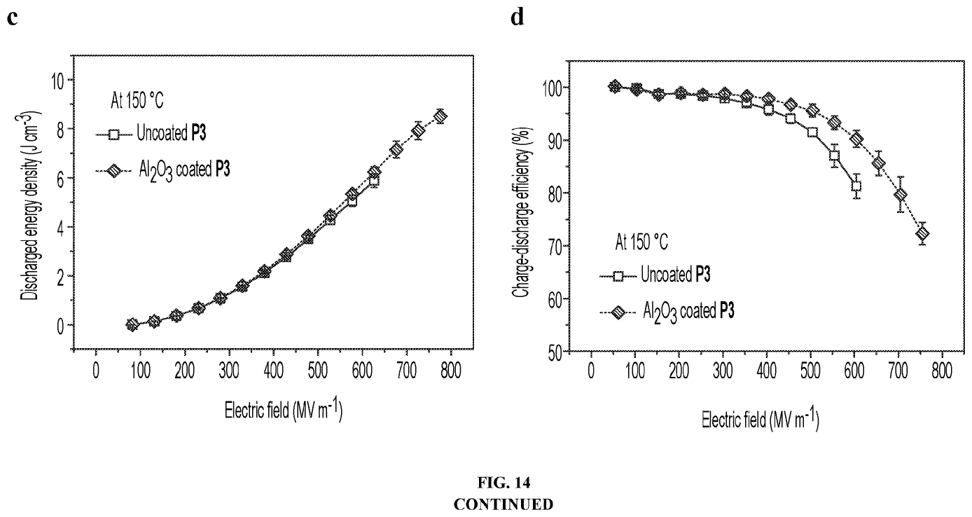

Although both films show a downward trend in E_{b} with increasing temperature, better retained E_{b} values are found at elevated temperatures upon the incorporation of Al₂O₃ nanocoating (FIG. 3, panel (a)). For instance, the Weibull E_{b} values decrease by 17.6% for uncoated polysulfate P3 but only by 4.3% for the about 5 nm Al₂O₃-coated sample from 25 to 150° C. More specifically, at 25° C., the Al₂O₃ coated film shows limited enhancement of U_{d} and n compared to the neat polysulfate P3, while the difference is more pronounced at elevated temperatures up to 150° C. (FIG. 14), suggesting that Al₂O₃ nanocoatings effectively enhance the thermo-dielectric stability.

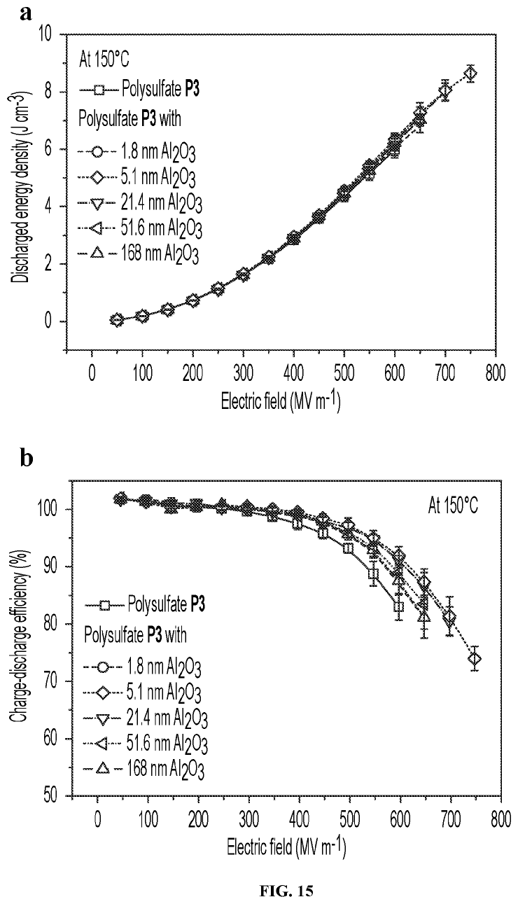

The energy storage properties of Al₂O₃-coated polysulfate P3 films were assessed at 150° C. compared to uncoated P3, which indicated that there were only minor differences in discharged energy density (U_{d}) for coated P3 relative to uncoated P3 for coatings having thicknesses in the range of about 1.8 to about 168 nm (FIG. 15, panel (a)). In contrast, the coated films exhibited improved charge-discharge efficiency, n, with the 5.1 nm coated film showing the highest overall efficiency (FIG. 15, panel a). D-E loop measurements confirmed that P3 polymer film with an Al₂O₃ coating thickness of about 5 nm exhibited the highest n compared with other coated films under the same electric field.

Notably, the optimal coating thickness of 5 nm is more than an order of magnitude smaller than the typical thickness of conventional inorganic oxide coatings adopted for polymeric capacitor films. For comparison, the thinnest coating in recent notable works on free-standing polymer films is about 80 nm. This represents a practical advantage for the time-effectiveness and for retaining the mechanical flexibility and operational cyclability of polymer films during wound capacitor cell fabrication. Reinforcement and defect introduction are the two competing factors associated with the thickness dependence of Al₂O₃ coatings that govern the dielectric breakdown behavior and energy storage properties of polysulfate P3 films. The former indicates that the polymer-Al₂O₃ interface may play a key role in impeding charge injection when the deposited coatings are optimally thin and ideally defect-free. On the other hand, the latter manifests the detrimental effect of accumulated defects such as A¹-OH groups due to incomplete chemisorption of trimethyl aluminum when increasing the thickness of the Al₂O₃ coating layer. The presence of defect states is disadvantageous for electrical insulation, especially under high temperatures and electric fields.

To verify that the few-nanometer thickness for an inorganic oxide coating is optimal for higher performance, PEN, which has been identified as one of the best commodity capacitor-grade films, was selected as the control polymer system. The highest Weibull E_{b} value for coated PEN was reached with coating layers of Al₂O₃ as thin as about 5.6 nm, further indicating a critical yet overlooked sub-10 nm size region that has both fundamental and practical implications for polymer dielectrics. The ultrathin coatings achieved under low processing temperature engenders additional benefits such as higher throughput, benign fabrication process, and better retained mechanical flexibility and operational cyclability of polymer films, all conducive to future wound capacitor cell fabrication.

Equipped with concurrently improved n and Eb, the polysulfate P3 film with the optimal Al₂O₃ coating thickness delivered a maximal Ud of 8.64 J cm⁻³ obtained at an applied field of 750 MV m⁻¹ at 150° C., which represents a 24% enhancement compared to the uncoated film (FIG. 3, panel (b)). This U_{d} is the highest compared to reported free-standing dielectric polymer and nanocomposite thin films operated at the same temperature and field strength.

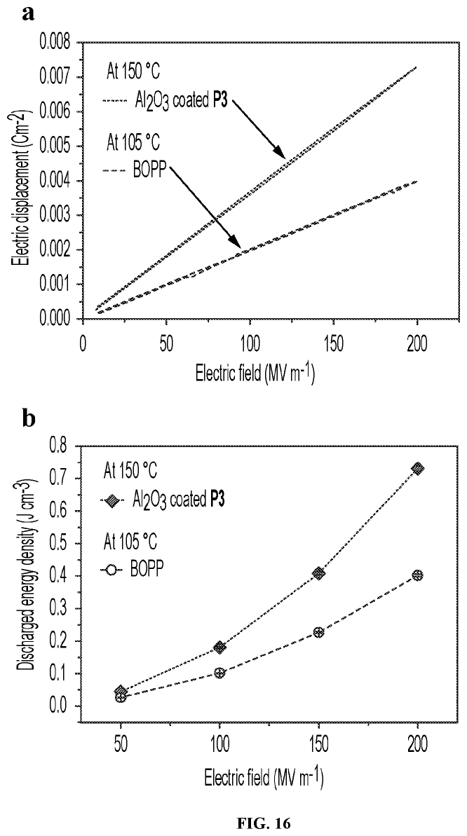

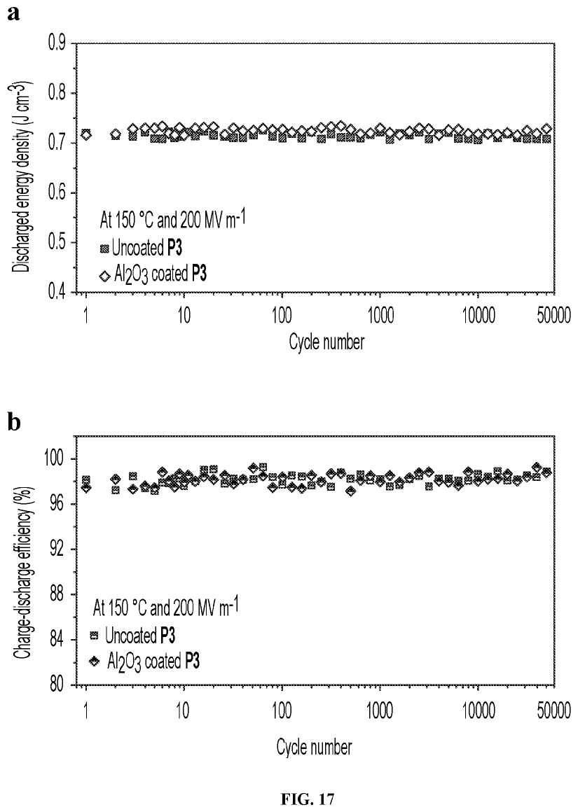

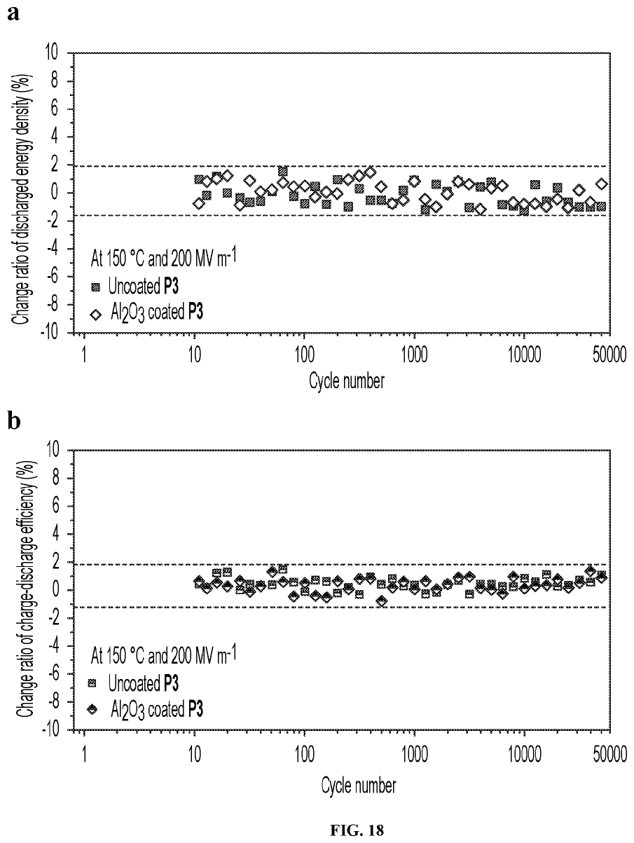

At an applied field of 200 MV m⁻¹, which is the working condition of capacitors in common power systems such as hybrid electric vehicles, the Al₂O₃ coated polysulfate P3 film shows almost negligible energy loss (i.e., <2% at 150° C.) and considerably higher U_{d} than that of the benchmark BOPP (e.g., about 0.72 J cm⁻³ at 150° C. vs. about 0.4 J cm⁻³ at 105° C.) (FIG. 16). Both uncoated and coated polysulfate P3 films show almost no signs of degradation in capacitive performance (data variation <1.6%) over successive 50,000 charging/discharging cycles at 200 MV m⁻¹ and 150° C. (FIG. 3, panel (c), FIG. 17, and FIG. 18), indicative of the excellent operational reliabilities of polysulfates and their suitability for electrification application under extreme conditions. Both native and Al₂O₃ coated polysulfate P3 films show excellent cyclic stability. Quantitatively, polysulfate P3 has C_{Ud}≤1.52% and C_{η}≤1.49%, and P3 coated with 5.1 nm Al₂O₃ has C_{Ud}≤1.47%; C_{η}≤1.35%, over 50,000 consecutive charging/discharging cycles at 150° C. and 200 MV m⁻¹

### Electrical Conduction and Charge Behavior

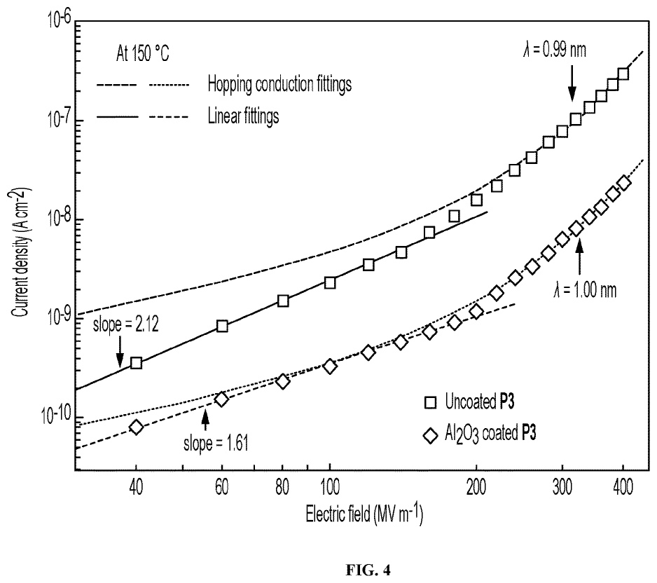

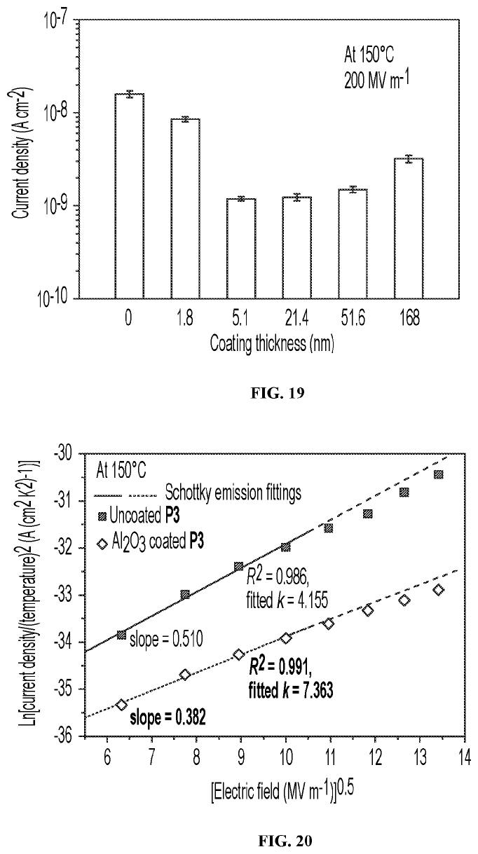

Leakage current measurements were performed on polysulfate P3-based films, since it is well recognized that electrical conduction is the foremost energy loss mechanism of dielectric materials at elevated electric fields. The leakage current density of thin films measured at 150° C. and 200 MV m⁻¹ declines as thin layers of Al₂O₃ coating were applied (FIG. 19). It reaches a minimum at the optimal coating thickness of about 5 nm, with a decrease of over an order of magnitude compared to that of the neat polymer. Field-dependent leakage current density studies reveal a distinct transition for both native and Al₂O₃-coated polysulfate P3 films within the field strength range of 40-400 MV m⁻¹ (FIG. 4). Segmented curve fittings suggest that the electrical conduction in polysulfate P3 films is dominated by charge injection-governed Schottky emission in the low field region (i.e., ≤200 MV m⁻¹) and a transport-limited hopping process in the higher field region, respectively (FIGS. 20, 21, and 22).

The slopes from Schottky emission fittings (FIG. 20) are 0.510 and 0.382 for polysulfate P3 and Al₂O₃ coated P3, respectively, with high quality of fitting (R²) between 0.986 and 0.991. The k values derived from the fitting slopes are 4.155 and 7.363 for polysulfate P3 and Al₂O₃ coated P3, respectively, which are close to the experimental data, suggesting that the Schottky emission should be the primary conduction mechanism in the low-field region (i.e., ≤200 MV m⁻¹).

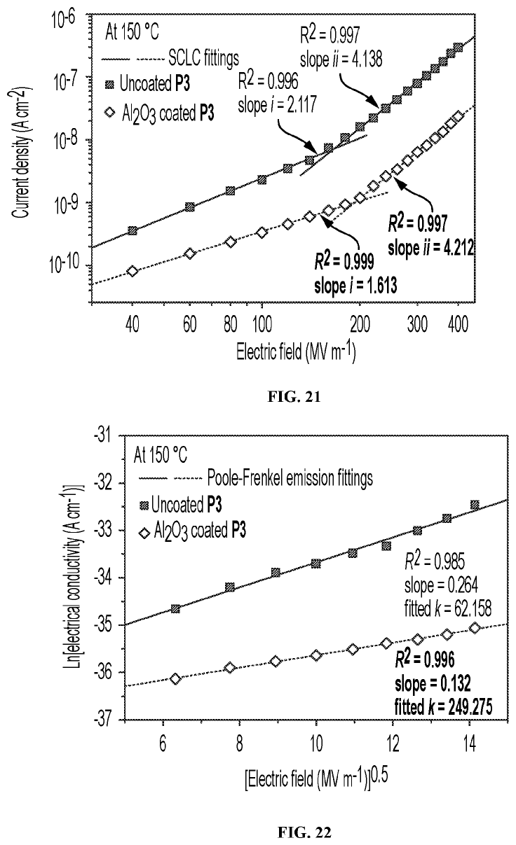

FIG. 21 shows fitting of the leakage current according to Ohm's law. The J and the E of the Ohm's law are supposed to show a linear relationship in the double logarithmic coordinates with a slope of 1.0. However, the slopes, i, derived from the linear fittings in the low-field region (i.e., ≤200 MV m⁻¹) are 2.117 and 1.613 for polysulfate P3 and Al₂O₃ coated P3, respectively. Similarly, the J and the E of the SCLC theory are supposed to show a linear relationship in the double logarithmic coordinates with a slope of 2.0. However, the slopes, ii, derived from the linear fittings in the high-field region (i.e., >200 MV m⁻¹) are 4.138 and 4.212 for polysulfate P3 and Al₂O₃ coated P3, respectively. Although the quality of fitting (R²) are high, ranging between 0.996 and 0.999, the fitted slopes show a large discrepancy from the theoretical values, suggesting that the conduction behavior should be mainly determined by other mechanisms.

FIG. 22 shows fittings from the Poole-Frenkel emission. The slopes from the Poole-Frenkel emission fittings are 0.264 and 0.132 for polysulfate P3 and Al₂O₃ coated P3, respectively, with high quality of fitting (R²) between 0.985 and 0.996. The corresponding k values derived from those fitting slopes are 62.158 and 249.275 for polysulfate P3 and Al₂O₃ coated P3, respectively, which are far larger than the experimental data, indicating that the Poole-Frenkel emission is not the governing conduction mechanism in the low-field region (i.e., ≤200 MV m⁻¹).

The Al₂O₃ nanocoating decreases the slope of the low-field linear fitting curve(s), but has almost no effect on hopping distances (λ, about 1 nm) derived from fitted hyperbolic sines based on a hopping conduction model (see Methods and FIG. 4). The results indicate that the ultrathin Al₂O₃ layer mainly regulates charge injection near the electrode rather than charge transport across the bulk polymer.

The nanocoating improved electrical insulating behavior can be rationalized based on the corresponding energy band diagrams of the electrode-dielectric interfaces, the band structures of which were derived from X-ray photoelectron spectroscopy (XPS) and ultraviolet photoelectron spectroscopy (UPS). As a result of a smaller electron affinity (Eₐ) and a larger E_{g} of Al₂O₃ relative to polysulfate P3, the interfacial barrier heights for electrons and holes are raised from 2.5 and 1.4 eV for the Au-polymer interface to 4.0 and 2.7 eV for the Au—Al₂O₃ interface, respectively, which account for the observed inhibited Schottky emission.

Another considerable energy barrier (ΔEₐ=1.5 eV) is present in the heterojunction of Al₂O₃-polysulfate P3, which can act as interfacial trap sites and has been further elucidated by tracking the surface potential decay using the non-contact Kelvin probe force microscopy (KPFM). In the coated polysulfate P3 film, the Al₂O₃ layer leads to a remarkably faster charge dissipation, with the normalized extremal contact potential difference (CPD) declining dramatically within 5 minutes. In stark contrast, the normalized extremal CPD of the coating-free film shows minor decay even after 50 minutes. The peak value of the normalized CPD decreases to about 10% for the coated film while retaining over 80% for the uncoated sample at 25 minutes. The contrasting charge dissipation behavior between different interfaces supports that the injected charges migrate across the coating layer (during voltage-on) and accumulate at the Al₂O₃-polymer interface, which induces a built-in electric field in the opposite direction to the applied field. Such a reverse electric field provides a driving force for charges to rapidly dissipate in the Al₂O₃ coated sample during voltage-off (i.e., KPFM scanning). The presence of the built-in field near the Al₂O₃-polymer interface also contributes to an augmented injection barrier, which is expected to repel further net inflow of electrons from the electrode. The interface-induced injection barrier is responsible for the reduction in the leakage current and for the synergetic increases in Eb, U_{d} and n observed in the Al₂O₃ coated polysulfate films, confirming the critical role of nanocoatings in improving the polymer's dielectric and energy storage characteristics.

Readily accessible aryloxy linked polysulfates and polysulfonates (e.g., polymers of Formulas I, II, III, and IV) are a new class of high-temperature, high-dielectric-strength polymers that meet the stringent requirements for harsh electrification conditions. The specific fluorene core-based polysulfate P3 balances key operational considerations regarding electronic, electrical and thermal parameters for high temperature polymer dielectrics, displaying a wide bandgap, high glass transition temperature, high dielectric constant and low dielectric loss. The corresponding thin films have demonstrated superior dielectric stability over a wide temperature range from room temperature to 200° C. Furthermore, deposition of ultrathin (about 5 nm) Al₂O₃ nanocoatings by an atomic layer deposition process leads to significantly reduced leakage current, and consequently further improved breakdown strength and electrostatic energy storage capacities. The polysulfate-based film capacitors deliver an unexpectedly high discharged energy density of 8.64 J cm⁻³ at 150° C. Key insights into the correlation between dielectric properties and charge transport behavior illuminate the critical role of the coating layer in enhancing the high-temperature electrostatic energy storage performance of polymeric films.

### EXAMPLES

### Polymeric Film Preparation.

Polysulfates P1-P3 were synthesized by bifluoride-catalyzed sulfur (VI) fluoride exchange polycondensation (2 mol % of KHF2/1 mol % of 18-crown-6 catalysis in NMP at 130° C.), according to a previous procedure. P1 powders were dissolved in NMP to yield a clear solution with a concentration of 20 mg mL⁻¹ under magnetic mechanical stirring overnight at 60° C. P2 and P3 powders were dissolved in DMF to yield a clear solution with a concentration of 20 mg mL⁻¹ under magnetic mechanical stirring overnight at room temperature. The obtained P1/NMP solution was cast on clean glass slides at room temperature, and kept in an air-circulating oven at 95° C. for 12 hours (h) to evaporate the solvent. The obtained P2/DMF and P3/DMF solutions were cast on clean glass slides at room temperature, and kept in an air-circulating oven at 65° C. for 12 h to evaporate the solvent. Afterward, the resultant polymer films were peeled off in deionized water and placed in a vacuum oven at 180° C. for 12 h to remove water and solvent residuals. The typical thickness of the free-standing polysulfate films is 2-5 μm. Comparative free-standing polymer films of UPILEX-S PI, KAPTON PI, BOPP, PEEK, PEN, FPE and PEI were obtained from PolyK Technologies, LLC., USA. The details of these commercial capacitor-grade dielectric films can be found in Table 1, above.

Al₂O₃ coatings were deposited using plasma-assisted ALD at 40° C. (FLEXAL, Oxford Instruments). At each cycle, trimethylaluminum (TMA) is dosed for 20 ms, followed by TMA purge using Ar/O₂ mixture for 4 s and plasma dose for 2 s. All processes were conducted at 15 mTorr. The deposition rate was controlled at 0.139 nm per cycle. The polymer films were suspended using a custom steel frame to ensure equal depositions on both sides. For all the dielectric and electrical measurements, both sides of the polymeric films were coated with gold electrodes using a magnetron sputter (Q150R from Quorum) with a thickness of 20 nm and an area of 4 mm² for dielectric breakdown and electric displacement-electric field (D-E) loop measurements, and an area of 50.24 mm² for dielectric spectroscopy, leakage current and cyclic charging/discharging measurements.

### Capacitor Preparation

Capacitors were prepared as free-standing thin polymeric films, with or without dielectric coatings, with gold electrodes on both sides. The typical thickness of the tested free-standing polysulfate films was 2-5 μm. Both sides of the polymeric films were coated with gold electrodes using a magnetron sputter (Q150R, from Quorum) with a thickness of about 20 nm and an area of about 4 mm² for dielectric breakdown and electric displacement-electric field (D-E) loop measurements, an area of 28.26 mm² for direct fast discharge (power density) test, and an area of about 50.24 mm² for dielectric spectroscopy, leakage current and charging/discharging cyclic measurements (see, e.g., FIG. 1, panel (d)).

The thickness of gold electrodes can be tailored by adjusting the sputtering time. The area of gold electrodes can be tailored by using different-sized masks. The sputtered gold electrodes were used due to the convenience of lab sample preparation considerations. A preferred electrode material for production purposes is aluminum.

### Thermal Characterization

The differential scanning calorimetry (DSC) analysis was carried out on TA Q200 under nitrogen using aluminum pans with a heating rate of 10° C. min⁻¹. According to the ASTM E1356-08 (2014): Standard Test Method for Assignment of the Glass Transition Temperatures by Differential Scanning calorimetry, the glass transition temperature (T_{g}) is defined as the midpoint temperature of a step in the baseline of the DSC curve. Thermal gravimetric analysis (TGA) was carried out on TGA-MS Q5000 (TA Instruments) under nitrogen using aluminum pans with a heating rate of 10° C. min⁻¹ from 25° C. to 600° C. All the polymer samples were treated in a vacuum oven at 105° C. for 30 min prior to DSC and TGA measurements.

### Structural Characterization.

The solution-based ¹H NMR spectra for polysulfate P1 was recorded at 100° C., and for polysulfates P2-P3 were recorded at room temperature on an AVANCE II 500 (Bruker, Germany) using the deuterated solvent dimethyl sulfoxide-d₆ (DMSO-d₆). As used herein, number average molecular weight Mn and polydispersity index (PDI) are determined via size exclusion chromatography (SEC) on a MALVERN OMNISEC equipped with refractive index detector, right-angle and low-angle light scattering detectors, and capillary viscometer. The polymer powder samples are dissolved in a pre-prepared solvent (DMF with 0.2% LiBr) with a concentration of 2 mg mL⁻¹, and filtered using 0.2 μm NYLON filters. The measurements were performed in DMF at 1 mL min⁻¹ at 45° C. and on two VISCOTEK T6000M styrene-divinyl benzene columns in series. Fourier transform infrared (FTIR) spectra were recorded in an attenuated total reflectance (ATR) mode equipped with a ZnSe crystal as a contact to the samples on a NICOLET IS50 FT-IR system (Thermo Fisher Scientific, USA). X-ray diffraction (XRD) patterns were recorded on a RIGAKU X-ray diffractometer using Cu-Kα radiation (2=0.15418 nm) at 40 kV and 20 mA. X-ray photoelectron spectroscopy (XPS) and ultraviolet photoelectron spectroscopy (UPS) spectra were performed in a THERMO SCIENTIFIC K-ALPHAPLUS instrument equipped with monochromatic A¹ Kα radiation and 1486.7 eV source was used for XPS and 21.2 eV He (I) discharge source was used for UPS. The X-ray analysis area for measurement was set at 200×400 μm (ellipse shape) and a flood gun was used for charge compensation. The base pressure of the analysis chamber was less than about 1× 10⁻⁹ mbar. The analysis chamber pressure was at 1×10⁻⁷ mbar during data acquisition.

UV-vis absorption spectra of the polymer film samples were obtained on an AGILENT CARY 5000 UV-Vis-NIR spectrometer. The optical transmittance of the samples was measured in the wavelength range 200-700 nm. Atomic force microscopy (AFM) images were acquired with an ASYLUM RESEARCH CYPHER VES atomic force microscope in a nitrogen saturated atmosphere. In order to resolve the samples topography, AFM images were obtained using the Amplitude Modulation technique. Kelvin probe force microscopy (KPFM) images were acquired with an ASYLUM RESEARCH CYPHER VES atomic force microscope in a nitrogen saturated atmosphere.

Free-standing polymeric film samples were attached onto indium tin oxide (ITO) coated glass substrates (2-3 Ω sq⁻¹, Thin Film Devices Inc., USA), silver paint (LEITSILBER 200, TED PELLA, INC., USA) was used to ensure electrical contact between the polymeric film and ITO layer, as well as electrically ground the ITO layer. For KPFM images, a low frequency electrostatic excitation about 2 kHz) is applied on the metallized AFM tip (PPP-EFM, available from NanoWorld, with typical stiffness of about 2 Nm⁻¹ and resonance frequency of about 70 kHz). A feedback loop controls an additional DC voltage applied to the tip in order to keep the electrostatic tip-sample interaction as small as possible. This applied DC voltage provides a direct measure of the charge potential difference (CPD) between the tip and the sample. For charge injection, a typical conductive-AFM setup was used with a high voltage source being connected to the tip and the back of the sample. A voltage ramp is applied from 0 to 85 V at a rate of 15 V s⁻¹ and then kept at 85 V for 5 s before turning it off.

Transmission electron microscope (TEM) images were obtained using a FEI TECNAI 12 at an accelerating voltage of 120 kV. Scanning transmission electron microscope energy dispersive X-ray spectroscopy (STEM-EDS) was performed at National Center for Electron Microscopy (NCEM) of Lawrence Berkeley National Laboratory by using a FEI TITANX 60-300 microscope operated at 200 kV. A BRUKER windowless EDS detector with a solid angle of 0.7 steradians enables high count rates with minimal dead time. The data were visualized with ESPRIT 1.9 software. Cross-sectional samples for TEM and STEM-EDS measurements were prepared by embedding polymeric film samples in epoxy resin (ARALDITE 502, Electron Microscopy Sciences) and cured at 60° C. overnight. Sections about 60 nm in thickness were microtomed using an RMC MT-X ULTRAMICROTOME (Boeckler Instruments), floated on top of the water, and picked up on copper TEM grids.

### Electrical Characterization.

Dielectric spectra of the polymeric film samples were acquired over wide frequency and temperature ranges using a HEWLETT PACKARD 4284A LCR meter. The samples in a dielectric test fixture were placed in a temperature chamber (EC1A, Sun Electronic Systems, Inc.), where the temperature-dependent dielectric spectra were acquired between 30° C. and 200° C. The temperature coefficient C_{T} of the k is obtained from Equation (1)

$${C}_{T} = \vert \frac{{k}_{i} - {k}_{0}}{{T}_{i} - {T}_{0}} \vert \times 100 \% \qquad ( 1 )$$

where ki is the k at temperature Tᵢ, and ko is the k at T₀ (i.e., 30° C.). Dielectric breakdown strengths of the polymeric film samples were measured using a TREK 610D instrument amplifier as the voltage source based on an electrostatic pull-down method, where a DC voltage ramp of 500 V s⁻¹ was applied to the film samples until dielectric failure. The breakdown strength was evaluated by performing a two-parameter Weibull distribution analysis (Equation (2)) on at least 10 samples

$$P ( {E}_{b} ) = 1 - exp ( - {( \frac{{E}_{b}}{α} )}^{β} ) \qquad ( 2 )$$

where P(E_{b}) is the probability of breakdown at a certain electric field strength, E_{b} is the measured dielectric breakdown field, a is the Weibull breakdown strength (i.e., Weibull E_{b}) which is associated with the electric field at a 63.2% probability of breakdown, β is the shape parameter which represents the dispersion degree of the data. D-E loops of the polymeric film samples were measured under varied applied electric fields using a modified Sawyer-Tower circuit, which is integrated with a PK-CPE1801 high voltage test system (PolyK Technologies, LLC.). The voltages with a unipolar triangular waveform were applied at a frequency of 100 Hz. The charging/discharging cyclic measurements were performed by collecting D-E loops under a consecutive repeated electric field of 200 MV m⁻¹ based on the same high voltage test system using the Fatigue mode. The direct fast discharge tests were performed through a capacitor discharge system with a high-voltage metal oxide semiconductor field-effect transistor (MOSFET) switch (Behlke HTS81). The charged energy was released to a load resistor (R_{L}), the resistance of the R_{L} was selected as 100 kΩ. The discharge time ((95%) is defined as the time for the released energy in a load resistor (R_{L}) to reach 95% of the final value. Power density (P) is given as P=U95%/195%, where U95% is the discharged energy density recorded at the discharge time. The discharge time depends on the resistance of R_{L}, the capacitance of the film sample, as well as the equivalent series resistor (ESR) value of the system. At 150° C. and under 200 MV m⁻¹, the discharge time t95% and the power density P of polysulfate P3 are 37.57 μs and 19.01 MW L⁻¹, respectively (FIG. 1, panel (d)). For dielectric breakdown and D-E loop measurements, the samples were immersed in GALDEN HT-270 PFPE fluorinated fluid to avoid creeping discharge, and the temperature was controlled using a digital hot plate equipped with a thermal couple. Leakage current densities of the polymeric film samples were acquired under varied applied electric field strengths in a temperature chamber (EC1A, Sun Electronic Systems, Inc.), using a KEITHLEY 6514 electrometer coupled with an external Trek 610D amplifier as the voltage source. According to the hopping conduction equation, leakage current density (J) is given as

$$J ( E , T ) = 2 ne λ v \times exp ( - \frac{{W}_{a}}{{K}_{B} T} ) \times sinh ( \frac{λ eE}{2 {K}_{B} T} ) \qquad ( 3 )$$

where E is the applied electric field during current density measurement, n is the carrier concentration, λ is the hopping distance, vis the attempt-to-escape frequency, Wₐ is the activation energy, Tis the temperature, e is the charge of the carriers, K_{B} is Boltzmann's constant. Equation (3) can be simplified as

$$J ( E ) = A * sinh ( B \times E ) \qquad ( 4 )$$

where A and B are two lumped parameters.

The change ratio of discharged energy density (Cud) of a material is described as

$${C}_{Ud} = \vert ( {U}_{di} - {U}_{d 10} ) / {U}_{d 10} \vert \times 100 \% \qquad ( 5 )$$

where U_{di} is the U_{d} obtained from the i^{th} cycle (i stands for the number of cycles), and U_{d10} is the average value of U_{d} based on the first ten charging-discharging cycles.

The change ratio of charge-discharge efficiency (C_{η}) is described as

$${C}_{η} = \vert ( {η}_{i} - {η}_{10} ) / {η}_{10} \vert \times 100 \% \qquad ( 6 )$$

where ηᵢ is the η obtained from the i^{th} cycle (i stands for the number of cycles), and η₁₀ is the average value of η based on the first ten charging-discharging cycles.

According to the Schottky emission equation, leakage current density (J) is given as

$$J = {A}_{R} {T}^{2} exp ( \frac{- {ϕ}_{{B}^{+}} e \sqrt{eE / 4 πk {ε}_{0}}}{{K}_{B} T} ) \qquad ( 7 )$$

where A_{R} is the effective Richardson constant in A m⁻² K⁻², T is the temperature in K, e is elementary charge in C, φ_{B} is the interface energy barrier height in eV, E is the applied electric field in MV m⁻¹ during current density measurement, KB is Boltzmann's constant in J K⁻¹, k is the dielectric constant, co is the vacuum permittivity in F m⁻¹. Equation (7) can be transformed as

$$ln ( \frac{J}{{T}^{2}} ) = ( \frac{\sqrt{{e}^{3} / 4 πk {ε}_{0}}}{{K}_{B} T} ) \sqrt{E} + ln ( {A}_{R} ) - ( \frac{{ϕ}_{B}}{{K}_{B} T} ) \qquad ( 8 )$$

For Equation (8), the plot of ln(J/T²) versus \sqrt{E} is supposed to show a linear relationship. The k value derived from the slope of the fitted curve can be used to determine whether the conduction mechanism in the dielectric materials conforms to the Schottky emission.

According to the Ohm's law and the SCLC theory, two conduction equations for leakage current density (J) are as follows, respectively

$$J = σ E \qquad ( 9 )$$

$$J = \frac{9 μ {k}_{{E}_{0}} {U}^{2}}{8 {d}^{3}} \qquad ( 10 )$$

where σ is the DC conductivity in S m⁻¹, E is the applied electric field during current density measurement in MV m⁻¹, U is the applied voltage during current density measurement in MV, d is the thickness of sample in m, μ is the carrier mobility in m² V⁻¹ s⁻¹, k is the dielectric constant, co is the vacuum permittivity in F m⁻¹.

According to the Poole-Frenkel emission equation, leakage current density (J) is given as

$$J = {σ}_{0} E exp ( \frac{- {μ}_{PF} + e \sqrt{eE / {πkε}_{0}}}{{K}_{B} T} ) \qquad ( 11 )$$

where σ₀ is the initial conductivity in S m⁻¹ under low electric fields, T is the temperature in K, e is elementary charge in C, μ_{PF} is the trap barrier height in eV, E is the applied electric field in MV m⁻¹ during current density measurement, K_{B} is the Boltzmann's constant in J K⁻¹, k is the dielectric constant, co is the permittivity in vacuum in F m⁻¹. Equation (11) can be transformed as

$$ln ( \frac{J}{E} ) = ln ( σ ) = ( \frac{\sqrt{{e}^{3} / {πkε}_{0}}}{{K}_{B} T} ) \sqrt{E} + ln ( {σ}_{0} ) - ( \frac{{μ}_{PF}}{{K}_{B} T} ) \qquad ( 12 )$$

where σ is the volume electrical conductivity calculated from J/E. From Equation (12), the plot of ln(σ) versus \sqrt{E} is supposed to show a linear relationship. The k value derived from the slope of the fitted curve can be used to determine whether the conduction mechanism in the dielectric materials conforms to the Poole-Frenkel emission.

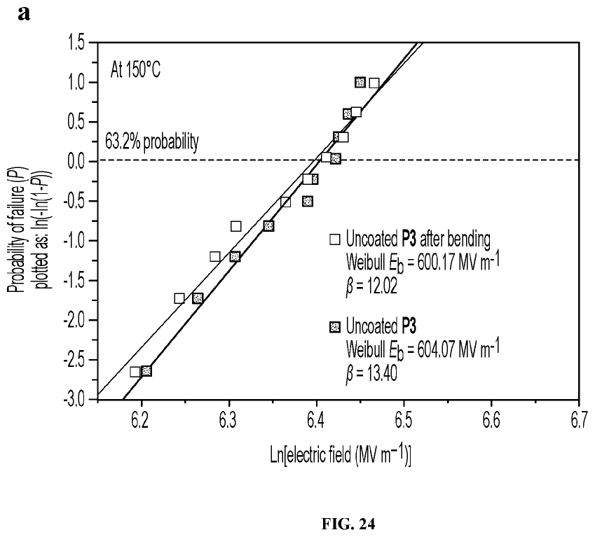

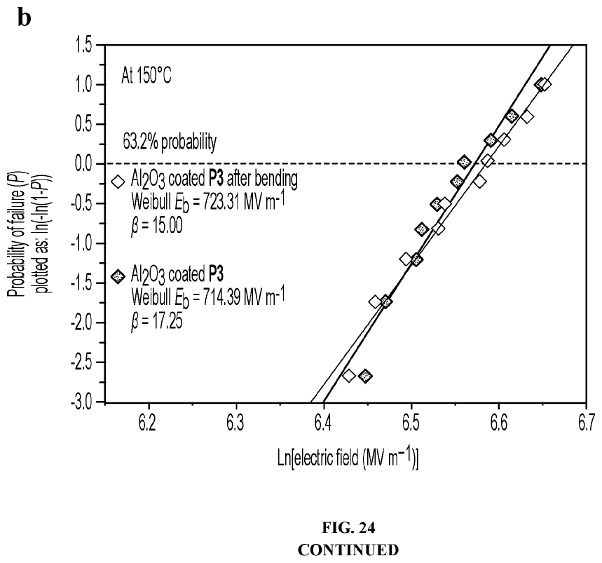

Measurements of strain versus stress and Young's modulus were performed on and uncoated P3 film and the corresponding films coated with about 5 nm thick Al₂O₃ on each face of the film. FIG. 23, panel (a), provides a stress versus strain curves for both films. FIG. 23, panel (b), provides bar graphs of the Young's modulus for both films. Effects of repeated bending of the coated and uncoated P3 films on dielectric breakdown strength breakdown strength were also evaluated. As demonstrated in FIG. 23, the 5 nm coating of alumina has marginal impact on the mechanical response of the film (i.e., Young's modulus). FIG. 24, panel (a), provides Weibull plots of dielectric breakdown strength of the uncoated P3 film, measured at 150° C. with and without 5000 consecutive bending cycles (6 mm bending radius). FIG. 24, panel (b), provides Weibull plots of dielectric breakdown strength of the 5 nm Al₂O₃-coated P3 film, measured at 150° C. with and without 5000 consecutive bending cycles (6 mm bending radius). The results showed that the uncoated film had a Weibull E_{b} of about 604 MV m⁻¹ and 8=13.40 without bending; and a Weibull E_{b} of about 600 MV m⁻¹ and 8=12.02 after 5000 bending cycles. In contrast, the coated film had a Weibull E_{b} of about 714 MV m⁻¹ and 8=17.25 without bending; and a Weibull E_{b} of about 723 MV m⁻¹ and 8=15.00 after 5000 bending cycles.

### Additional Polymer Examples

Table 5 provides structures of additional polysulfate polymers (P8-P36), along with their glass transition temperature (T_{g}) and molecular weight information (Mn in kiloDaltons (kDa), and polydispersity index (PDI), and for most examples their optical band gap (E_{g}), as determined by the methods described herein. The polymers with T_{g} values of at least about 120° C., preferably at least about at least about 190° C., are particularly useful for higher temperature capacitor applications.

TABLE 5

| Polymer structure | Ex. # | T_{g} (ºC.) | E_{g} (eV) |
|---|---|---|---|
| 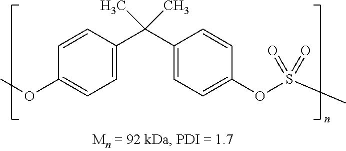 | P8 | 97.2 | 4.45 |
| 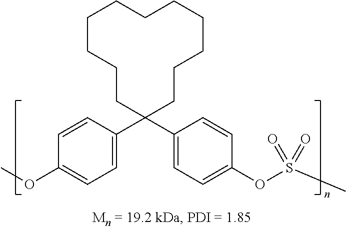 | P9 | 172.2 | 4.44 |
| 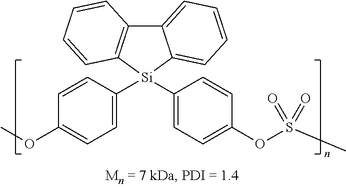 | P10 | 176.4 | 3.68 |
| 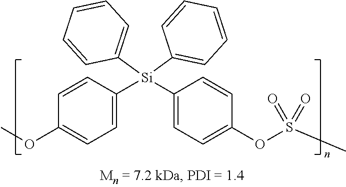 | P11 | 113.1 | 4.42 |
| 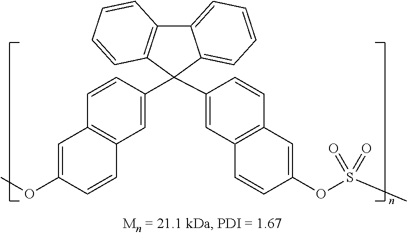 | P12 | 298 | 3.71 |
| 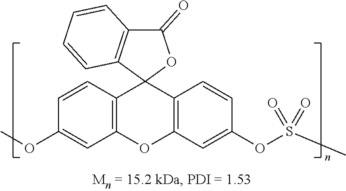 | P13 | 238.9 | 4.1 |
| 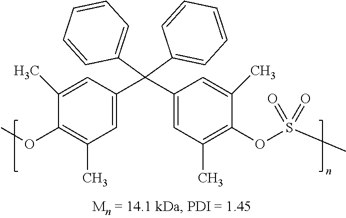 | P14 | 102.5 | 4.3 |
| 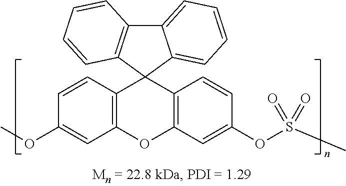 | P15 | 241.6 | 3.9 |
| 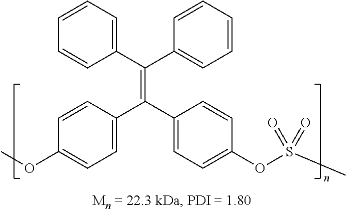 | P16 | 153.2 | 3.27 |
| 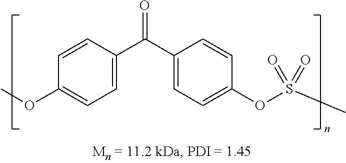 | P17 | 97.2 | 3.73 |
| 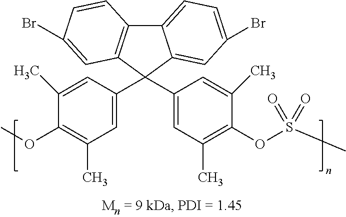 | P18 | 176.6 | 3.77 |
| 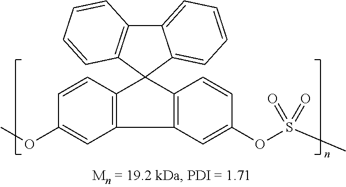 | P19 | 253.2 | 3.7 |
| 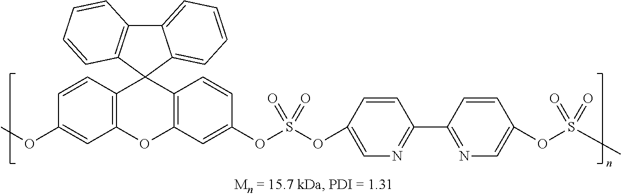 | P20 | 191.3 | 3.73 |
| 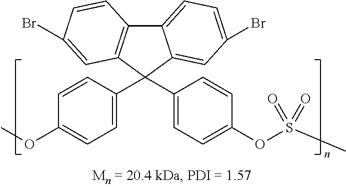 | P21 | 256.9 | 3.76 |
| 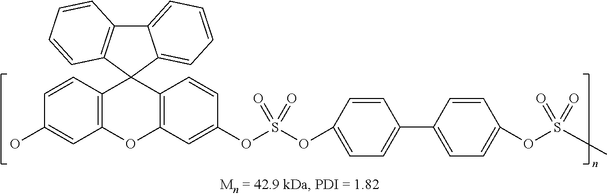 | P22 | 191.3 | 3.91 |
| 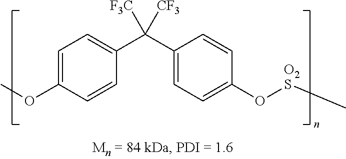 | P23 | 106.8 | 4.42 |
| 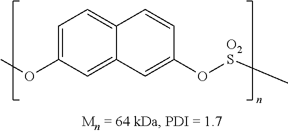 | P24 | 100.4 | 4.06 |
| 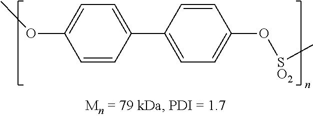 | P25 | 120.4 | 4.26 |
| 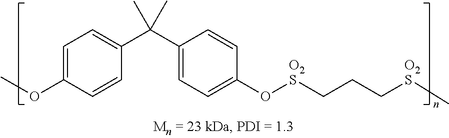 | P26 | 85.9 | 3.81 |
| 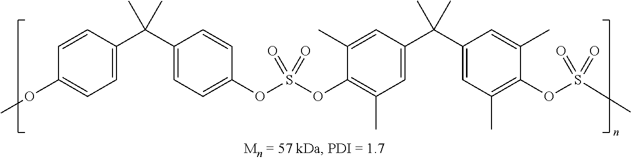 | P27 | 116.1 | Not measured |
| 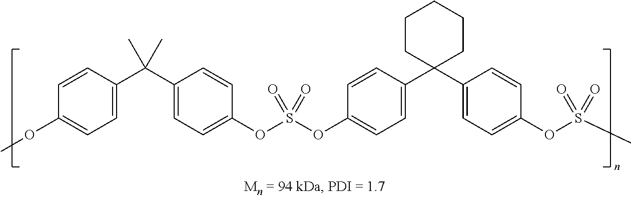 | P28 | 108.4 | Not measured |
| 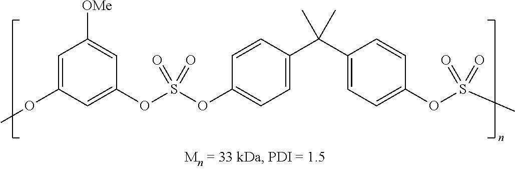 | P29 | 72.6 | Not measured |
| 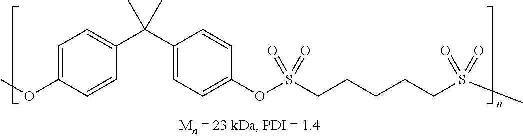 | P30 | 85.9 | Not measured |
| 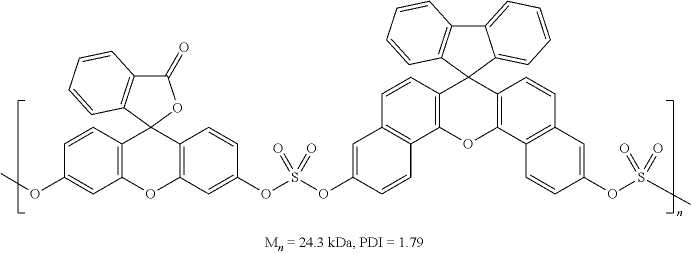 | P31 | 301.9 | 3.59 |
| 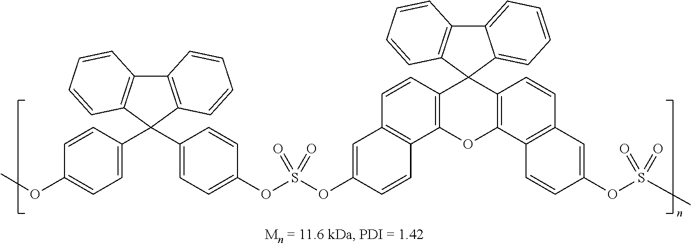 | P32 | 271.6 | 3.58 |
| 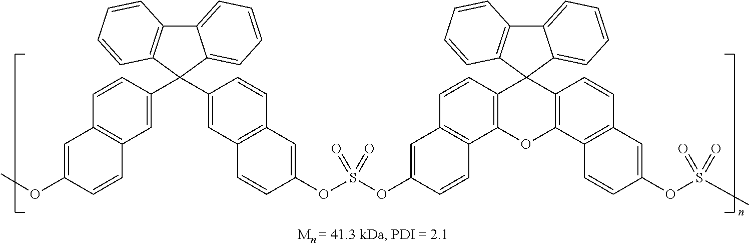 | P33 | >310 | 3.57 |
| 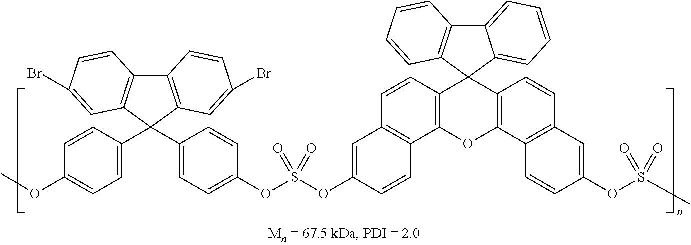 | P34 | 299.9 | 3.58 |
| 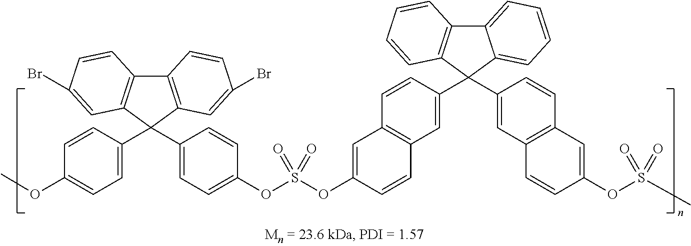 | P35 | 266.8 | 3.8 |
| 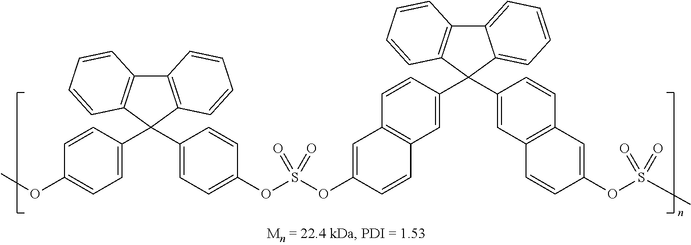 | P36 | 253.8 | 3.94 |
| 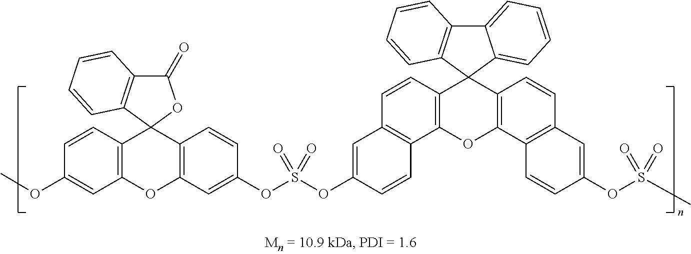 | P37 | 258.3 | 3.73 |
| 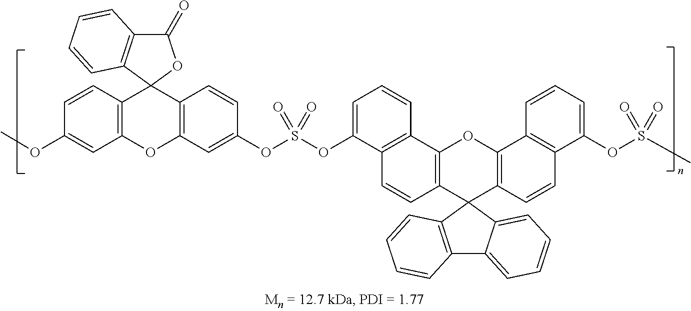 | P38 | >300 | 3.58 |
| 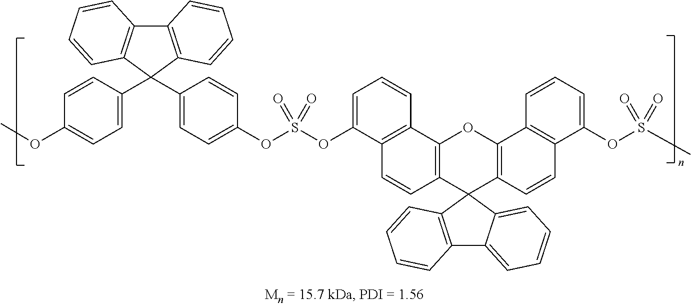 | P39 | 280.2 | 3.58 |
| 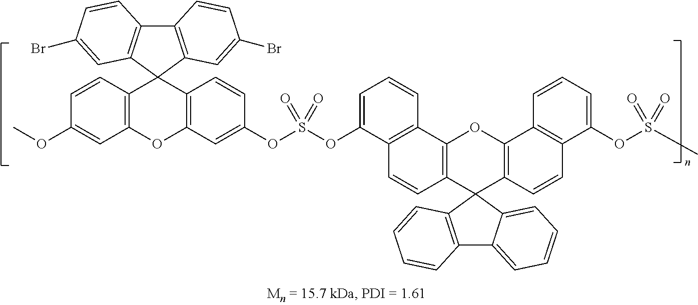 | P40 | >300 | 3.57 |
| 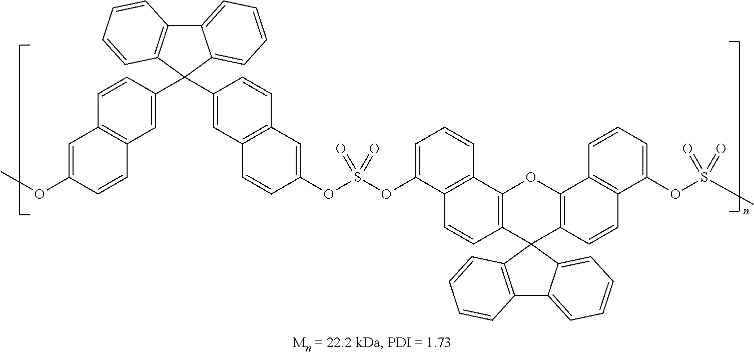 | P41 | >310 | 3.57 |

Table 6 provides structures of additional polysulfate polymers (P37-P43) that useful in the energy storage and capacitor devices described herein, which are predicted to have T_{g} values of at least about 230° C. and E_{g} values of at least about 3.6 eV, using an artificial intelligence-assisted method for calculating T_{g} and E_{g}.

TABLE 6

| Polymer structure | Example |
|---|---|
| 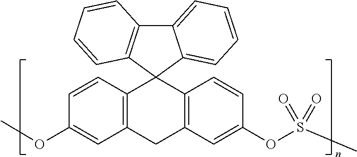 | P42 |
| 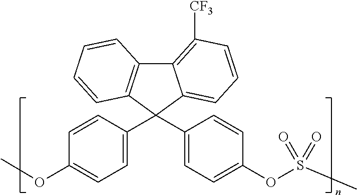 | P43 |
| 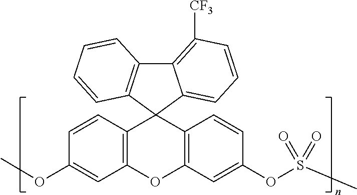 | P44 |
| 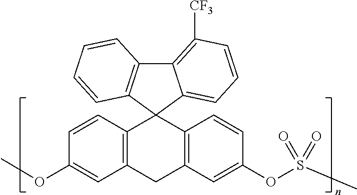 | P45 |
| 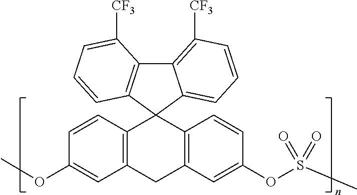 | P46 |
| 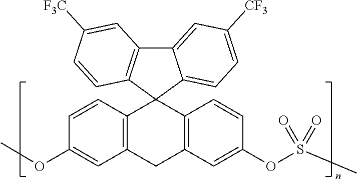 | P47 |
| 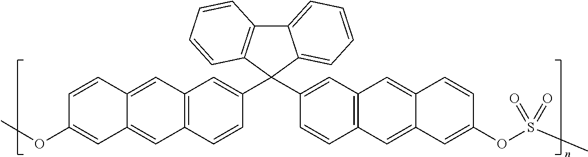 | P48 |

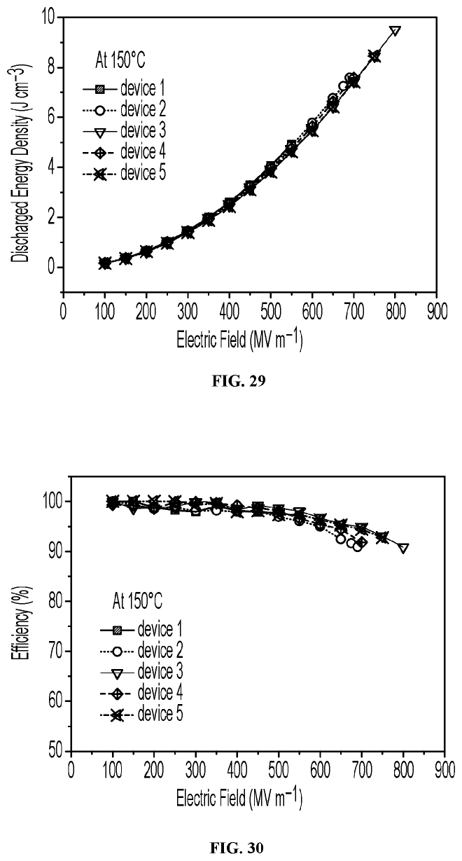

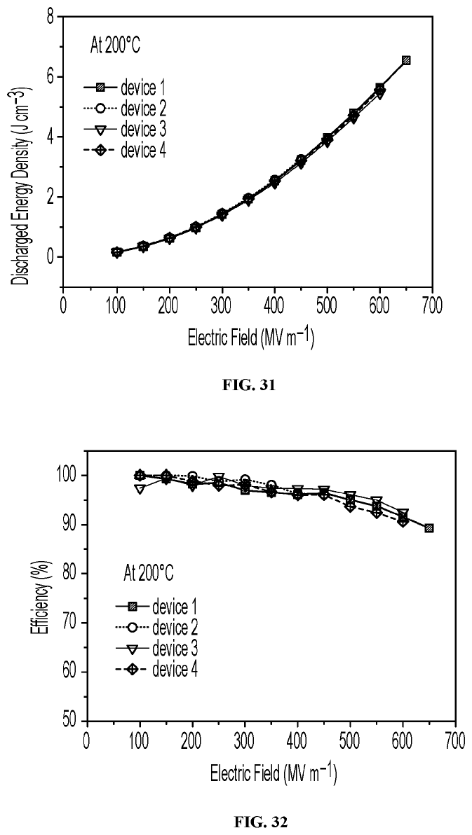

Polymer P12, with a T_{g} of 298° C., was further evaluated assess its electrical performance at 150 and 200° C. using the methods described herein. FIG. 29 shows plots of discharged energy density (J cm⁻³) versus electric field (MV m⁻¹) for five films of polymer P12 (labeled devices 1 through 5), measured at 150° C.; and FIG. 30 shows plots of charge-discharge efficiency (%) versus electric field (MV m⁻¹) for five films of polymer P12 (labeled devices 1 through 5), measured at 150° C. FIG. 31 shows plots of discharged energy density (J cm⁻³) versus electric field (MV m⁻¹) for four films of polymer P12 (labeled devices 1 through 4), measured at 200° C.; and FIG. 32 shows plots of charge-discharge efficiency (%) versus electric field (MV m⁻¹) for four films of polymer P12 (labeled devices 1 through 4), measured at 200° C. Polymer P12 performed well at both 150 and 200° C. with respect to discharged energy density and efficiency.

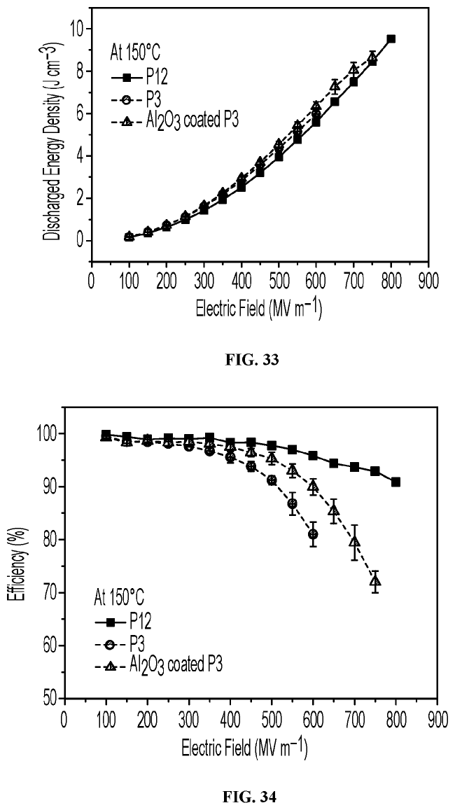

FIG. 33 shows plots of discharged energy density (J cm⁻³) versus electric field (MV m⁻¹) for polymer P12 (average of the five films from FIG. 29) compared to films of polymer P3 and alumina-coated polymer P3, measured at 150° C.; and FIG. 34 shows plots of charge-discharge efficiency (%) versus electric field (MV m⁻¹) for polymer P12 (average of the five films from FIG. 29) compared to films of polymer P3 and alumina-coated polymer P3, measured at 150° C. The data in FIG. 33 show that P12 affords similar discharged energy density to P3 and alumina-coated P3 at 150° C. Surprisingly, P12 outperformed P3 and alumina-coated P3 with respect to charge-discharge efficiency at higher electric field strength at 150° C. (FIG. 34).

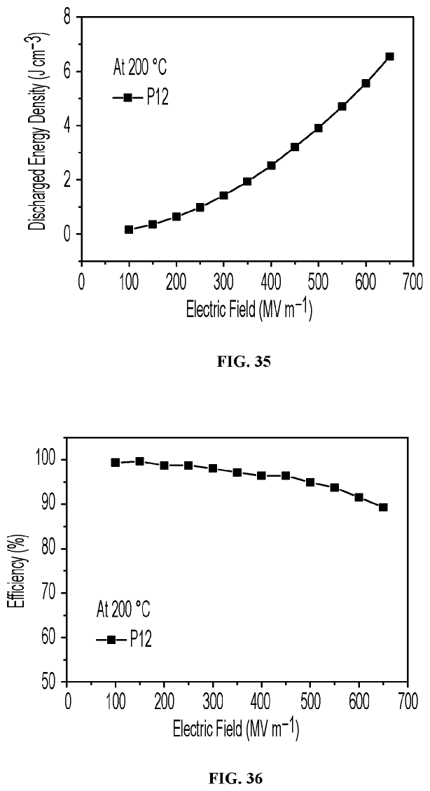

FIG. 35 shows a plot of discharged energy density (J cm⁻³) versus electric field (MV m⁻¹) for polymer P12 (average of the four films), measured at 200° C.; and FIG. 36 shows a plot of charge-discharge efficiency (%) versus electric field (MV m⁻¹) for polymer P12 (average of the four), measured at 200° C.

### Preparation of the Polymers.

Polymers P4, P8, and P23 to P30 were previously described in Gao et al., Nature Chemistry 2017, 9 (11): 1083-1088, and were made by the procedures described therein.

### Example P9

### Preparation of ((cyclododecane-1,1-diylbis(4,1-phenylene))bis(oxy))bis(tert-butyldimethylsilane) (1)

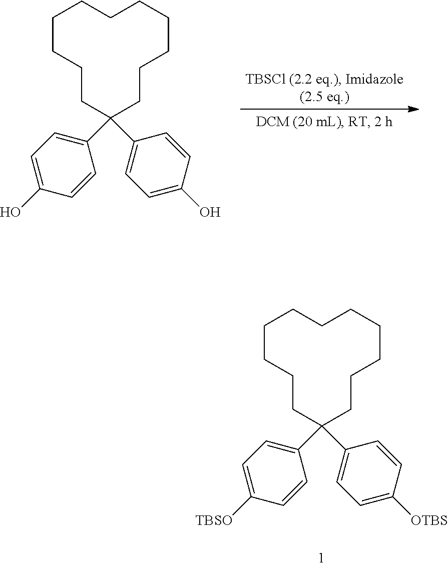 [SMILES: Oc1ccc(C2(c3ccc(O)cc3)CCCCCCCCCCC2)cc1 ; CC(C)(C)[Si](C)(C)Oc1ccc(C2(c3ccc(O[Si](C)(C)C(C)(C)C)cc3)CCCCCCCCCCC2)cc1]

A 100 mL round-bottomed flask was charged with a magnetic stir bar, 4,4′-(cyclododecane-1,1-diyl)diphenol (0.810 g, 2.3 mmol), imidazole (0.394 g, 5.8 mmol, 2.5 eq.) and 20 mL of di chloromethane (CH₂Cl₂). The solution was stirred at room temperature for 10 min and then TBSC1 (0.759 g, 6.5 mmol, 2.2 eq) was added monitoring by TLC. After 2 hours, the reaction mixture was filtered, and the filtrate was concentrated under reduced pressure on a rotary evaporator. The resulting crude product was dissolved in 30 mL of ethyl acetate (EtOAc), which was subsequently washed with brine. The organic phase was dried over anhydrous MgSO₄. After filtration, the filtrate was subjected to evaporation to remove EtOAc. The product was purified by flash column chromatography over silica gel (hexanes/ethyl acetate=50/1) to afford Product 1 as white solid (1.2 g, 90% yield).

White solid. mp 107-109° C. Rf=0.78 (Hexane/EA=20:1). ¹H NMR (400 MHz, CDCl3) δ 7.00 (d, J=8.7 Hz, 4H), 6.71 (d, J=8.6 Hz, 4H), 2.05-1.94 (m, 4H), 1.45-1.25 (m, 14H), 0.99-0.88 (m, 22H), 0.19 (s, 12H). ¹³C NMR (101 MHz, CDCl₃) δ 153.10, 142.87, 128.61, 119.07, 47.31, 33.47, 26.70, 26.38, 25.83, 22.39, 22.17, 20.12, 18.30, −4.25.

### Preparation of cyclododecane-1,1-diylbis(4,1-phenylene)bis(sulfurofluoridate) (4)

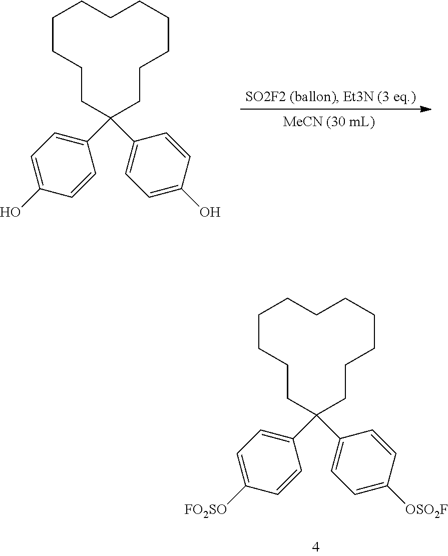

A 100 mL round-bottomed flask was charged with a magnetic stir bar, 4,4′-(cyclododecane-1,1-diyl)diphenol (1.056 g, 3 mmol), MeCN (30 mL) and Et₃N (0.909 g, 9 mmol, 3 eq.). The reaction flask was then sealed with a septum, the atmosphere above the solution was removed with gentle vacuum, and SO₂F₂ gas (sulfuryl fluoride, VIKANE) was introduced by needle from a balloon filled with the gas and monitored by TLC. The resulting mixture was stirred at room temperature until the full conversion of starting compound to the product. After completion, the solvent was removed by rotary evaporation, the residue was dissolved in EtOAc (50 mL), and the solution was washed with brine (3×10⁰ mL). The organic phase was dried over anhydrous Na₂SO₄ and concentrated. The product was purified by flash column chromatography over silica gel (hexanes/ethyl acetate=20/1) to afford product 4 as white solid (1.45 g, 94% yield).

White solid. mp 110-112° C. Rf=0.60 (Hexane/EA=10:1). ¹H NMR (400 MHz, CDCl3) δ 7.27-7.25 (m, 8H), 2.24-1.95 (m, 4H), 1.46-1.32 (m, 14H), 0.98-0.97 (m, 4H). ¹³C NMR (100 MHz, CDCl₃) δ 149.72, 148.15, 129.65, 120.41, 48.62, 33.31, 26.37, 26.18, 22.24, 21.96, 20.00. 19F NMR (376 MHz, CDCl₃) δ 34.86.

### Synthesis of the Polymer P9

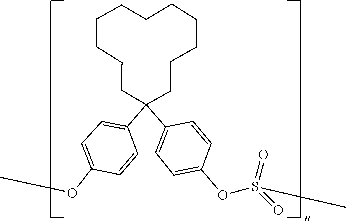

Following the general procedure:

White solid. mp 273-275° C. 1H NMR (500 MHz, THF-d8) δ 7.67-7.65 (m, 4H), 5.72-5.70 (m, 4H), 1.67-1.68 (m, 22H). ¹³C NMR (134 MHz, THF-d8) δ 119.04, 97.22, 61.94, 59.55, 30.10, 15.27. Mₙ=19.2 kDa. PDI=1.8. T_{g} (DSC)=172.2° C. E_{g} (eV)=4.44.

### Example P10

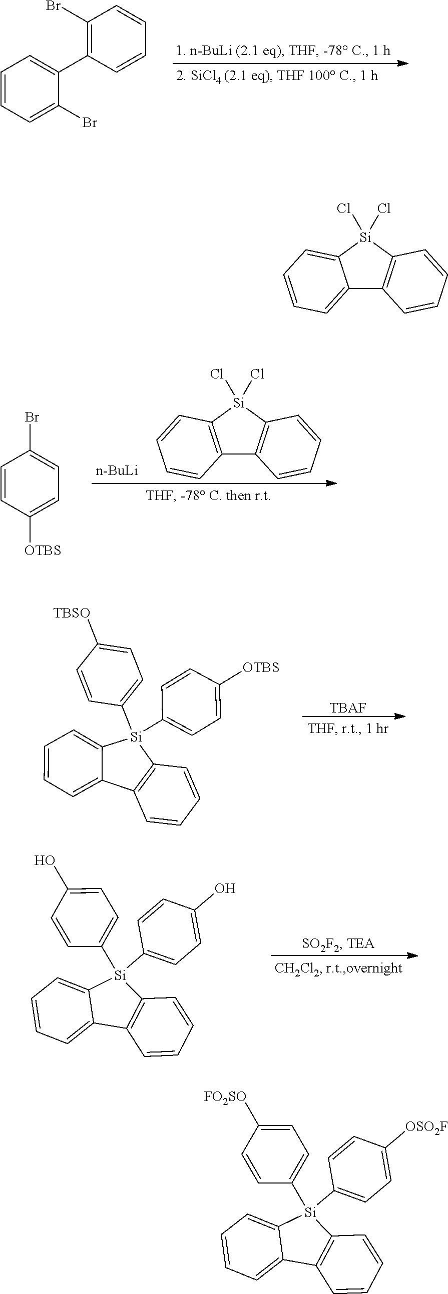

5,5-dichloro-5H-dibenzo[b,d]silole. This intermediate was prepared using the previously published method described in the publication van der Boon, L. J. P. et al. Dynamic Conformational Behavior in Stable Pentaorganosilicates. European Journal of Inorganic Chemistry. 2019, 3318-3328 (2019). 59% yield. The intermediate was used in the next step without further purification.

The following intermediates were prepared by using similar conditions described in the synthesis of P11 monomer.

5,5-bis(4-((tert-butyldimethylsilyl)oxy)phenyl)-5H-dibenzo[b,d]silole. White solid, 64% yield. mp 64-66° C. ¹H NMR (600 MHz, Chloroform-d) δ 7.88 (d, J=7.8 Hz, 2H), 7.75 (d, J=7.1 Hz, 2H), 7.51-7.44 (m, 6H), 7.30 (t, J=7.2 Hz, 2H), 6.81 (d, J=9.9 Hz, 4H), 0.96 (d, J=1.3 Hz, 18H), 0.18 (d, J=1.2 Hz, 12H). ¹³C NMR (151 MHz, CDCl₃) δ 157.55, 148.61, 137.04, 136.81, 133.92, 130.51, 127.68, 124.27, 121.09, 119.96, 25.66, 18.19, −4.36. 4,4′-(5H-dibenzo[b,d]silole-5,5-diyl)diphenol. White solid, 90% yield. mp 67-68° C. 1H NMR (400 MHz, DMSO-d₆) δ 9.70 (s, 2H), 8.00 (d, J=7.8 Hz, 2H), 7.79 (d, J=7.1 Hz, 2H), 7.50 (t, J=8.0 Hz, 2H), 7.39 (d, J=8.1 Hz, 4H), 7.33 (t, J=7.2 Hz, 2H), 6.78 (d, J=8.1 Hz, 4H). 13C NMR (151 MHz, DMSO) δ 159.79, 148.35, 137.03, 136.94, 134.24, 131.12, 128.32, 121.79, 121.47, 116.01.

(5H-dibenzo[b,d]silole-5,5-diyl)bis(4,1-phenylene)bis(sulfurofluoridate). White solid, 72% yield. mp 163-164° C. ¹H NMR (600 MHz, DMSO-d₆) δ 8.07 (d, J=7.9 Hz, 1H), 8.03 (d, J=6.7 Hz, 1H), 7.87 (d, J=8.7 Hz, 2H), 7.66 (d, J=8.5 Hz, 2H), 7.58 (t, J=7.6 Hz, 1H), 7.40 (t, J=7.6 Hz, 1H). ¹³C NMR (151 MHz, DMSO) δ 151.85, 148.65, 138.09, 134.78, 134.13, 133.80, 132.14, 128.85, 122.25, 121.61.

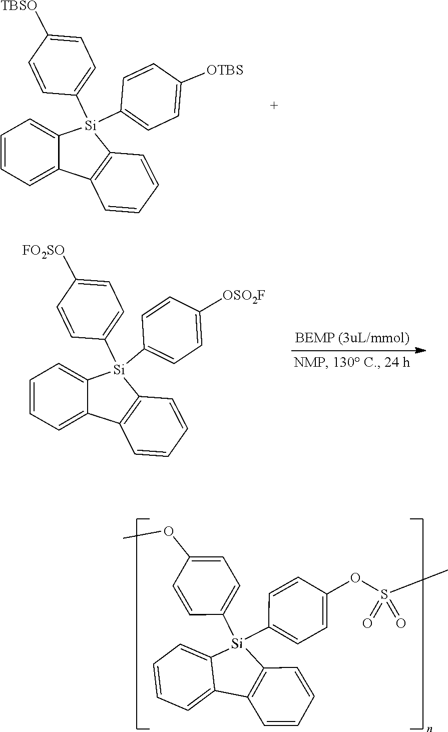

Polysulfate P10 was prepared from the above monomers. Off white powder. mp 193-197° C. ¹H NMR (600 MHz, DMSO) δ 8.07-7.95 (m, 2H), 7.94-7.84 (m, 2H), 7.83-7.64 (m, 4H), 7.56-7.39 (m, 6H), 7.36-7.26 (m, 2H). ¹³C NMR (151 MHz, DMSO) δ 151.5, 148.1, 137.3, 134.1, 133.7, 132.2, 131.5, 128.2, 121.7, 121.0. Mₙ=7 kDa, PDI=1.4. T_{g}=176.4° C.

### Example P11

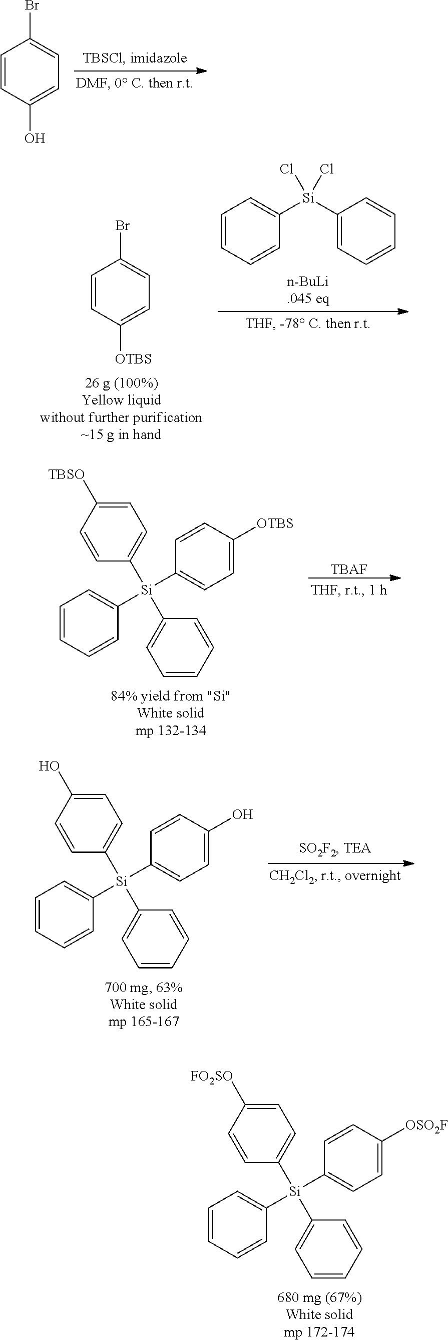

(4-bromophenoxy) (tert-butyl)dimethylsilane was prepared by using the identical method described in Journal of Medicinal Chemistry (1987), 30(5), 871-80. It was obtained as yellow liquid. ¹H NMR (400 MHz, DMSO-d₆) δ 7.41-7.33 (m, 2H), 6.83-6.68 (m, 2H), 0.90 (s, 9H), 0.14 (s, 6H).

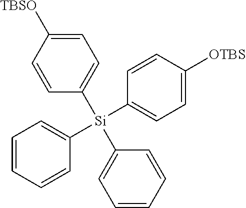 [SMILES: CC(C)(C)[Si](C)(C)Oc1ccc([Si](c2ccccc2)(c2ccccc2)c2ccc(O[Si](C)(C)C(C)(C)C)cc2)cc1]

### bis(4-((tert-butyldimethylsilyl)oxy)phenyl)diphenylsilane

To a solution of (4-bromophenoxy) (tert-butyl)dimethylsilane (11 g, 1 eq, 38 mmol) in THF (160 mL) was slowly added n-BuLi (1.6 M in hexane, 1 eq, 40 mmol) at −78° C. The reaction mixture was then stirred at 0° C. for 1 hour. After that time, it was cooled to −78° C. and a solution of dichlorodiphenylsilane (4.3 g, 0.45 eq, 17.1 mmol) in 5 mL of THF was added. The resulting mixture was stirred overnight monitoring by TLC and was hydrolyzed with 5% HCl until a yellow solution was obtained. The mixture was concentrated by rotary evaporation and the residue was dissolved in Et₂O. The crude mixture was washed with water and separated. The organic phase was collected by rotary evaporation, and purified by flash chromatography (0-3% EtOAc/Hexane) to yield the title product as a white solid (8.6 g, 84% yield) mp 132-134° C. ¹H NMR (400 MHz, Chloroform-d) δ 7.53 (d, J=7.0 Hz, 4H), 7.39 (d, J=7.4 Hz, 6H), 7.34 (t, J=7.1 Hz, 4H), 6.83 (d, J=8.3 Hz, 4H), 0.97 (s, 18H), 0.20 (s, 12H).

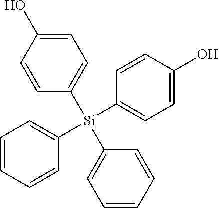 [SMILES: Oc1ccc([Si](c2ccccc2)(c2ccccc2)c2ccc(O)cc2)cc1]

### 4,4′-(diphenylsilanediyl)diphenol

At 0° C., a THF solution containing bis(4-((tert-butyldimethylsilyl)oxy)phenyl)diphenylsilane (1.8 g, 1 eq, 3 mmol) was slowly added dropwise to TBAF (1 M in THF, 2 eq, 6 mmol). The mixture was stirred at room temperature for 1 hour monitoring by TLC and was concentrated by rotary evaporation. The residue was purified by flash chromatography system (0-60% EtOAc/Hexane) to yield the product as a white solid (0.700 g, 63% yield). mp 165-167° C. ¹H NMR (400 MHz, DMSO) δ 9.69 (s, 2H), 7.49-7.33 (m, 10H), 7.26 (d, J=8.4 Hz, 4H), 6.83 (d, J=8.4 Hz, 4H).

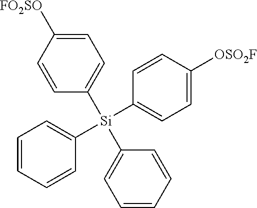

### (diphenylsilanediyl)bis(4,1-phenylene)bis(sulfurofluoridate) (General procedure B)

4,4′-(diphenylsilanediyl)diphenol (0.700 g, 1 eq, 1.9 mmol) and triethylamine (0.8 mL, 3 eq, 6 mmol) were dissolved in in dichloromethane (20 mL). The reaction container was sealed, degassed, and SO₂F₂ gas (sulfuryl fluoride) was introduced by needle with a balloon filled with gas. The reaction was vigorously stirred overnight at room temperature monitoring by TLC. After completion, the reaction was quenched with the water. The organic layer was dried over MgSO₄ and concentrated. The resulting crude was filtered through a short pad of silica gel, and the desired product was concentrated by rotary evaporation to give a white solid (0.680 g, 67% yield). mp 172-174° C. ¹H NMR (600 MHz, DMSO) δ 7.70 (s, 8H), 7.55 (td, J=5.9, 3.0 Hz, 2H), 7.52-7.48 (m, 8H). ¹³C NMR (151 MHz, DMSO) δ 151.6, 138.9, 136.3, 135.3, 132.3, 130.9, 129.0, 121.5. ¹⁹F NMR (376 MHz, DMSO) δ 36.6 (s).

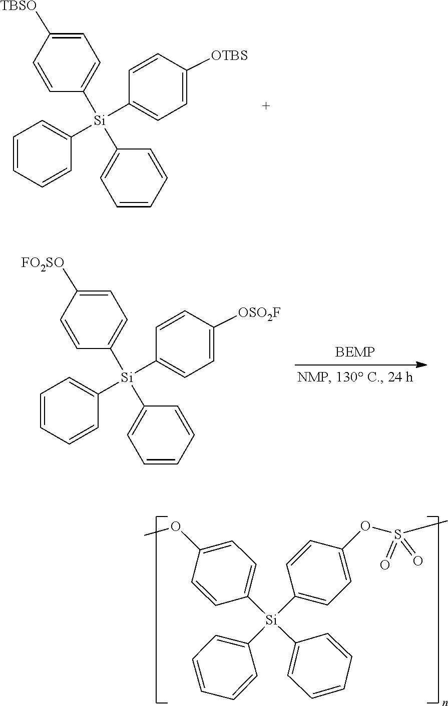

### Polysulfate P11 (General Procedure)

To a dry 20 mL vial equipped with a stir bar, was added monomer (diphenylsilanediyl)bis(4,1-phenylene)bis(sulfurofluoridate) (0.160 g, 1 eq, 0.3 mmol), bis(4-((tert-butyldimethylsilyl)oxy)phenyl)diphenylsilane (0.180 g, 1 eq, 0.3 mmol), and NMP (0.3 mL). The container was sealed and degassed and refilled with N₂ and placed into a pre-heated 130° C. heating block. Catalyst (1 μL) was added via a microsyringe. The reaction was then allowed to stir for 7 hours at 130° C. Thereafter, another 2 mL of DMF was added to dissolve the polymer at this temperature. The resulting DMF solution was slowly injected into 50 mL of methanol under vigorous stirring. Polymers crashed out as white powder/strip in methanol. They were collected via filtration, re-dissolved in DMF, and the solid underwent precipitation once more. The final polymer product was dried at 70° C. for 3 hours in vacuo (2.0 torr). Molecular weight and polydispersity were determined on GPC. Yellow solid. mp 122-135° C. ¹H NMR (600 MHz, DMSO) δ 7.85-7.27 (m, 18H). ¹³C NMR (151 MHz, DMSO) δ 151.3, 138.1, 135.7, 133.5, 132.1, 130.3, 128.4, 120.9. Mₙ=7.2 kDa, PDI=1.4. T_{g}=113.1° C.

### Example P12

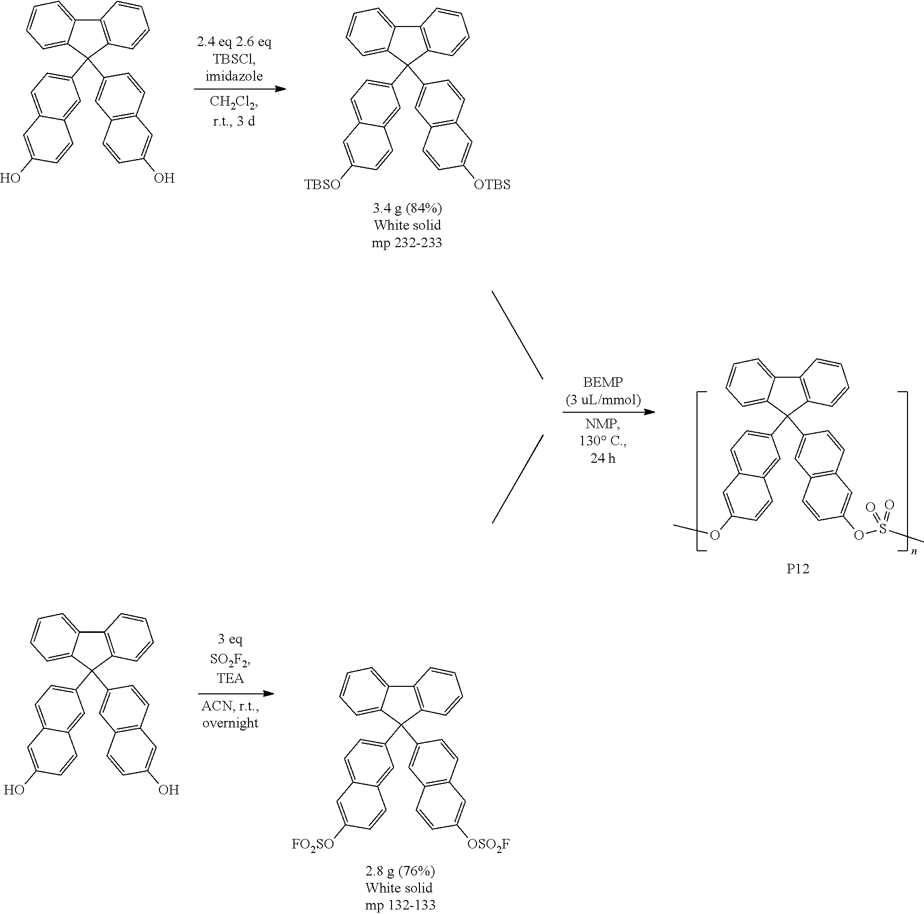

The monomers were prepared by using procedures:

(((9H-fluorene-9,9-diyl)bis(naphthalene-6,2-diyl))bis(oxy))bis(tert-butyldimethylsilane). White solid, 84% yield. mp 232-233° C. ¹H NMR (400 MHz, Chloroform-d)) δ 7.80 (d, J=7.5 Hz, 2H), 7.57 (d, J=8.7 Hz, 2H), 7.52-7.47 (m, 6H), 7.37 (ddd, J=7.5, 4.3, 1.6 Hz, 4H), 7.28 (dd, J=7.6, 1.2 Hz, 2H), 7.12 (d, J=2.4 Hz, 2H), 6.98 (dd, J=8.8, 2.4 Hz, 2H), 0.98 (s, 18H), 0.20 (s, 12H). ¹³C NMR (151 MHz, Chloroform-d) δ 153.54, 151.25, 141.00, 140.29, 133.50, 129.46, 128.98, 127.77, 127.56, 127.52, 126.85, 126.34, 125.90, 122.17, 120.31, 114.68, 65.43, 25.78, 18.32, −4.30.

### (9H-fluorene-9,9-diyl)bis(naphthalene-6,2-diyl)bis(sulfurofluoridate) (General Procedure A)

White solid, 76% yield. mp 132-133° C. ¹H NMR (400 MHz, Chloroform-d) δ 7.89-7.82 (m, 2H), 7.80 (d, J=8.7 Hz, 2H), 7.77-7.72 (m, 4H), 7.64 (d, J=1.9 Hz, 2H), 7.52 (dd, J=8.7, 1.9 Hz, 2H), 7.48-7.39 (m, 4H), 7.36 (dd, J=9.0, 2.5 Hz, 2H), 7.31 (td, J=7.5, 1.2 Hz, 2H). ¹³C NMR (151 MHz, Chloroform-d) δ 150.01, 147.66, 144.54, 140.34, 132.38, 132.29, 130.94, 128.72, 128.43, 128.19, 128.12, 126.13, 126.10, 120.68, 119.33, 118.52, 65.49. ¹⁹F NMR (376 MHz, Chloroform-d) δ 37.8 (s).

Polysulfate P12 was prepared from corresponding monomers. White solid. mp >300° C. ¹H NMR (600 MHz, DMSO) δ 8.11-7.77 (m, 8H), 7.72-7.60 (m, 2H), 7.60-7.49 (m, 2H), 7.49-7.18 (m, 8H). ¹³C NMR (151 MHz, DMSO) δ 149.7, 147.5, 143.9, 139.7, 132.0, 131.5, 130.8, 128.4, 128.1, 126.1, 125.5, 120.8, 120.0, 118.2, 65.0. Mₙ=21.1 kDa, PDI=1.67. T_{g}=298° C.

### Example P13

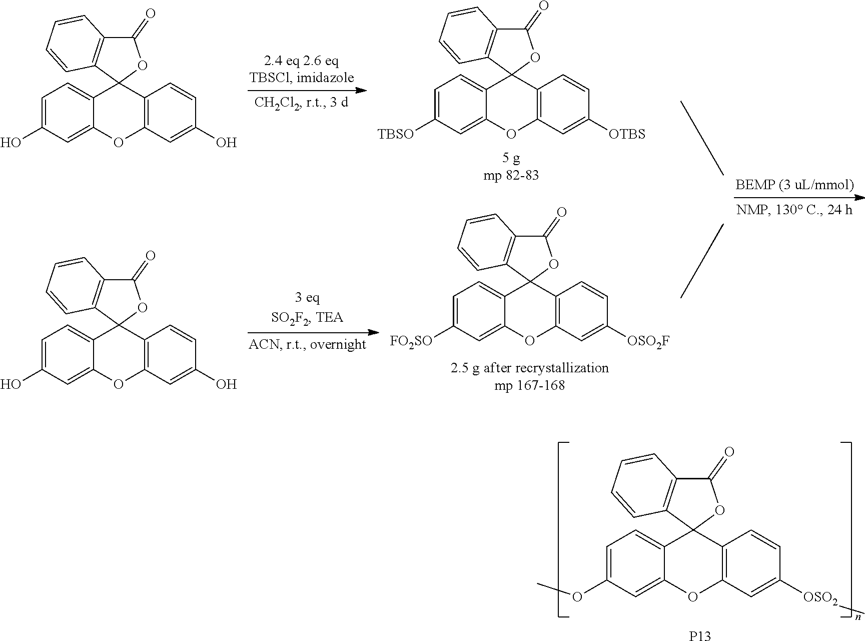

### Monomers:

### 3′,6′-bis((tert-butyldimethylsilyl)oxy)-3H-spiro[isobenzofuran-1,9′-xanthen]-3-one

White solid, 89% yield. mp 82-83° C. ¹H NMR (400 MHz, DMSO) δ 8.14-8.08 (m, 1H), 7.91 (d, J=2.5 Hz, 2H), 7.88-7.77 (m, 2H), 7.54-7.48 (m, 1H), 7.43 (dd, J=8.9, 2.5 Hz, 2H), 7.17 (d, J=8.9 Hz, 2H). ¹³C NMR (151 MHz, Chloroform-d) δ 169.48, 157.59, 153.18, 152.32, 134.95, 129.63, 129.01, 126.88, 124.97, 124.02, 116.61, 112.09, 107.65, 83.29, 25.62, 18.22, −4.39. 3-oxo-3H-spiro[isobenzofuran-1,9′-xanthene]-3′,6′-diyl bis(sulfurofluoridate). White solid, 45% yield. mp 167-168° C. ¹H NMR (400 MHz, DMSO-d₆) δ 7.99 (d, J=7.7 Hz, 1H), 7.78 (td, J=7.5, 1.3 Hz, 1H), 7.70 (td, J=7.5, 1.0 Hz, 1H), 7.29 (d, J=7.6 Hz, 1H), 6.77 (t, J=1.4 Hz, 2H), 6.62 (d, J=1.3 Hz, 4H), 0.91 (s, 18H), 0.19 (s, 12H). ¹³C NMR (151 MHz, Chloroform-d) δ 168.44, 152.20, 151.38, 150.59, 135.87, 130.76, 130.21, 125.77, 125.53, 123.75, 119.65, 117.25, 110.37, 79.97. ¹⁹F NMR (376 MHz, DMSO) δ 37.0 (s).

Polysulfate P13 was prepared from the above monomers. Yellow solid. mp >300° C. 1H NMR (600 MHz, DMSO) δ 8.10-7.99 (m, 1H), 7.83-7.70 (m, 2H), 7.67-7.55 (m, 2H), 7.42 (d, J=7.5 Hz, 1H), 7.32-7.22 (m, 2H), 7.11-7.00 (m, 2H). ¹³C NMR (151 MHz, DMSO) δ 168.2, 152.0, 150.8, 150.5, 136.1, 130.8, 130.5, 125.2, 125.0, 124.2, 118.6, 117.5, 110.1, 79.9. Mₙ=15.2 kDa, PDI=1.53. T_{g}=239° C.

### Example P14

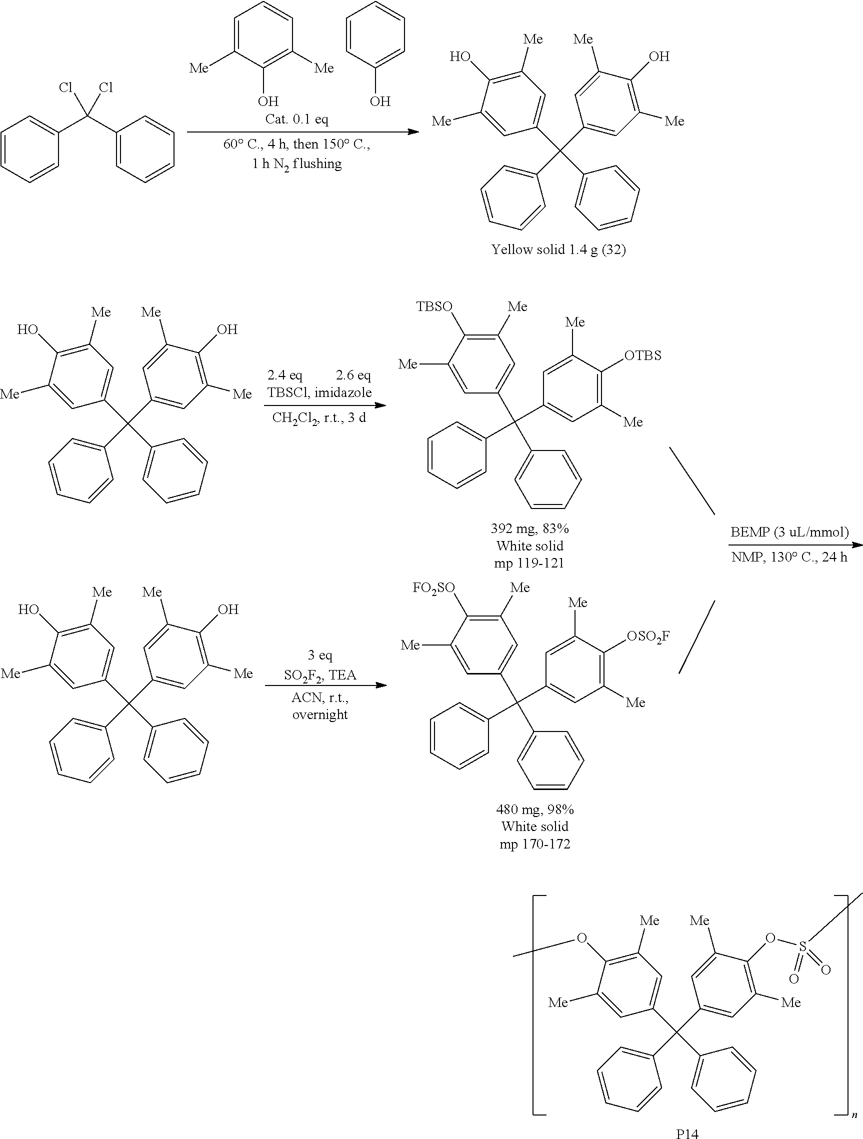

### 4,4′-(diphenylmethylene)bis(2,6-dimethylphenol)

Dichlorodiphenylmethane (2.36 g, 1 eq, 10 mmol), 2,6-dimethylphenol (2.68 g, 2.2 eq, 22 mmol), and phenol (0.100 g, 0.1 eq, 1 mmol) were stirred at room temperature until no volatiles were produced. The mixture was then heated at 60° C. for 4 hours. The temperature was slowly increased to 150° C. and held for 20 minutes. During this period, the flask was flushed with N₂. Thereafter, the crude product was purified by flash chromatography system (0-25% EtO Ac/Hexane) to afford the product as a yellow solid (1.4 g, 34% yield). mp 200-201° C. 1H NMR (400 MHz, DMSO-d₆) δ 8.09 (d, J=3.6 Hz, 2H), 7.20 (d, J=7.2 Hz, 4H), 7.09 (t, J=8.0 Hz, 6H), 6.61 (d, J=3.0 Hz, 4H), 2.00 (d, J=3.3 Hz, 12H).

Monomers were prepared by corresponding procedures:

bis(4-((tert-butyldimethylsilyl)oxy)-3,5-dimethylphenyl)diphenylmethane. Colorless crystal. mp 170-172° C. ¹H NMR (600 MHz, CDCl₃) δ 7.46-7.03 (m, 12H), 2.12 (s, 12H), 1.05 (d, J=1.8 Hz, 18H), 0.23 (d, J=1.9 Hz, 12H).

(diphenylmethylene)bis(2,6-dimethyl-4,1-phenylene)bis(sulfurofluoridate). Colorless oil. ¹H NMR (400 MHz, Chloroform-d) δ 7.30-7.25 (m, 4H), 7.24-7.18 (m, 2H), 7.17-7.10 (m, 4H), 6.93 (s, 4H), 2.28 (s, 12H).

Polysulfate P14 was prepared from above monomers. Gray solid, mp 245-257° C. ¹H NMR (600 MHz, DMSO) δ 7.38-6.91 (m, 14H), 2.23-1.98 (m, 12H). Mₙ=14.1 kDa, PDI=1.45. T_{g}=102.5° C.

### Example P15

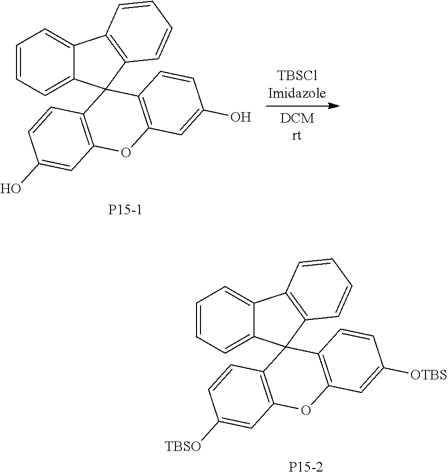

### Preparation of 3′,6′-bis((tert-butyldimethylsilyl)oxy)spiro[fluorene-9,9′-xanthene] (P15-2)

Spiro[fluorene-9,9′-xanthene]-3′,6′-diol (P15-1, 0.300 g, 0.82 mmol, 1.0 equiv.), imidazole (0.170 g, 2.5 mmol, 3.0 equiv.), and TBSC1 (0.300 g, 2.0 mmol, 2.5 equiv.) were dissolved in 1 mL dry DMF. The mixture was stirred at room temperature for 1 hour, then 5 mL water was added. The aqueous layer was extracted with EtOAc (3×10 mL). The combined organic layer was washed with brine (10 mL), dried over Na₂SO₄ and evaporated. The crude product was purified by column chromatography on silica gel (5% EtOAc in Hexanes) to afford the product as a white solid (0.449 g, 92%). ¹H NMR (500 MHz, CDCl₃) δ 7.76 (d, J=7.5 Hz, 2H), 7.34 (td, J=7.5, 1.2 Hz, 2H), 7.20 (td, J=7.4, 1.1 Hz, 2H), 7.14 (d, J=7.6 Hz, 2H), 6.66 (d, J=2.3 Hz, 2H), 6.26 (dd, J=8.5, 2.4 Hz, 2H), 6.22 (d, J=8.5 Hz, 2H), 0.96 (s, 18H), 0.19 (s, 12H).

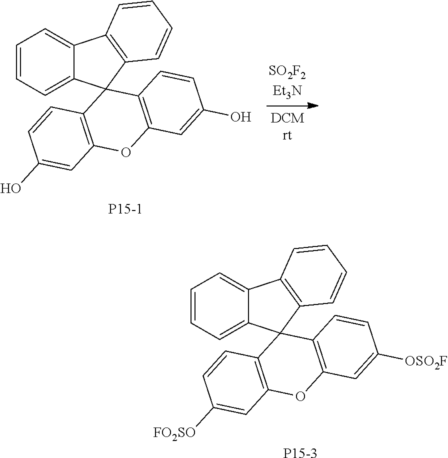

### Preparation of spiro[fluorene-9,9′-xanthene]-3′,6′-diyl bis(sulfurofluoridate) (P15-3)

Spiro[fluorene-9,9′-xanthene]-3′,6′-diol (P15-1, 0.300 g, 0.82 mmol, 1.0 equiv.) was dissolved in 4 mL dry dichloromethane (CH₂Cl₂), and Et₃N (347 μL, 0.253 g, 2.5 mmol, 3.0 equiv.) was added. The mixture was charged with SO₂F₂ via a balloon, and stirred under room temperature for 4 hours. Subsequently, the mixture washed with water (20 mL), the organic phase was dried over Na₂SO₄ and evaporated. The crude product was purified by column chromatography on silica gel (5% EtOAc in Hexanes) to afford the product as a white solid (quant.). ¹H NMR (500 MHz, CDCl3) δ 7.83 (d, J=7.6 Hz, 2H), 7.44 (td, J=7.5, 1.0 Hz, 2H), 7.28 (dd, J=7.5, 1.1 Hz, 2H), 7.25 (d, J=2.1 Hz, 2H), 7.14 (d, J=7.6 Hz, 2H), 6.81 (dd, J=9.0, 2.3 Hz, 2H), 6.51 (d, J=8.7 Hz, 2H).

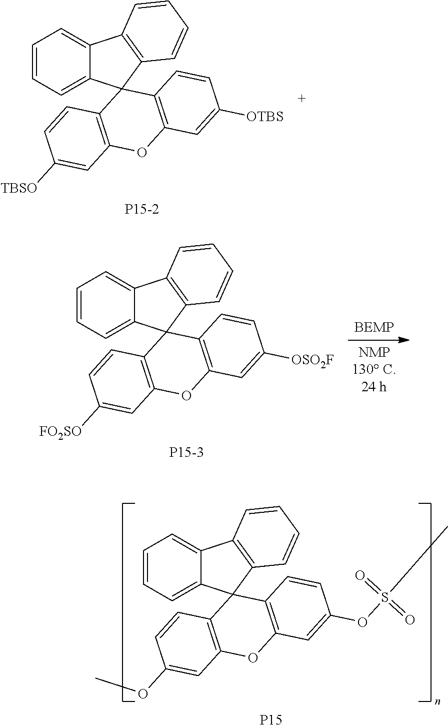

### Preparation of P15

The P15 was prepared by the generation procedure.

1H NMR (500 MHz, DMSO-d₆) δ 7.97-7.90 (m, 1H), 7.42-7.24 (m, 2H), 7.17-6.90 (m, 2H), 6.86-6.72 (m, 1H), 6.34-6.18 (m, 1H). Mp=330° C. Mₙ=22.8 kDa. PDI=1.29. T_{g}=241.6° C.

### Example P16

### Preparation of (((2,2-diphenylethene-1,1-diyl)bis(4,1-phenylene))bis(oxy))bis(tert-butyldimethylsilane) (3)

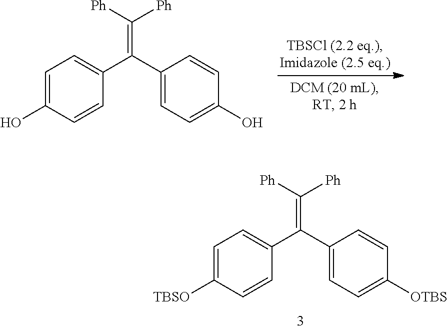 [SMILES: Oc1ccc(C(=C(c2ccccc2)c2ccccc2)c2ccc(O)cc2)cc1 ; CC(C)(C)[Si](C)(C)Oc1ccc(C(=C(c2ccccc2)c2ccccc2)c2ccc(O[Si](C)(C)C(C)(C)C)cc2)cc1]

A 100 mL round-bottomed flask was charged with a magnetic stir bar, 4,4′-(2,2-diphenylethene-1,1-diyl)diphenol (0.728 g, 2.0 mmol), imidazole (0.340 g, 5 mmol, 2.5 eq.) and 20 mL of dichloromethane (CH₂Cl₂). The solution was stirred at room temperature for 10 min, then TBSC1 (0.660 g, 4.4 mmol, 2.2 eq) was added at room temperature. After 2 h, the reaction was monitored by TLC, the starting material disappeared. After completion, the reaction mixture was filtered, and the filtrate was concentrated under reduced pressure on a rotary evaporator. The resulting crude product was dissolved in 30 mL of ethyl acetate (EtOAc), which was subsequently washed with brine. The organic phase was dried over anhydrous MgSO₄. After filtration, the filtrate was subjected to evaporation to remove EtOAc. The product was purified by flash column chromatography over silica gel (hexanes/ethyl acetate=20/1) to afford product 3 as white solid (1.1 g, 93% yield).

White solid. mp 97-99° C. Rf=0.75 (Hexane/EA=20:1). ¹H NMR (400 MHz, CDCl3) δ 7.12-7.05 (m, 6H), 7.02 (dd, J=6.7, 2.9 Hz, 4H), 6.89 (d, J=7.9 Hz, 4H), 6.59 (d, J=8.6 Hz, 4H), 0.97 (s, 18H), 0.17 (s, 12H). ¹³C NMR (101 MHz, CDCl₃) δ 154.31, 144.39, 140.56, 139.43, 137.05, 132.65, 131.53, 127.70, 126.15, 119.39, 25.83, 18.38, −4.30.

### Preparation of 4-(1-(4-((fluorosulfonyl)oxy)phenyl)-2,2-diphenylvinyl)phenyl sulfurofluoridate (6)

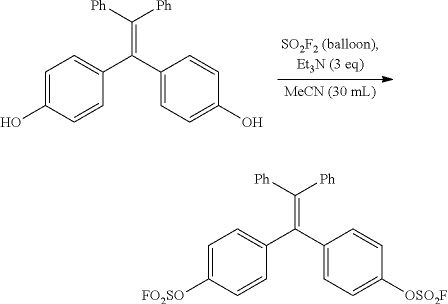

A 100 mL round-bottomed flask was charged with a magnetic stir bar, 4,4′-(2,2-diphenylethene-1,1-diyl)diphenol (0.728 g, 2 mmol), MeCN (30 mL) and Et₃N (0.606 g, 6 mmol, 3 eq.). The reaction flask was then sealed with a septum, the atmosphere above the solution was removed with gentle vacuum, and SO₂F₂ gas (sulfuryl fluoride, VIKANE) was introduced by needle from a balloon filled with the gas. The resulting mixture was stirred at room temperature until the full conversion of starting compound to the product, monitored by TLC. After completion, the solvent was removed by rotary evaporation, the residue was dissolved in EtOAc (50 mL), and the solution was washed with brine (3×10⁰ mL). The organic phase was dried over anhydrous Na₂SO₄ and concentrated. The product was purified by flash column chromatography over silica gel (hexanes/ethyl acetate=9/1) to afford product 6 as white solid (0.980 g, 93% yield).

White solid. mp 158-160. Rf=0.55 (Hexane/EA=10:1). ¹H NMR (400 MHz, CDCl3) δ 7.20-7.07 (m, 14H), 7.01-6.96 (m, 4H). ¹³C NMR (101 MHz, CDCl₃) δ 148.65, 144.49, 143.71, 142.41, 136.86, 133.26, 131.22, 128.20, 127.54, 120.56 (d, J=10.5 Hz). 19F NMR (376 MHz, CDCl3) δ 35.18.

### Synthesis of the Polymer P16

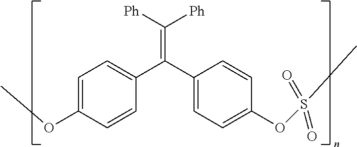

Following the general procedure:

White solid. mp 220-223° C. ¹H NMR (500 MHz, THF-d8) δ 7.10-6.94 (m, 18H), 13C NMR (134 MHz, THF-d8) δ 149.09, 143.40, 142.98, 142.78, 137.98, 132.84, 131.12, 127.84, 126.95, 120.49. Mw ps=22.3 kDa. PDI=1.8. T_{g} (DSC)=153.2° C. E_{g} (eV)=3.27.

### Example P17

### Preparation of bis(4-((tert-butyldimethylsilyl)oxy)phenyl)methanone (2)

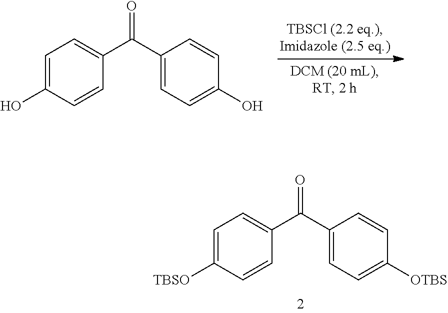 [SMILES: O=C(c1ccc(O)cc1)c1ccc(O)cc1 ; CC(C)(C)[Si](C)(C)Oc1ccc(C(=O)c2ccc(O[Si](C)(C)C(C)(C)C)cc2)cc1]

A 100 mL round-bottomed flask was charged with a magnetic stir bar, 4,4′-(cyclododecane-1,1-diyl)diphenol (0.428 g, 2.0 mmol), imidazole (0.340 g, 5 mmol, 2.5 eq.) and 20 mL of dichloromethane (CH₂Cl₂). The solution was stirred at room temperature for 10 min, then TBSC1 (0.660 g, 4.4 mmol, 2.2 eq) was added at room temperature. After 2 h, the reaction was monitored by TLC, the starting material disappeared. After completion, the reaction mixture was filtered, and the filtrate was concentrated under reduced pressure on a rotary evaporator. The resulting crude product was dissolved in 30 mL of ethyl acetate (EtOAc), which was subsequently washed with brine. The organic phase was dried over anhydrous MgSO₄. After filtration, the filtrate was subjected to evaporation to remove EtOAc. The product was purified by flash column chromatography over silica gel (hexanes/ethyl acetate=9/1) to afford product 2 as white solid (0.812 g, 92% yield).

White solid. mp 55-56° C. Rf=0.55 (Hexane/EA=5:1). ¹H NMR (400 MHz, CDCl3) δ 7.73 (d, J=8.6 Hz, 4H), 6.90 (d, J=8.7 Hz, 4H), 1.00 (s, 18H), 0.25 (s, 12H). ¹³C NMR (101 MHz, CDCl₃) δ 194.85, 159.63, 132.28, 131.38, 119.75, 25.73, 18.36, −4.24.

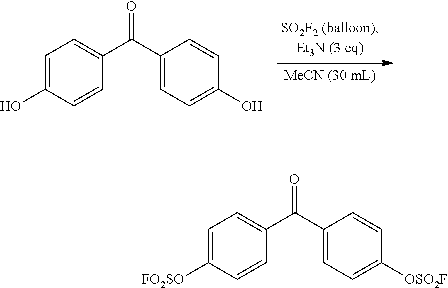

### Preparation of carbonylbis(4,1-phenylene)bis(sulfurofluoridate) (5)

A 100 mL round-bottomed flask was charged with a magnetic stir bar, bis(4-hydroxyphenyl) methanone (0.428 g, 2 mmol), MeCN (30 mL) and Et₃N (0.606 g, 6 mmol, 3 eq.). The reaction flask was then sealed with a septum, the atmosphere above the solution was removed with gentle vacuum, and SO₂F₂ gas (sulfuryl fluoride, VIKANE) was introduced by needle from a balloon filled with the gas. The resulting mixture was stirred at room temperature until the full conversion of starting compound to the product, monitored by TLC. After completion, the solvent was removed by rotary evaporation, the residue was dissolved in EtOAc (50 mL), and the solution was washed with brine (3×10⁰ mL). The organic phase was dried over anhydrous Na₂SO₄ and concentrated. The product was purified by flash column chromatography over silica gel (hexanes/ethyl acetate=5/1) afforded product 5 as white solid (0.720 g, 95% yield). White solid. mp 93-95° C. Rf=0.45 (Hexane/EA=5:1). ¹H NMR (400 MHz, CDCl3) δ 7.96 (d, J=8.8 Hz, 4H), 7.53 (d, J=8.0 Hz, 4H). ¹³C NMR (101 MHz, CDCl₃) δ 192.91, 152.74 (d, J=8 Hz), 137.04, 132.39 (d, J=19 Hz), 121.42 (d, J=14 Hz). 19F NMR (376 MHz, CDCl3) δ 36.34.

### Synthesis of the Polymer P17

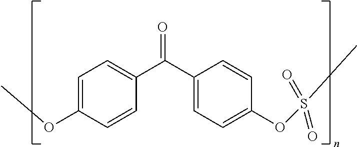

Following the general procedure:

White solid. mp 232-234° C. ¹H NMR (500 MHz, THF-d8) δ 7.92 (d, J=8.6 Hz, 4H), 7.56 (d, J=8.6 Hz, 4H). ¹³C NMR (134 MHz, THF-d8) 8161.56, 132.05, 121.08. Mw ps=11.2 kDa. PDI=1.5. T_{g} (DSC)=97.2° C. E_{g} (eV)=3.73.

### Example P18

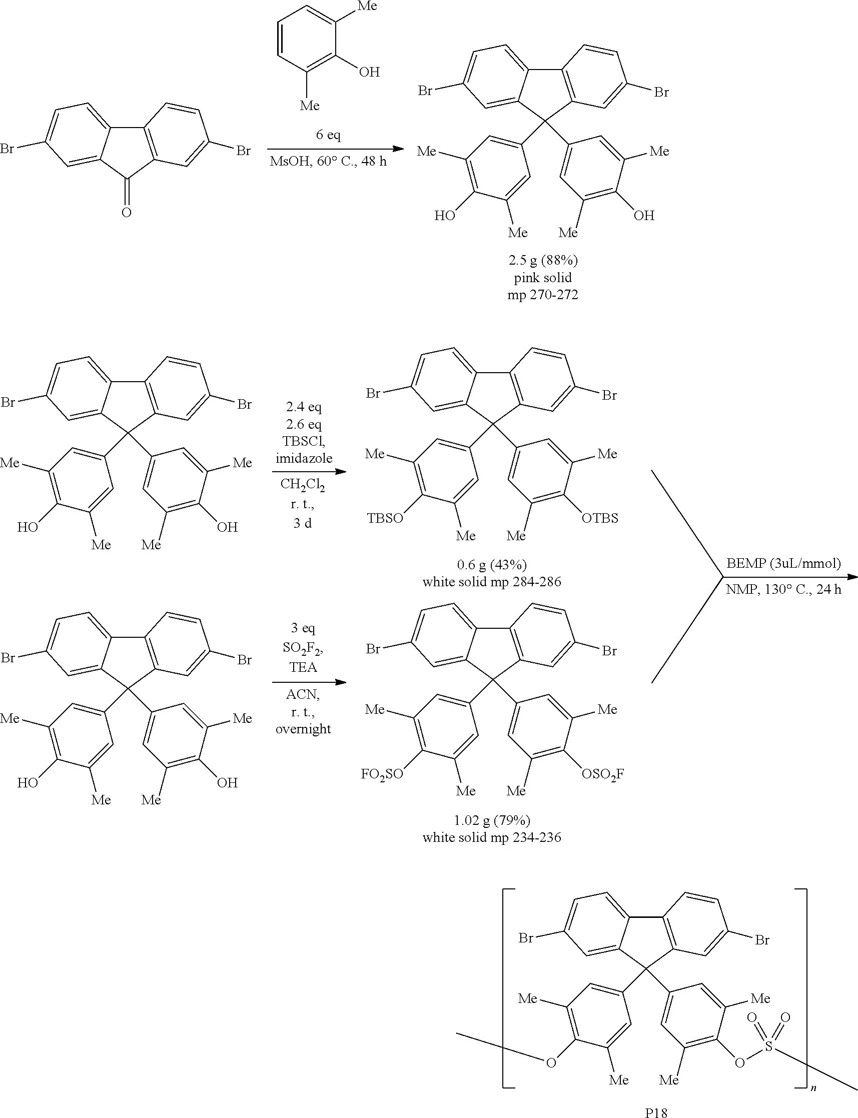

### 4,4′-(2,7-dibromo-9H-fluorene-9,9-diyl)bis(2,6-dimethylphenol)

This bisphenol was prepared by using the condition described in the synthesis of P21. Pink solid, 88% yield. mp 270-272° C. ¹H NMR (400 MHz, Chloroform-d) δ 7.55 (d, J=8.7 Hz, 2H), 7.45 (d, J=5.2 Hz, 4H), 6.70 (s, 4H), 2.14 (s, 12H).

### Monomers:

(((2,7-dibromo-9H-fluorene-9,9-diyl)bis(2,6-dimethyl-4,1-phenylene))bis(oxy))bis(tert-butyldimethylsilane). White solid, 43% yield. mp 284-286° C. ¹H NMR (400 MHz, Chloroform-d) δ 7.55 (dd, J=7.7, 3.0 Hz, 2H), 7.45 (d, J=7.8 Hz, 4H), 6.67 (d, J=2.6 Hz, 4H), 2.09 (d, J=2.9 Hz, 12H), 1.01 (d, J=3.1 Hz, 18H), 0.17 (d, J=3.1 Hz, 12H).

(2,7-dibromo-9H-fluorene-9,9-diyl)bis(2,6-dimethyl-4,1-phenylene)bis(sulfurofluoridate). White solid, 79% yield. mp 234-236° C. ¹H NMR (400 MHz, Chloroform-d) δ 7.61 (d, J=8.1 Hz, 2H), 7.53 (dd, J=8.1, 1.7 Hz, 2H), 7.41 (d, J=1.7 Hz, 2H), 6.82 (s, 4H), 2.29 (s, 12H). 19F NMR (376 MHz, Chloroform-d) δ 43.7 (s).

Polysulfate P18 were prepared from above monomers. Gray solid, mp 280-289° C. 1H NMR (600 MHz, THF) δ 7.80-7.77 (m, 2H), 7.69-7.65 (m, 2H), 7.59-7.55 (m, 2H), 7.01-6.98 (m, 4H), 2.29 (s, 13H). ¹³C NMR (151 MHz, THF) δ 152.3, 147.8, 143.6, 138.2, 131.9, 131.2, 129.3, 128.9, 122.0, 121.8, 64.7, 16.2. Mₙ=9 kDa, PDI=1.45. T_{g}=176.6° C.

### Example P19

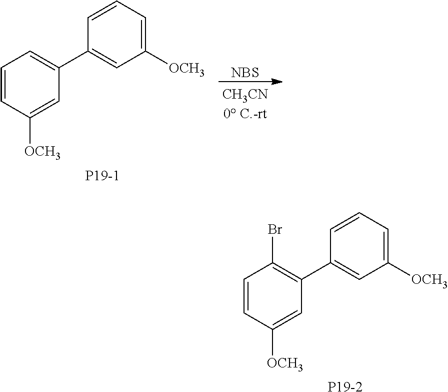

### Preparation of 2-bromo-3′,5-dimethoxy-1,1′-biphenyl (P19-2)

To a solution of 3,3′-dimethoxy-1,1′-biphenyl (P19-1, 7.076 g, 33.0 mmol, 1.0 equiv.) in 80 mL dry acetonitrile stirred under 0° C. was added an 80 mL acetonitrile solution of NBS (6.230 g, mmol, 1.05 equiv.) dropwise over 30 min. The yellow solution was then warmed up to room temperature with monitoring by TLC (Hex/EtOAc=2/1) and stirred overnight. Upon completion, the solvent was concentrated to ca. 30 mL under reduced pressure, and water (30 mL) was added. The aqueous layer was extracted with EtOAc (3×30 mL). The combined organic layer was washed with brine (30 mL), dried over Na₂SO₄ and evaporated. The crude yellow oil was purified by column chromatography on silica gel (20% EtOAc in Hexanes) to afford the product as a colorless oil (8.4 g, 87%). ¹H NMR (500 MHz, CDCl3) δ 7.54 (d, J=8.8 Hz, 1H), 7.37-7.31 (t, 1H), 6.99 (dt, J=7.5, 1.3 Hz, 1H), 6.96-6.92 (m, 2H), 6.88 (d, J=3.1 Hz, 1H), 6.78 (dd, J=8.8, 3.1 Hz, 1H), 3.85 (s, 3H), 3.81 (s, 3H). ¹³C NMR (126 MHz, CDCl₃) δ 159.11, 158.76, 143.23, 142.45, 133.70, 129.01, 121.71, 116.57, 114.98, 114.82, 113.29, 112.97, 55.55, 55.32.

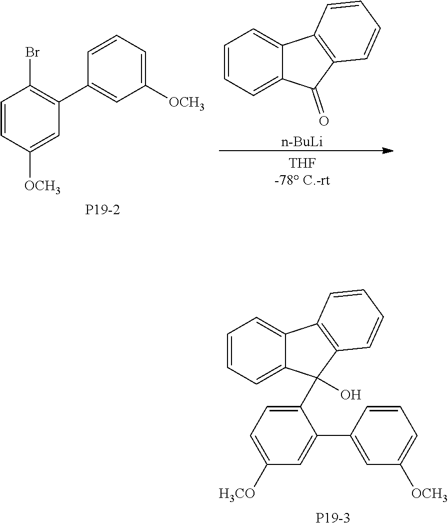

Preparation of 9-(3′,5-dimethoxy-[1,1′-biphenyl]-2-yl)-9H-fluoren-9-ol (P19-3) 2-bromo-3′,5-dimethoxy-1,1′-biphenyl (P19-2, 8.4 g, 28.7 mmol, 1.0 equiv.) was dissolved in 60 mL extra dry THF, and cooled down to −78° C. n-BuLi (19 mL, 1.6 M in hexanes, 30.1 mmol, 1.05 equiv.) was added dropwise to the reaction mixture. The reaction mixture was warmed to room temperature and stirred for an additional 1 hour, followed by cooling down to −78° C. A solution of 9H-fluoren-9-one (5.7 g, 31.6 mmol, 1.1 equiv.) in extra dry THF (60 mL) was added dropwise, and stirred at that temperature for 1 hour with monitoring by TLC. Then, the reaction was warmed to room temperature and stirred overnight. After completion, it was quenched by sat. NH₄Cl (20 mL). The aqueous layer was extracted with EtOAc (3×30 mL). The combined organic layer was washed with brine (30 mL), dried over Na₂SO₄ and evaporated. The crude product was purified by column chromatography on silica gel (10% EtOAc in Hexanes) to afford the product as a white solid (7.0 g, 62%). ¹H NMR (500 MHz, CDCl₃) δ 8.37 (d, J=8.8 Hz, 1H), 7.20 (m, 8H), 7.05 (dd, J=8.8, 2.8 Hz, 1H), 6.61-6.43 (m, 2H), 6.44-6.34 (m, 1H), 5.61 (d, J=7.4 Hz, 1H), 5.58-5.55 (m, 1H), 3.79 (s, 3H), 3.37 (s, 3H).

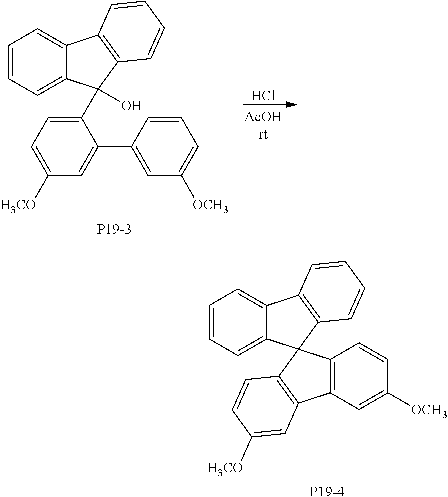

### Preparation of 3,6-dimethoxy-9,9′-spirobi[fluorene] (P19-4)

9-(3′,5-dimethoxy-[1,1′-biphenyl]-2-yl)-9H-fluoren-9-ol (P19-3, 1.0 g, 2.5 mmol, 1.0 equiv.) was dissolved in 100 mL AcOH, and 2 mL conc. HCl was added dropwise. The mixture was stirred at room temperature for 24 hours with monitoring by TLC. After completion, water (50 mL) was added, and the aqueous layer was extracted with EtOAc (3×30 mL). The combined organic layer was washed with brine (30 mL), dried over Na₂SO₄ and evaporated. The crude product was purified by column chromatography on silica gel (5% EtOAc in Hexanes) to afford the product as a white solid (0.62 g, 65%). ¹H NMR (500 MHz, CDCl₃) δ 7.82 (d, J=7.6 Hz, 1H), 7.42-7.30 (m, 2H), 7.10 (td, J=7.5, 1.1 Hz, 1H), 6.74 (d, J=7.6 Hz, 1H), 6.67 (dd, J=8.3, 2.4 Hz, 1H), 6.62 (d, J=8.5 Hz, 1H), 3.89 (s, 3H).

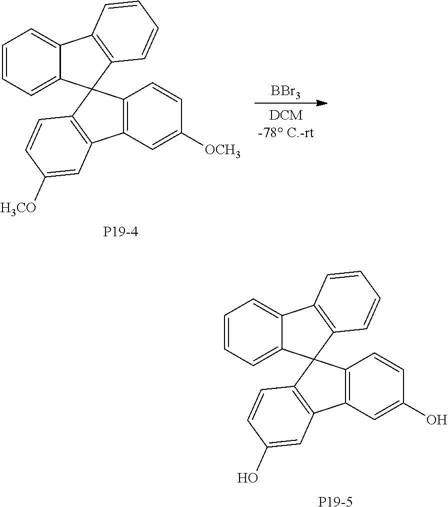

### Preparation of 9,9′-spirobi[fluorene]-3,6-diol (P19-5)

3,6-dimethoxy-9,9′-spirobi[fluorene] (P19-4, 0.720 g, 1.9 mmol, 1.0 equiv.) was dissolved in 5 mL dry DCM, and cooled to −78° C. BBr₃ (15.2 mL, 1.0 M in DCM, 15.2 mmol, 8.0 equiv.) was added dropwise via a syringe. Then the reaction was allowed to warm to room temperature and stirred overnight with monitoring by TLC. Subsequently, water (30 mL) was added, and the aqueous layer was extracted with EtOAc (3×30 mL). The combined organic layer was washed with brine (30 mL), dried over Na₂SO₄ and evaporated. The crude product was purified by column chromatography on silica gel (20% EtOAc in Hexanes) to afford the product as a white solid (quant.). ¹H NMR (500 MHz, CDCl3) δ 7.81 (d, J=7.6 Hz, 2H), 7.34 (td, J=7.5, 1.1 Hz, 2H), 7.23 (dd, J=1.8, 1.0 Hz, 2H), 7.10 (td, J=7.5, 1.1 Hz, 2H), 6.74 (d, J=7.6 Hz, 2H), 6.57 (m, 4H), 4.87 (brs, 1H).

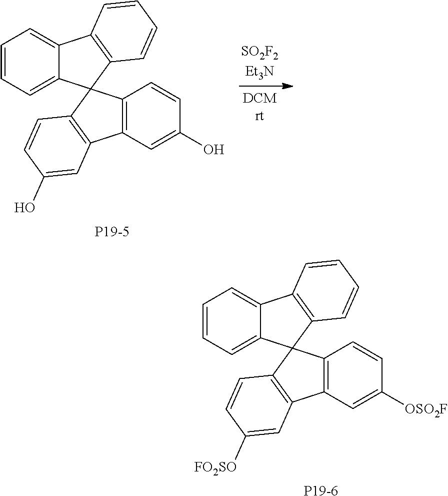

### Preparation of 9,9′-spirobi[fluorene]-3,6-diyl bis(sulfurofluoridate) (P19-6)

9,9′-spirobi[fluorene]-3,6-diol (P19-5, 0.240 g, 0.69 mmol, 1.0 equiv.) was dissolved in 4 mL dry DCM, and Et₃N (290 μL, 0.209 g, 2.07 mmol, 3.0 equiv.) was added. The mixture was charged with SO₂F₂ via a balloon, and stirred under room temperature for 4 hours with monitoring by TLC. Subsequently, the mixture washed with water (20 mL), the organic phase was dried over Na₂SO₄ and evaporated. The crude product was purified by column chromatography on silica gel (5% EtOAc in Hexanes) to afford the product as a white solid (quant.). ¹H NMR (500 MHz, CDCl3) δ 7.86 (d, J=7.7 Hz, 2H), 7.79 (d, J=2.3 Hz, 2H), 7.42 (td, J=7.5, 1.0 Hz, 2H), 7.19-7.11 (m, 4H), 6.84 (d, J=8.4 Hz, 2H), 6.72 (d, J=7.6 Hz, 2H).

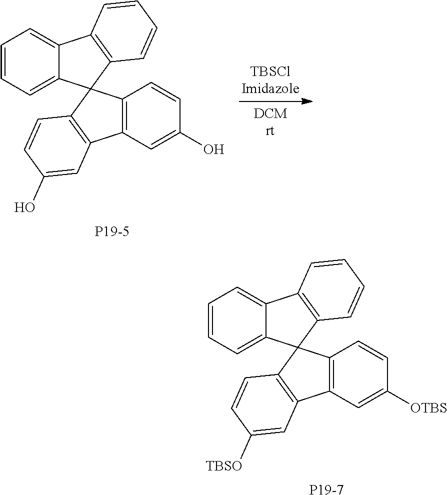

### Preparation of 3,6-bis((tert-butyldimethylsilyl)oxy)-9,9′-spirobi[fluorene] (P19-7)

9,9′-spirobi[fluorene]-3,6-diol (P19-5, 0.300 g, 0.86 mmol, 1.0 equiv.), imidazole (0.351 g, 5.16 mmol, 6.0 equiv.), and TBSC1 (0.520 g, 3.44 mmol, 4.0 equiv.) were dissolved in 1 mL dry DMF. The mixture was stirred under room temperature for 1 hour with monitoring by TLC. Then 5 mL of water was added, the aqueous layer was extracted with EtOAc (3×10 mL). The combined organic layer was washed with brine (10 mL), dried over Na₂SO₄ and evaporated. The crude product was purified by column chromatography on silica gel (5% EtOAc in Hexanes) to afford the product as a white solid (0.427 g, 86%). ¹H NMR (500 MHz, CDCl3) δ 7.80 (d, J=7.6 Hz, 2H), 7.34 (td, J=7.5, 1.1 Hz, 2H), 7.20 (dd, J=2.2, 0.5 Hz, 2H), 7.10 (td, J=7.5, 1.1 Hz, 2H), 6.74 (dt, J=7.6, 0.8 Hz, 2H), 6.59-6.49 (m, 4H), 1.01 (s, 18H), 0.24 (s, 12H).

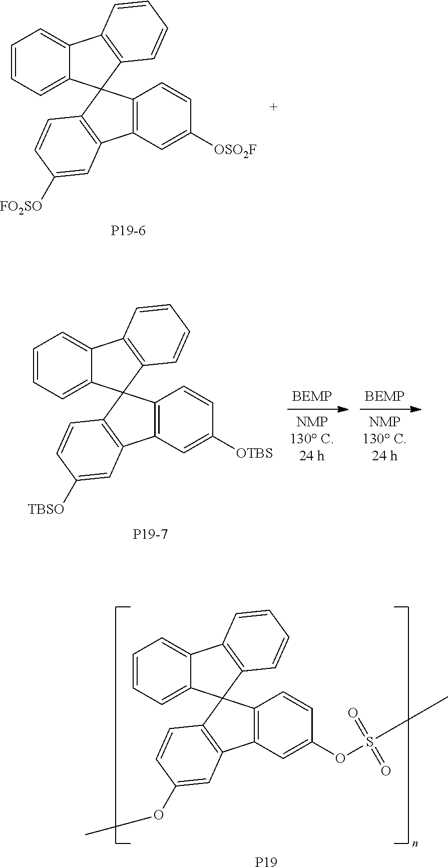

### Preparation of P19

The P19 was prepared by the generation procedure.

1H NMR (500 MHz, DMSO-d₆) δ 8.36 (s, 2H), 7.97 (d, J=14.5 Hz, 2H), 7.42-7.28 (m, 2H), 7.26-7.18 (m, 2H), 7.07-6.97 (m, 2H), 6.74-6.49 (m, 4H). ¹³C NMR (126 MHz, DMSO-d₆) δ 150.45, 148.67, 146.85, 142.54, 141.67, 128.81, 128.64, 125.71, 123.90, 122.00, 121.20, 115.43. mp=335° C. Mₙ=19.2 kDa. PDI=1.71. T_{g}=253.2° C.

### Example P20

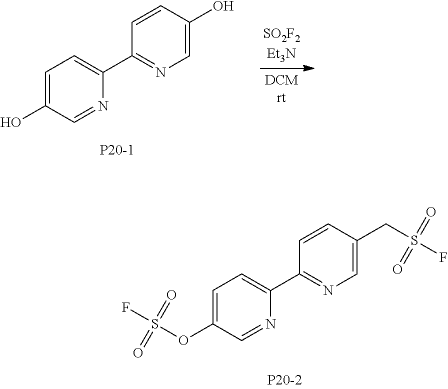 [SMILES: Oc1ccc(-c2ccc(O)cn2)nc1 ; O=S(=O)(F)Cc1ccc(-c2ccc(OS(=O)(=O)F)cn2)nc1]

### Preparation of [2,2′-bipyridine]-5,5′-diyl bis(sulfurofluoridate) (P20-2)

[2,2′-bipyridine]-5,5′-diol (P20-1, 0.100 g, 0.53 mmol, 1.0 equiv.) was suspended in 4 mL dry DCM, and Et₃N (222 μL, 0.161 g, 1.60 mmol, 3.0 equiv.) was added. The mixture was charged with SO₂F₂ via a balloon, and stirred under room temperature overnight with monitoring by TLC. Subsequently, the mixture washed with water (30 mL), the organic phase was dried over Na₂SO₄ and evaporated. The crude product was purified by column chromatography on silica gel (20% EtOAc in Hexanes) to afford the product as a white solid (0.157 g, 84%). ¹H NMR (400 MHz, CDCl3) δ 8.74 (d, J=2.7 Hz, 1H), 8.62 (d, J=9.1 Hz, 1H), 7.87 (dd, J=8.7, 2.7 Hz, 1H).

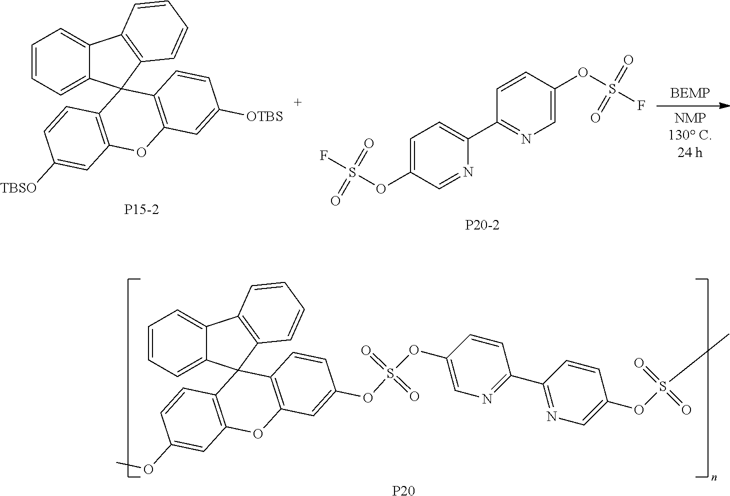

### Preparation of P20

The P20 was prepared by the generation procedure.

mp=298° C. Mₙ=15.7 kDa. PDI=1.31. T_{g}=191.3° C.

### Example P21

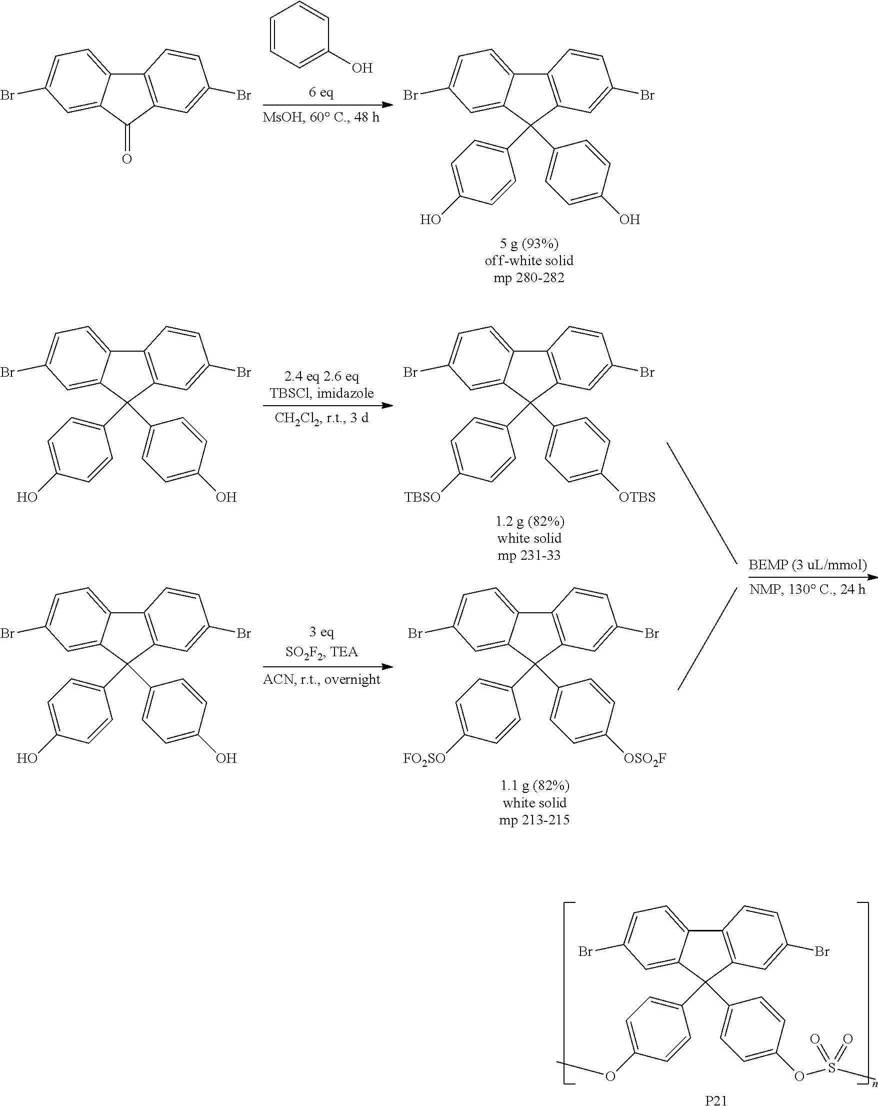

### 4,4′-(2,7-dibrom 0-9H-fluorene-9,9-diyl)diphenol

The mixture of 2,7-dibromo-9H-fluoren-9-one (3.6 g, 1 eq, 10.6 mmol), phenol (5 g, 6 eq, 66.6 mmol), and 14 mL MsOH were heated at 60° C. for 24 hours. The resulting liquid were poured into ice-water and obtained solid was collected by filtration. The solid was dried under vacuum at room temperature, and then re-dissolved in EtOAc. The solution was injected into hexane via syringe and the resulting solid was collected as desired product with high purity as an off-white solid (93% yield). mp 280-282° C. ¹H NMR (400 MHz, DMSO-d₆) δ 9.38 (s, 2H), 7.86 (d, J=8.2 Hz, 2H), 7.54 (d, J=8.2 Hz, 2H), 7.45 (s, 2H), 6.85 (d, J=8.5 Hz, 4H), 6.62 (d, J=8.6 Hz, 4H).

### Monomers:

(((2,7-dibromo-9H-fluorene-9,9-diyl)bis(4,1-phenylene))bis(oxy))bis(tert-butyldimethylsilane). White solid, 82% yield. mp 231-233° C. ¹H NMR (400 MHz, Chloroform-d) δ 7.55 (d, J=8.5 Hz, 2H), 7.49-7.37 (m, 4H), 6.96 (d, J=8.6 Hz, 4H), 6.68 (d, J=8.6 Hz, 4H), 0.95 (s, 18H), 0.17 (s, 12H).

(2,7-dibromo-9H-fluorene-9,9-diyl)bis(4,1-phenylene)bis(sulfurofluoridate). White solid, 82% yield. mp 213-215° C. ¹H NMR (400 MHz, Chloroform-d) δ 7.63 (d, J=7.7 Hz, 2H), 7.55 (d, J=7.6 Hz, 2H), 7.42 (s, 2H), 7.30-7.16 (m, 8H). 19F NMR (376 MHz, Chloroform-d) δ 38.1 (s).

Polysulfate P21 was prepared from the above monomers. Gray solid, mp 300-312° C. 1H NMR (600 MHz, DMSO) δ 7.97-7.90 (m, 2H), 7.70-7.50 (m, 4H), 7.40-7.09 (m, 8H). ¹³C NMR (151 MHz, DMSO) δ 151.6, 148.8, 143.7, 137.7, 131.5, 129.7, 128.6, 123.1, 121.6, 121.4, 64.2. Mₙ=20.4 kDa, PDI=1.57. T_{g}=256.9° C.

### Example P22

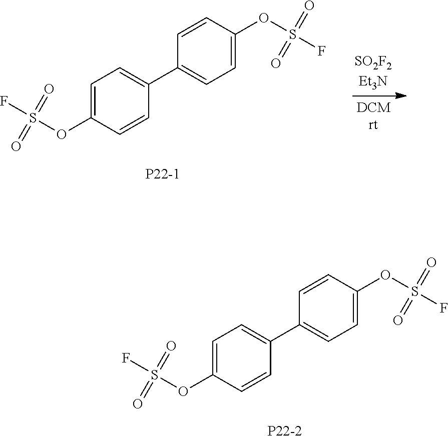

The compound was prepared according to the previous literature published by our group [Gao B, Zhang L, Zheng Q, et al. Bifluoride-catalysed sulfur (VI) fluoride exchange reaction for the synthesis of polysulfates and polysulfonates. Nature Chemistry, 2017, 9(11): 1083-1088.].

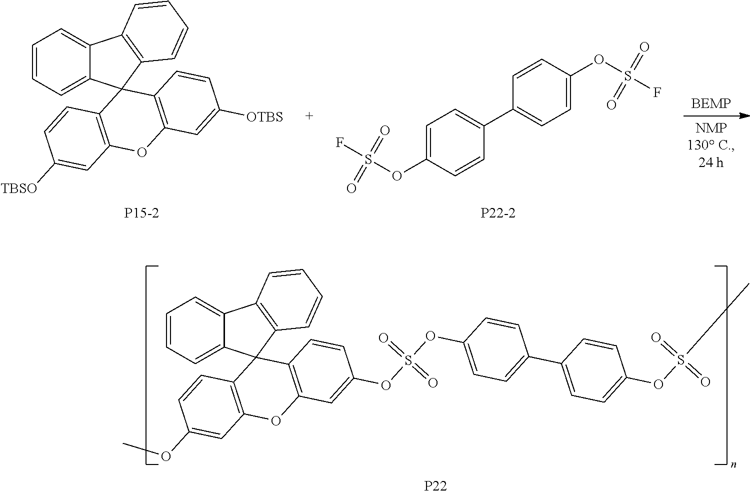

### Preparation of P22

The P22 was prepared by the generation procedure.

1H NMR (500 MHz, DMSO-d₆) δ 8.04-7.94 (m, 2H), 7.87-7.70 (m, 4H), 7.62-7.35 (m, 8H), 7.27-6.81 (m, 6H), 6.44-6.27 (m, 2H). mp=298° C. Mₙ=42.9 kDa. PDI=1.82. T_{g}=191.3° C.

Synthesis of Monomer with Spirocycle:

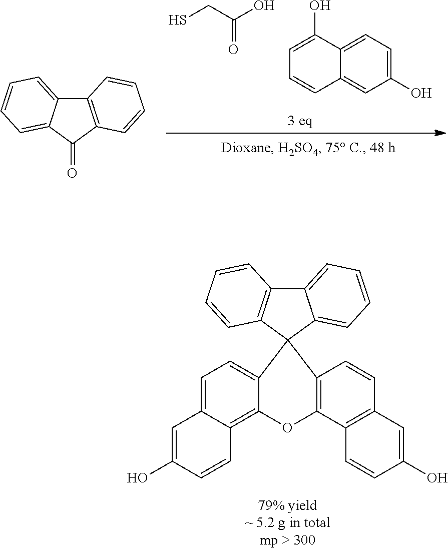 [SMILES: O=C1c2ccccc2-c2ccccc21 ; O=C(O)CS ; Oc1ccc2c(O)cccc2c1 ; Oc1ccc2c3c(ccc2c1)C1(c2ccccc2-c2ccccc21)c1ccc2cc(O)ccc2c1O3]

### Spiro[dibenzo[c,h]xanthene-7,9′-fluorene]-3,11-diol

To a mixture of 9H-fluoren-9-one (1.8 g, 1 eq, 10 mmol) and naphthalene-1,6-diol (4 g, 2.7 eq, 27.4 mmol) in 1,4-dioxane (50 mL), was slowly added 2-mercaptoacetic acid (200 μL) and sulfuric acid in sequence. The resulting mixture was heated at 75° C. for 12 hours monitoring by TLC. The reaction mixture was quenched with water, extracted with EtOAc, dried over Na₂SO₄ and concentrated to dryness. The residue was purified by flash chromatography system (0-60% EtO Ac/Hexane) to afford the product a pale yellow solid (5.2 g, 79% yield). mp >300° C. ¹H NMR (600 MHz, DMSO) δ 9.92 (s, 2H), 8.60 (d, J=9.0 Hz, 2H), 8.04 (d, J=7.7 Hz, 2H), 7.53-7.33 (m, 2H), 7.31 (dd, J=9.0, 2.4 Hz, 2H), 7.22 (td, J=7.4, 1.1 Hz, 2H), 7.15 (d, J=8.7 Hz, 2H), 7.09 (d, J=7.6 Hz, 2H), 7.07 (d, J=2.4 Hz, 2H), 6.15 (d, J=8.7 Hz, 2H). ¹³C NMR (151 MHz, DMSO) δ 156.7, 155.9, 145.8, 139.8, 135.3, 129.0, 128.6, 126.2, 125.8, 123.6, 122.1, 120.9, 119.2, 118.5, 115.1, 109.6, 53.8.

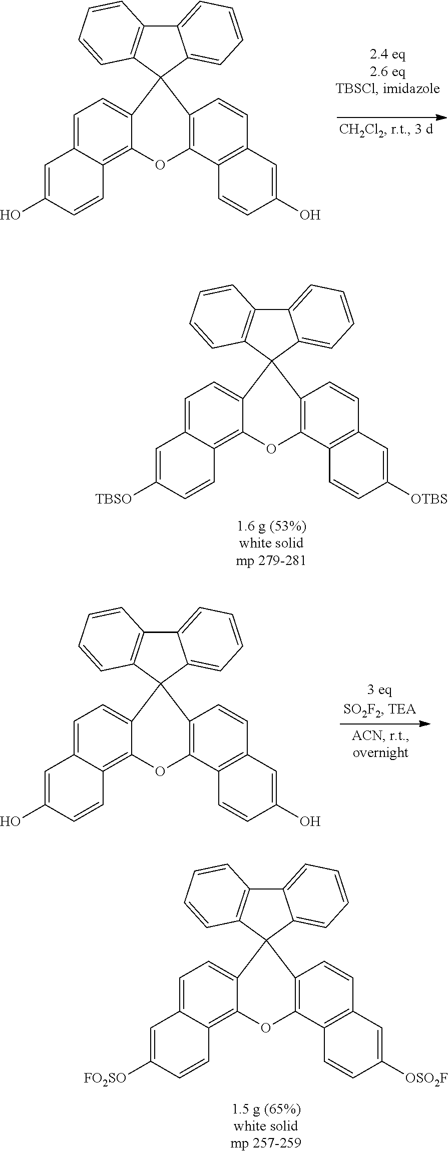

### Monomers:

3,11-bis((tert-butyldimethylsilyl)oxy)spiro[dibenzo[c,h]xanthene-7,9′-fluorene]. White solid, 53% yield. mp 279-281° C. ¹H NMR (600 MHz, CDCl3) δ 8.86 (d, J=9.4 Hz, 2H), 7.94 (d, J=7.7 Hz, 2H), 7.78 (s, 2H), 7.70 (d, J=9.2 Hz, 2H), 7.48 (t, J=7.5 Hz, 2H), 7.36 (d, J=8.7 Hz, 2H), 7.27 (q, J=7.5 Hz, 2H), 7.17 (d, J=7.7 Hz, 2H), 6.56 (d, J=8.7 Hz, 2H). ¹³C NMR (151 MHz, CDCl₃) δ 155.3, 148.4, 145.6, 139.8, 133.8, 128.7, 128.5, 127.9, 126.2, 124.7, 123.7, 123.5, 120.3, 119.9, 119.5, 118.8. ¹⁹F NMR (376 MHz, CDCl₃) δ 38.1 (s).

spiro[dibenzo[c,h]xanthene-7,9′-fluorene]-3,11-diyl bis(sulfurofluoridate). White solid, 65% yield. mp 257-259° C. ¹H NMR (600 MHz, DMSO) δ 8.64 (d, J=9.0 Hz, 2H), 8.01 (d, J=7.8 Hz, 2H), 7.43 (t, J=7.6 Hz, 2H), 7.29 (d, J=9.0 Hz, 2H), 7.22 (dd, J=17.1, 8.1 Hz, 6H), 7.10 (d, J=7.5 Hz, 2H), 6.22 (d, J=8.7 Hz, 2H), 1.00 (s, 18H), 0.25 (s, 12H). ¹³C NMR (151 MHz, DMSO) δ 155.3, 153.9, 145.2, 139.3, 134.5, 128.4, 128.1, 125.7, 125.6, 123.1, 122.1, 122.0, 120.3, 119.4, 115.8, 114.9, 25.6, −4.5.

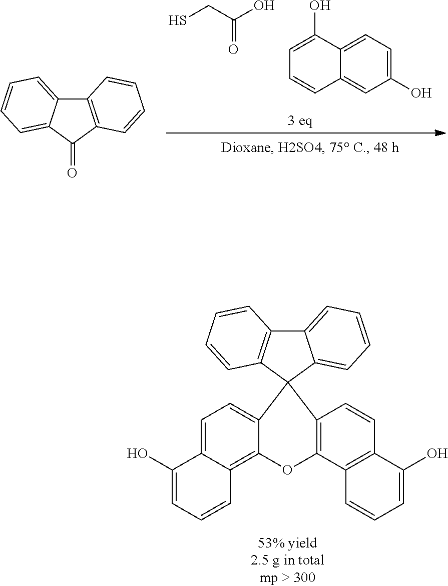 [SMILES: O=C1c2ccccc2-c2ccccc21 ; O=C(O)CS ; Oc1ccc2c(O)cccc2c1 ; Oc1cccc2c3c(ccc12)C1(c2ccccc2-c2ccccc21)c1ccc2c(O)cccc2c1O3]

### Spiro[dibenzo[c,h]xanthene-7,9′-fluorene]-4,10-diol

This intermediate was prepared by using similar condition in the synthesis of Spiro[dibenzo[c,h]xanthene-7,9′-fluorene]-3,11-diol. The product was obtained as yellow solid with a 53% yield. mp >300° C. ¹H NMR (600 MHz, DMSO) δ 10.21 (s, 1H), 8.15 (d, J=8.4 Hz, 1H), 8.07 (d, J=7.7 Hz, 1H), 7.60 (d, J=8.9 Hz, 1H), 7.56 (t, J=8.0 Hz, 1H), 7.49-7.42 (m, 1H), 7.28-7.22 (m, 1H), 7.12 (d, J−7.6 Hz, 1H), 7.03-6.95 (m, 1H), 6.21 (d, J=8.9 Hz, 1H). ¹³C NMR (151 MHz, DMSO) δ 155.8, 153.9, 145.5, 139.9, 129.1, 128.7, 127.9, 126.3, 125.8, 124.8, 123.8, 121.0, 118.4, 118.0, 112.2, 109.9, 54.1.

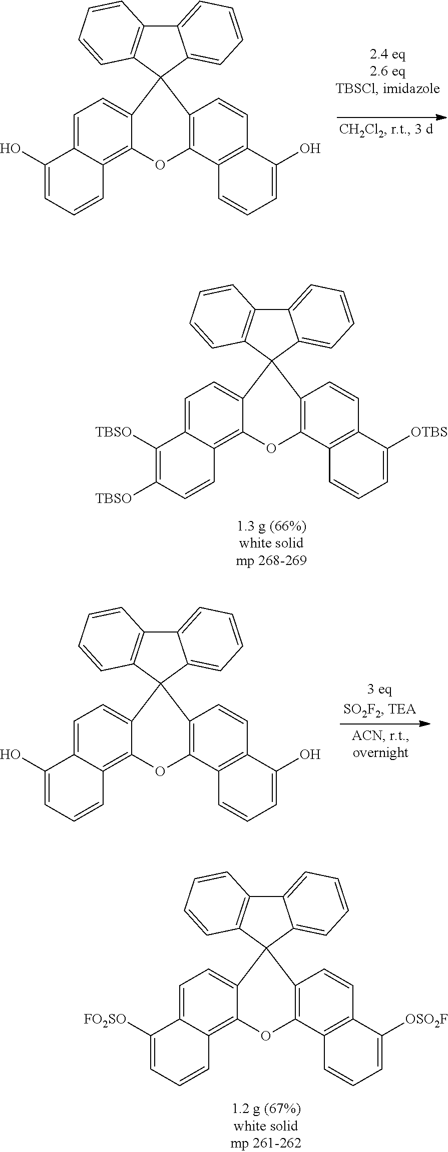

4,10-bis((tert-butyldimethylsilyl)oxy)spiro[dibenzo[c,h]xanthene-7,9′-fluorene]. Yellow solid, 66% yield. mp 268-269° C. ¹H NMR (600 MHz, CDCl3) δ 8.80 (d, J=8.4 Hz, 2H), 7.94 (d, J=7.7 Hz, 2H), 7.77 (t, J=8.1 Hz, 2H), 7.66 (d, J=7.7 Hz, 2H), 7.54 (d, J=8.9 Hz, 2H), 7.48 (td, J=7.5, 1.1 Hz, 2H), 7.25 (td, J=7.4, 1.1 Hz, 2H), 7.17 (d, J=7.6 Hz, 2H), 6.61 (d, J=8.9 Hz, 2H). ¹³C NMR (151 MHz, CDCl₃) δ 155.2, 146.3, 145.7, 140.0, 128.9, 128.8, 128.1, 126.4, 126.3, 126.1, 126.0, 122.6, 120.5, 120.3, 118.6, 116.3, 54.0, 1° F. NMR (376 MHz, DMSO-D⁶) δ 34.7 (s).

spiro[dibenzo[c,h]xanthene-7,9′-fluorene]-4,10-diyl bis(sulfurofluoridate). Yellow solid, 67% yield. Mp 261-262° C. ¹H NMR (600 MHz, CDCl3) δ 8.37 (dd, J=8.4, 1.2 Hz, 2H), 7.92-7.85 (m, 2H), 7.64 (d, J=8.8 Hz, 2H), 7.55 (t, J=8.0 Hz, 2H), 7.42 (td, J=7.4, 1.4 Hz, 2H), 7.25-7.16 (m, 4H), 6.95 (dd, J=7.6, 1.0 Hz, 2H), 6.41 (d, J=8.8 Hz, 2H), 1.03 (s, 19H), 0.27 (s, 12H). ¹³C NMR (151 MHz, CDCl3) δ 156.1, 151.8, 146.0, 140.0, 128.5, 128.1, 128.0, 126.5, 126.5, 126.3, 124.7, 120.0, 118.5, 117.9, 114.7, 113.5, 54.4, 25.9, 18.5, −4.2.

Polysulfates P31-P42 were prepared from corresponding monomers by using the standard polymerization condition. The spectral data are listed as following:

### Example P31

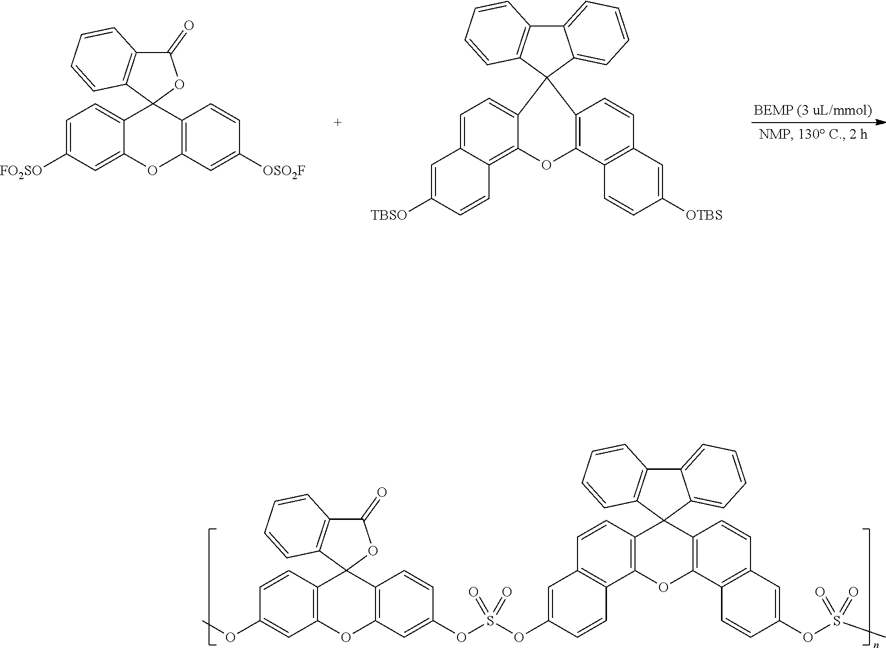

Yellow solid. mp >300° C. ¹H NMR (600 MHz, DMSO) δ 9.02-8.84 (m, 2H), 8.06-7.99 (m, 4H), 7.81-7.00 (m, 20H), 6.39-6.22 (m, 2H). ¹³C NMR (151 MHz, DMSO) δ 168.2, 154.9, 150.8, 150.6, 150.4, 148.2, 145.0, 139.3, 139.1, 136.1, 133.5, 130.5, 128.6, 128.4, 126.8, 125.8, 125.0, 124.7, 124.1, 123.6, 122.6, 120.6, 120.3, 118.9, 118.6, 118.4, 117.5, 117.5, 110.0, 53.3, 51.8, Mₙ=24.3 kDa, PDI=1.79. T_{g}=301.9° C.

### Example P32

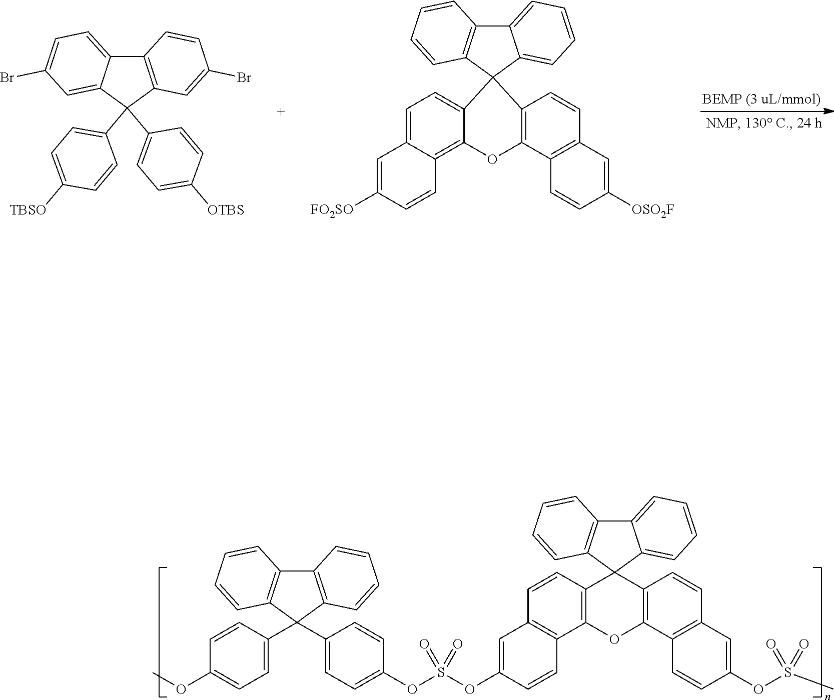

White solid. mp >300° C. ¹H NMR (600 MHz, DMSO) δ 9.06-8.73 (m, 2H), 8.07-8.00 (m, 2H), 7.92-7.70 (m, 4H), 7.50-7.03 (m, 24H), 6.44-6.19 (m, 2H). ¹³C NMR (151 MHz, DMSO) δ 155.0, 149.5, 148.6, 148.4, 145.1, 145.0, 139.4, 139.3, 133.5, 129.6, 129.5, 128.7, 128.5, 128.2, 126.8, 125.9, 124.5, 123.6, 122.5, 121.2, 121.2, 120.8, 120.6, 120.4, 118.8, 118.8, 118.5, 64.0, 53.3. Mₙ=11.6 kDa, PDI=1.42. T_{g}=271.9° C.

### Example P33

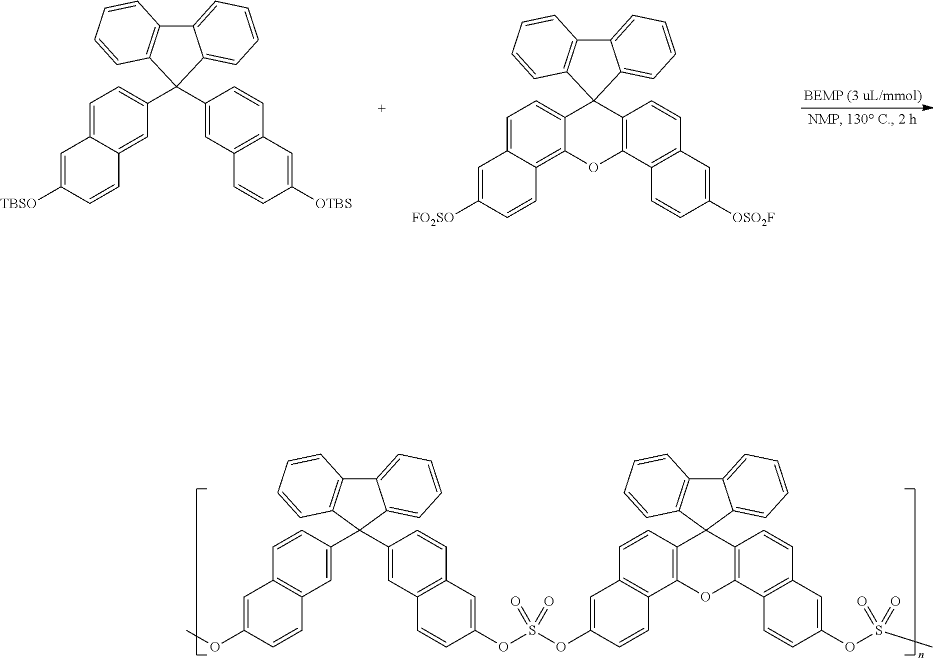

White solid. mp >300° C. ¹H NMR (600 MHz, DMSO) δ 9.16-8.69 (m, 2H), 8.07-7.97 (m, 3H), 7.94-6.72 (m, 31H), 6.43-6.13 (m, 2H). ¹³C NMR (151 MHz, DMSO) δ 154.9, 149.7, 148.3, 147.4, 145.0, 144.0, 139.7, 139.3, 133.5, 132.0, 131.5, 130.8, 128.4, 128.1, 126.8, 126.1, 125.8, 125.5, 124.7, 123.6, 122.6, 120.6, 120.4, 120.0, 118.8, 118.6, 118.2, 65.0, 53.2. Mₙ=41.3 kDa, PDI=2.1. T_{g}>310° C.

### Example P34

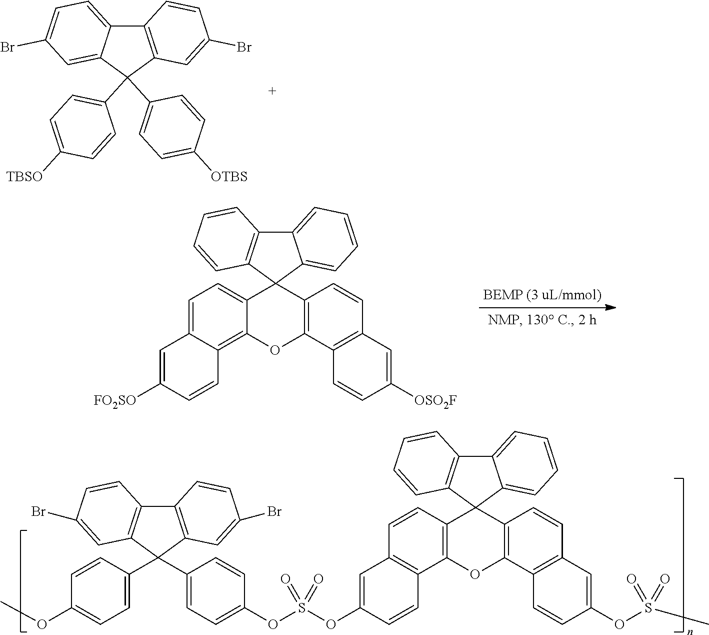

White solid. mp >300° C. ¹H NMR (600 MHz, DMSO) δ 8.99-8.82 (m, 2H), 8.04-7.97 (m, 2H), 7.94-7.00 (m, 26H), 6.38-6.18 (m, 2H). ¹³C NMR (151 MHz, DMSO) δ 154.9, 151.6, 148.9, 148.3, 145.0, 143.7, 139.3, 137.7, 133.4, 131.5, 129.7, 129.6, 128.6, 126.8, 125.8, 124.5, 123.5, 123.1, 122.5, 121.6, 121.5, 121.4, 120.6, 120.3, 118.8, 118.5, 64.2, 53.3. Mₙ=67.5 kDa, PDI=2.0. T_{g}=299.9° C.

### Example P35

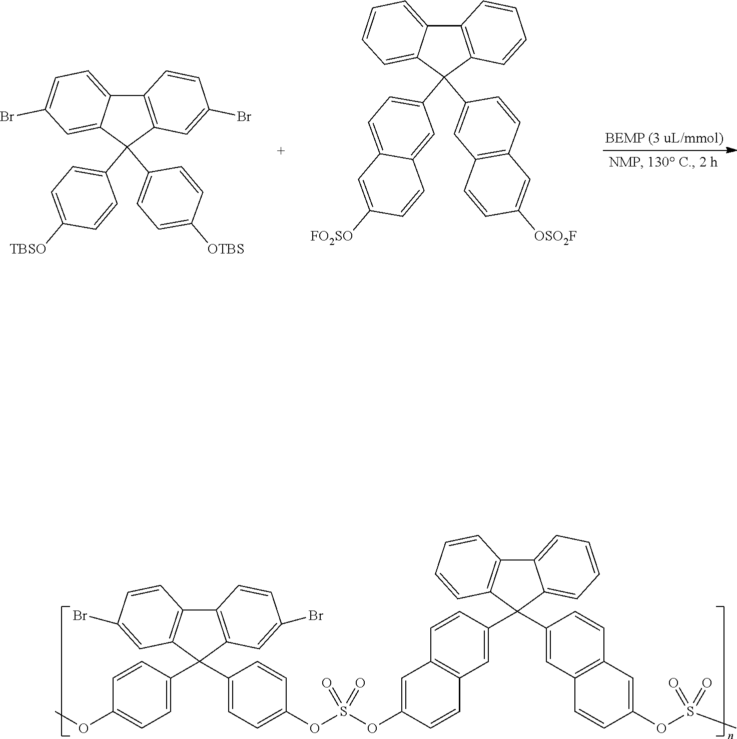

White solid. mp >300° C. ¹H NMR (600 MHz, DMSO) δ 8.03-7.96 (m, 2H), 7.95-7.75 (m, 8H), 7.72-7.62 (m, 4H), 7.61-7.53 (m, 4H), 7.47-7.20 (m, 16H). ¹³C NMR (151 MHz, DMSO) δ 151.6, 149.7, 148.9, 147.5, 144.0, 143.7, 139.7, 137.7, 132.0, 131.6, 131.5, 130.7, 129.7, 128.7, 128.4, 128.1, 126.2, 125.5, 123.1, 121.7, 121.5, 120.8, 119.9, 118.2, 65.0, 64.2. Mₙ=23.6 kDa, PDI=1.57. T_{g}=266.8° C.

### Example P36

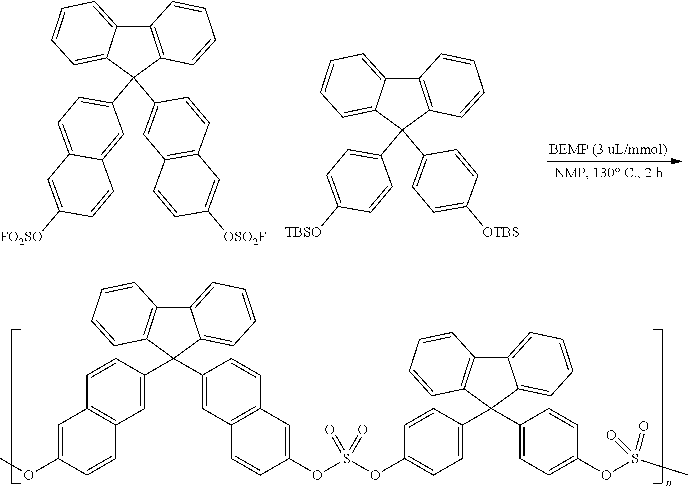

White solid. mp >300° C. ¹H NMR (600 MHz, DMSO) δ 8.02-7.96 (m, 2H), 7.94-7.72 (m, 8H), 7.69-7.60 (m, 2H), 7.60-7.52 (m, 2H), 7.48-7.11 (m, 22H). ¹³C NMR (151 MHz, DMSO) δ 149.7, 149.5, 148.6, 147.5, 145.1, 143.9, 139.7, 139.4, 131.9, 131.4, 130.7, 129.6, 129.5, 128.4, 128.1, 126.1, 125.9, 125.4, 121.2, 120.8, 119.9, 118.1, 65.0, 64.0. Mₙ=22.4 kDa, PDI=1.53. T_{g}=253.8° C.

### Example P37

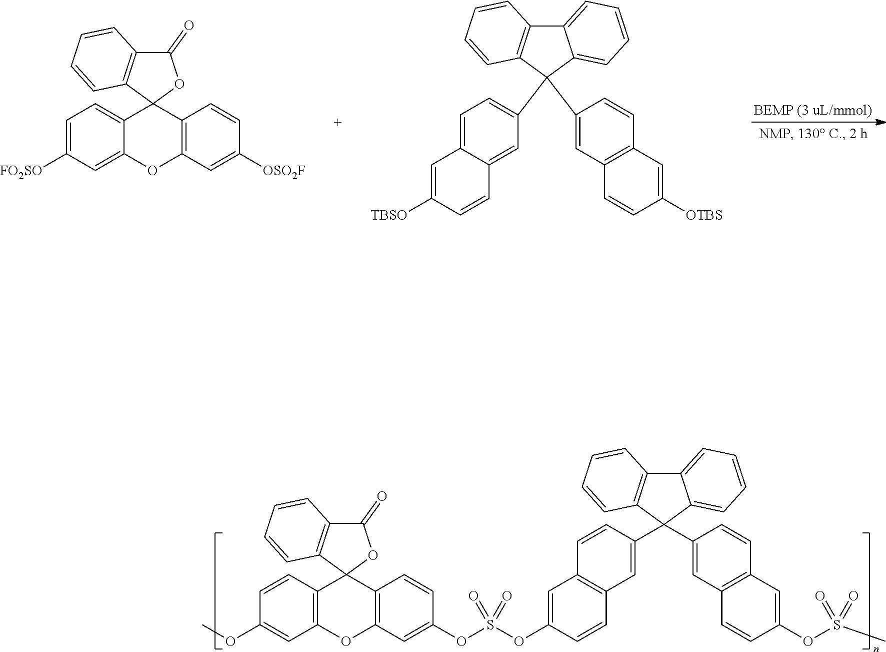

Yellow solid. mp >300° C. ¹H NMR (600 MHz, DMSO) δ 9.05-8.59 (m, 2H), 8.15-7.97 (m, 2H), 7.92-7.65 (m, 6H), 7.41-7.04 (m, 22H), 6.44-6.17 (m, 2H). ¹³C NMR (151 MHz, DMSO) δ 154.8, 149.5, 148.5, 145.3, 145.0, 139.4, 129.5, 128.7, 128.1, 126.9, 126.7, 125.7, 125.4, 121.8, 121.4, 121.2, 120.8, 119.1, 118.8, 116.3, 64.0, 53.2. Mₙ=10.9 kDa, PDI=1.6. T_{g}=258.3° C.

### Example P38

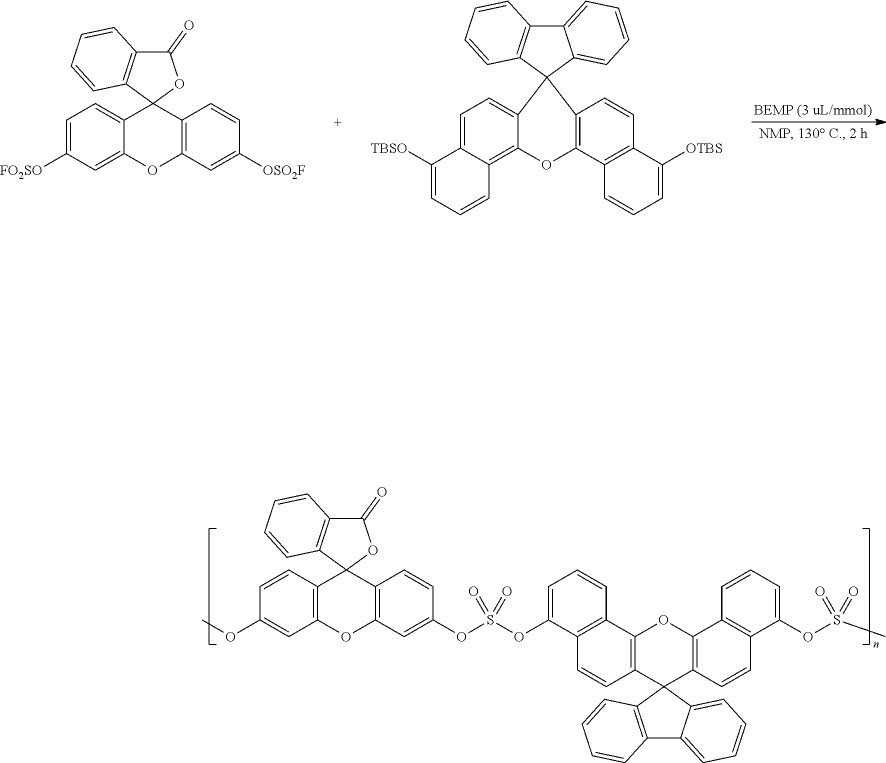

Yellow solid. mp >300° C. ¹H NMR (600 MHz, DMSO) δ 8.06-7.97 (m, 4H), 7.95-7.85 (m, 4H), 7.79-7.66 (m, 4H), 7.63-7.54 (m, 4H), 7.51-7.36 (m, 8H), 7.33-7.22 (m, 4H), 7.15-6.92 (m, 2H). ¹³C NMR (151 MHz, DMSO) δ 168.2, 152.0, 150.8, 150.6, 150.5, 149.7, 147.5, 147.4, 144.0, 144.0, 139.7, 136.1, 132.0, 131.6, 131.5, 130.9, 130.5, 128.5, 128.1, 126.2, 125.5, 125.2, 125.0, 124.2, 120.8, 119.9, 118.4, 118.2, 117.6, 110.0, 79.9, 65.0. Mₙ=12.7 kDa, PDI=1.77. T_{g}=>300° C.

### Example P39

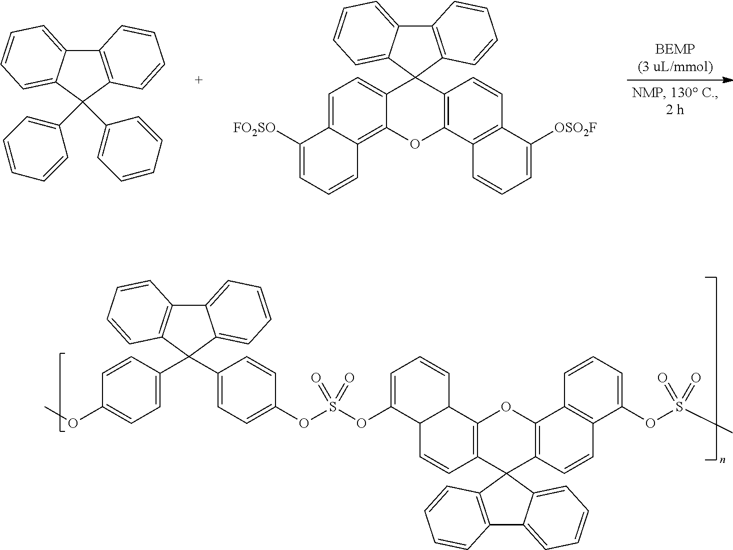

White solid. mp >300° C. ¹H NMR (600 MHz, DMSO) δ 9.11-8.60 (m, 2H), 8.15-7.97 (m, 2H), 7.95-6.78 (m, 22H), 6.54-6.04 (m, 2H). ¹³C NMR (151 MHz, DMSO) δ 168.2, 154.8, 152.1, 150.7, 150.5, 145.4, 145.0, 139.3, 136.0, 130.8, 130.4, 128.6, 126.9, 125.7, 125.4, 125.2, 124.9, 124.0, 122.0, 120.6, 119.2, 118.9, 118.5, 116.3, 110.1, 79.8, 53.2. Mₙ=12.7 kDa, PDI=1.56. T_{g}=280.2° C.

### Example P40

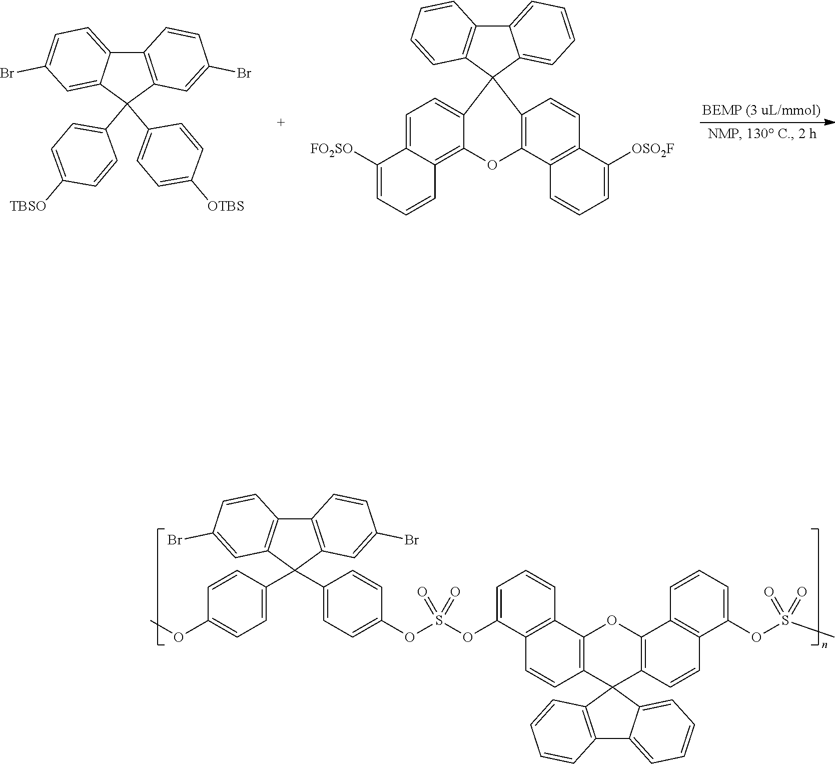

White solid. mp >300° C. ¹H NMR (600 MHz, DMSO) δ 9.15-8.56 (m, 2H), 8.09-7.96 (m, 2H), 7.93-7.69 (m, 6H), 7.63-7.53 (m, 4H), 7.44-7.19 (m, 12H), 7.17-6.96 (m, 4H), 6.45-6.20 (m, 2H). ¹³C NMR (151 MHz, DMSO) δ 155.2, 152.0, 149.3, 145.9, 145.5, 144.3, 139.8, 138.1, 132.0, 130.1, 129.1, 127.4, 126.2, 125.8, 123.6, 122.1, 121.9, 121.1, 119.2, 116.8, 64.7, 53.6. Mₙ=15.7 kDa, PDI=1.61. T_{g}=>300° C.

### Example P41

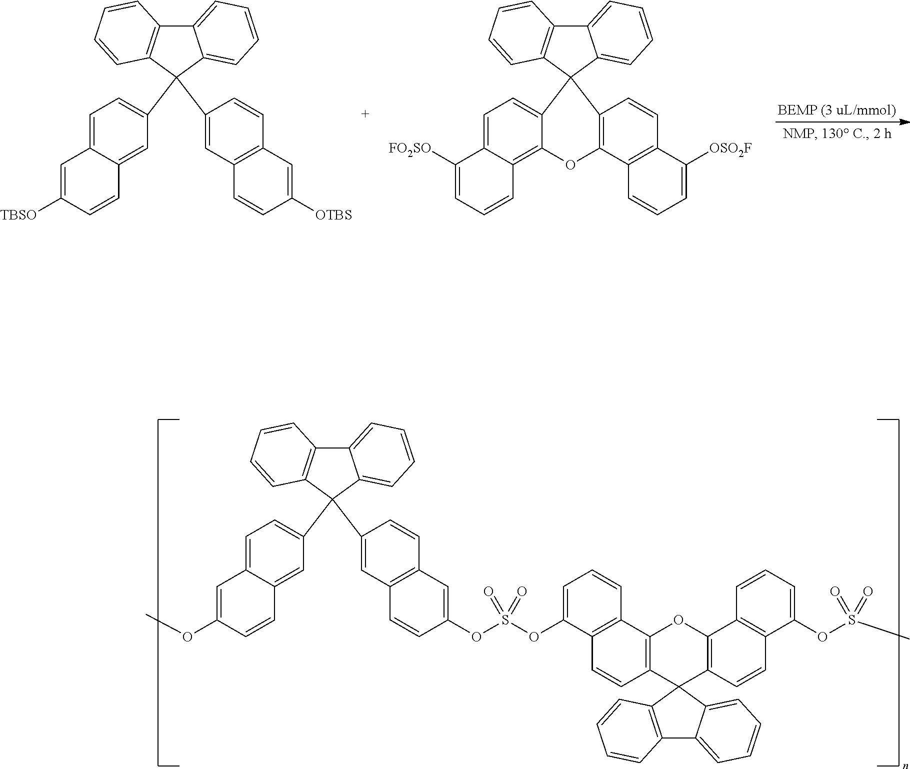

White solid. mp >300° C. ¹H NMR (600 MHz, DMSO) δ 9.01-8.76 (m, 2H), 8.12-7.96 (m, 4H), 7.96-6.69 (m, 31H), 6.46-6.23 (m, 2H). ¹³C NMR (151 MHz, DMSO) δ 154.8, 149.7, 147.3, 145.6, 145.1, 144.0, 139.7, 139.3, 131.9, 131.5, 130.8, 128.3, 128.1, 126.9, 126.1, 125.7, 125.5, 125.4, 121.8, 120.8, 120.6, 120.1, 119.2, 118.4, 116.5, 65.0, 53.2. Mₙ=22.2 kDa, PDI=1.73. T_{g}=>310° C.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A dielectric film comprising a polymer film that comprises a coating of an inorganic dielectric material having a thickness in the range of about 1 to about 500 nm on at least one face thereof; and the polymer film comprises a polymer of Formula I, which is free from residual metal catalysts: 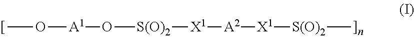
wherein:
A¹ is a first divalent aryl group;
A² is a second divalent aryl group;
X¹ is O or a covalent bond;
n is the average number of repeating units within the brackets of the formula and has a value sufficient to provide a number average molecular weight (Mₙ) of at least about 7,000 g mol⁻¹, as determined by SEC using styrene-divinyl benzene columns, DMF/0.2% LiBr elution solvent, and polystyrene molecular weight standards; and
each divalent aryl group independently is unsubstituted or is substituted by one or more substituent selected from halogen, alkyl, aryl, arylalkyl, alkylaryl, alkoxy, and aryloxy.

2. The dielectric film of claim 1, wherein A¹ and A² are the same.

3. The dielectric film of claim 1, wherein A¹ and A² are different.

4. The dielectric film of any one of claims 1 to 3, wherein the first divalent aryl group and the second divalent aryl group are independently selected from the group consisting of divalent phenyl (—C₆H₄—), divalent naphthyl (—C₁₀H₆—), divalent anthracenyl (—C₁₄H₁₀—), divalent biphenyl (—C₆H₄—C₆H₄—), divalent binaphthyl (—C₁₀H₆—C₁₀H₆—), a divalent heteroaryl group, a divalent aryl group of formula -A³-X²-A³-, and a divalent aryl group of formula -A⁴-X³-A⁴-;
wherein each A³ and A⁴ independently is a divalent aryl moiety;
X² is selected from S(O)₂, O, S, C(═O), and Z(R¹)(R²);
X³ is selected from S(O)₂, O, S, C(═O), and Z(R³)(R⁴);
Z is carbon or silicon;
R¹ is aryl; R² is selected from H, halogen, alkyl, aryl, arylalkyl, alkylaryl, alkoxy and aryloxy; or R¹ and R² together constitute a first divalent substituent which together with Z constitutes a 5-, 6-, or 7-membered hydrocarbon or heterocyclic ring;
R³ is aryl; R⁴ is selected from H, halogen, alkyl, aryl, arylalkyl, alkylaryl, alkoxy and aryloxy; or R³ and R⁴ together constitute a second divalent substituent which together with Z constitutes a 5-, 6-, or 7-membered hydrocarbon or heterocyclic ring;
and wherein the first and second divalent substituents optionally are substituted by one or more substituent selected from halogen, alkoxy, and aryloxy.

5. The dielectric film of claim 4, wherein Z is carbon.

6. The dielectric film of claim 5, wherein the first and/or second divalent substituents together with the Z to which they are attached constitute a cyclic group selected from the group consisting of an anthrone group, a 2,3-benzofluorene group, a chroman group, a 2-coumarone group, a 4,5-diazafluorene group, a dibenzosuberane group, a dibenzosuberene group, a 9,10-dihydroanthracene group, a 2,7-dihydro-3,4-benzofuran group, a 9,10-dihydro-9,10-difluoroanthracene group, a 2,3-dihydrobenzofuran group, a 9,10-dihydrophenanthrene group, a fluorene group, an indan group, an indene group, a 3-isochromanone group, a phthalide group, a thioxanthene group, and a xanthene group.

7. The dielectric film of any one of claims 1 to 6, wherein X¹ is O.

8. The dielectric film of claim 1, wherein the polymer of Formula I is:

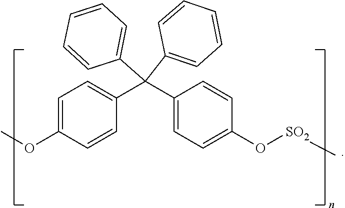

9. The dielectric film of claim 1, wherein the polymer of Formula I is:

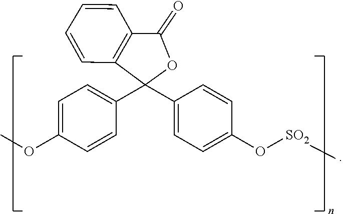

10. The dielectric film of claim 1, wherein the polymer of Formula I is:

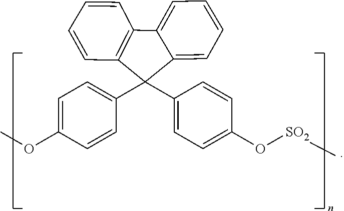

11. The dielectric film of claim 1, wherein the polymer of Formula I is:

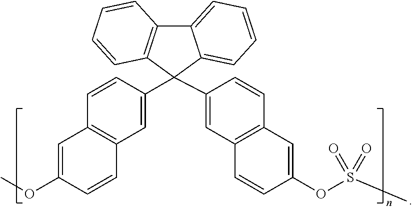

12. The dielectric film of claim 1, wherein the polymer of Formula I is:

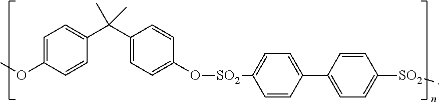

13. The dielectric film of claim 1, wherein the polymer of Formula I is selected from the group consisting of:

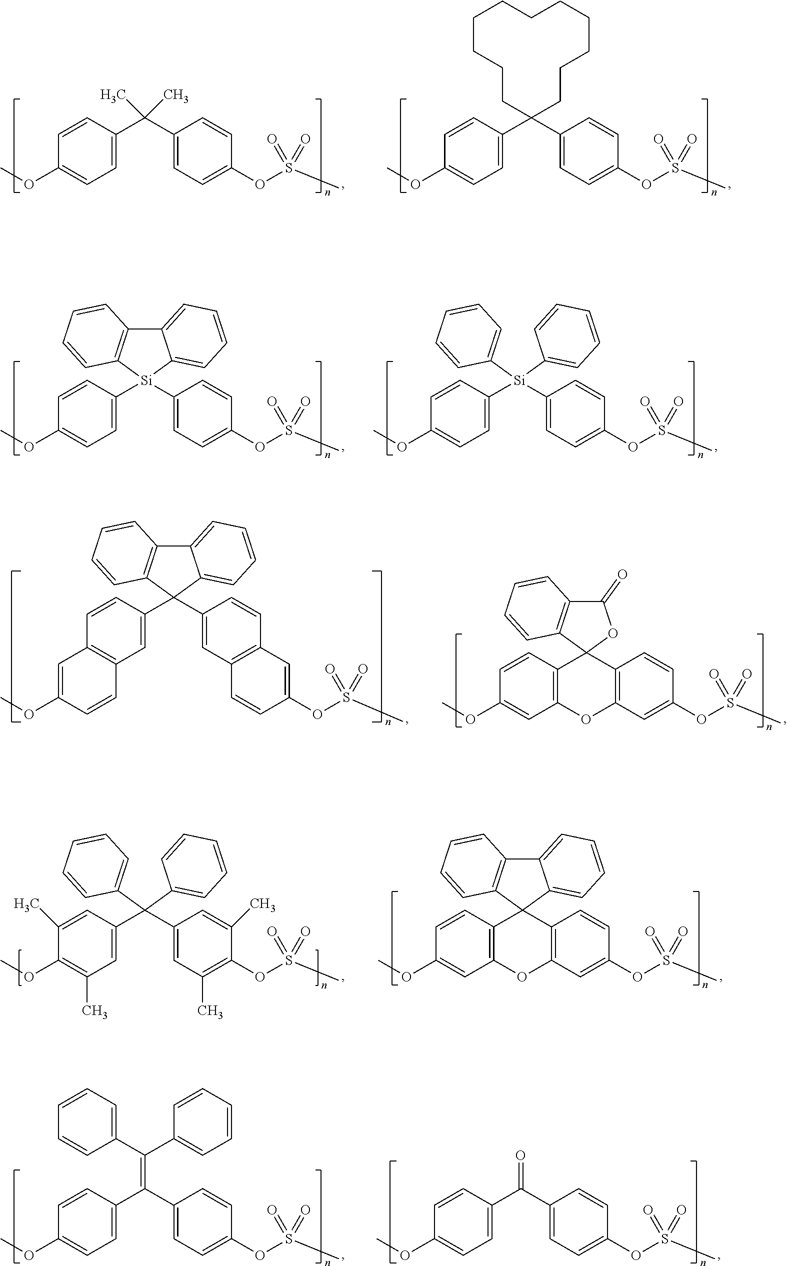

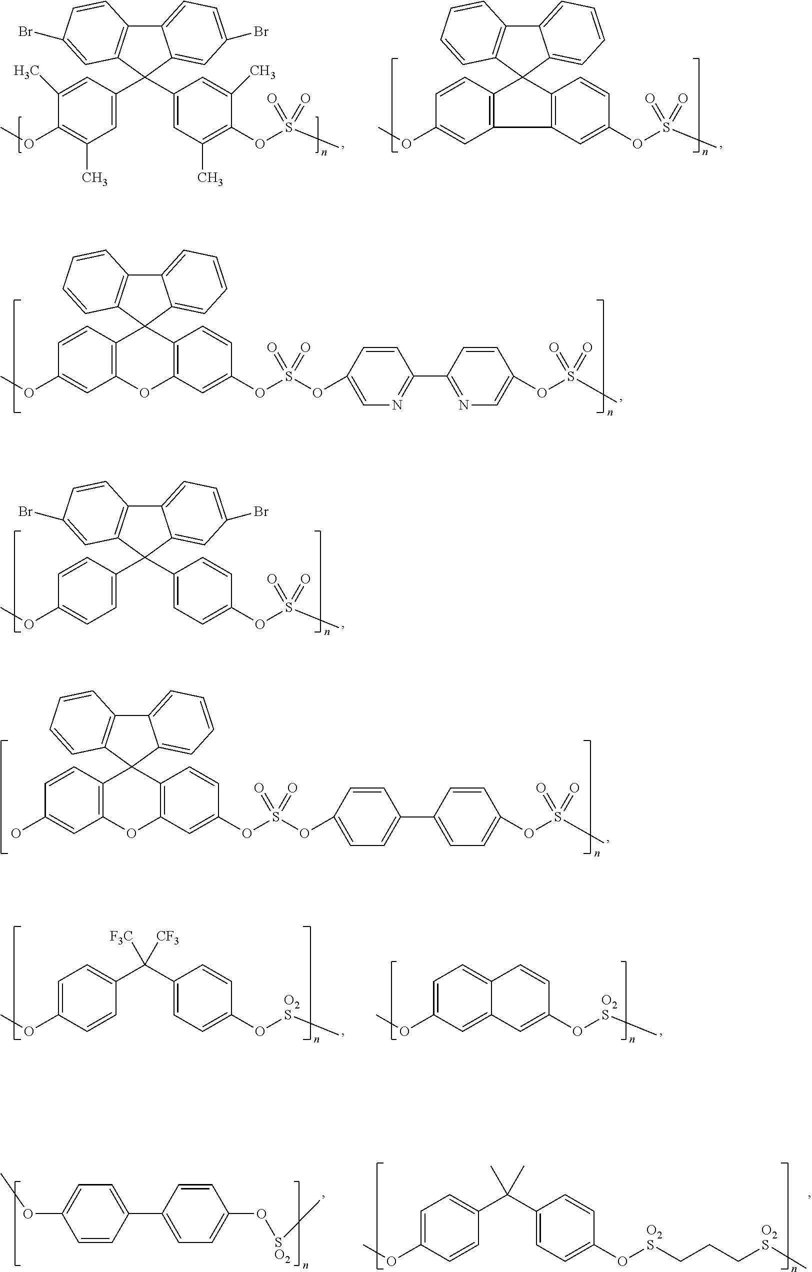

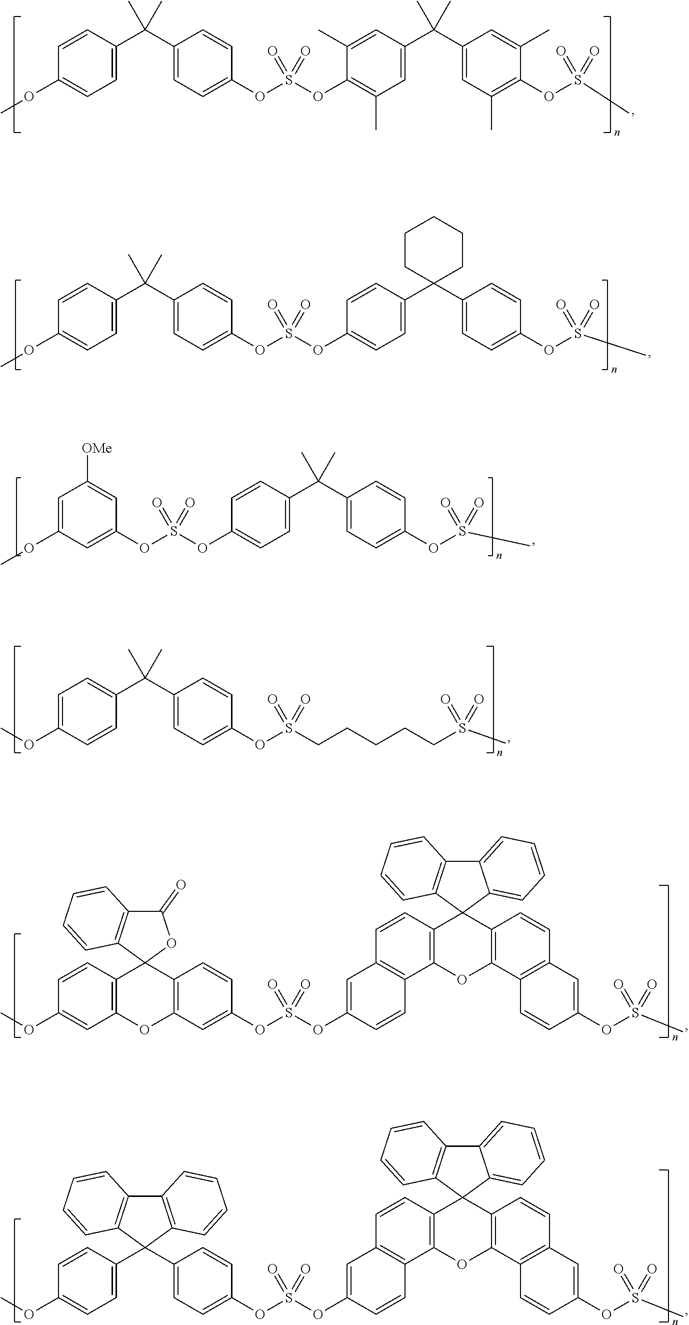

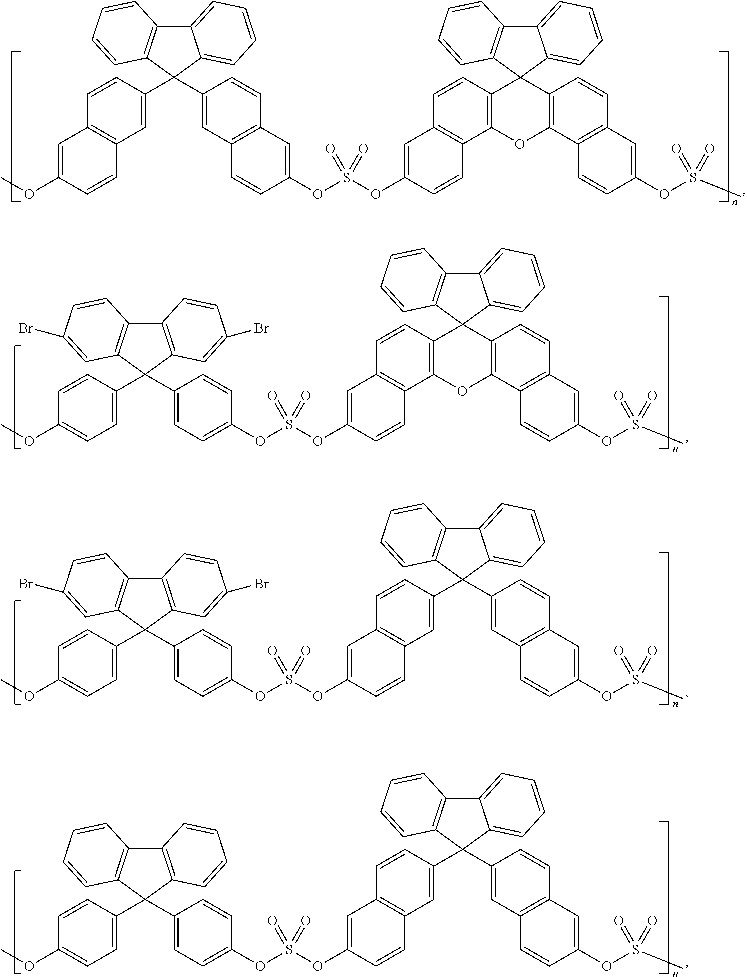

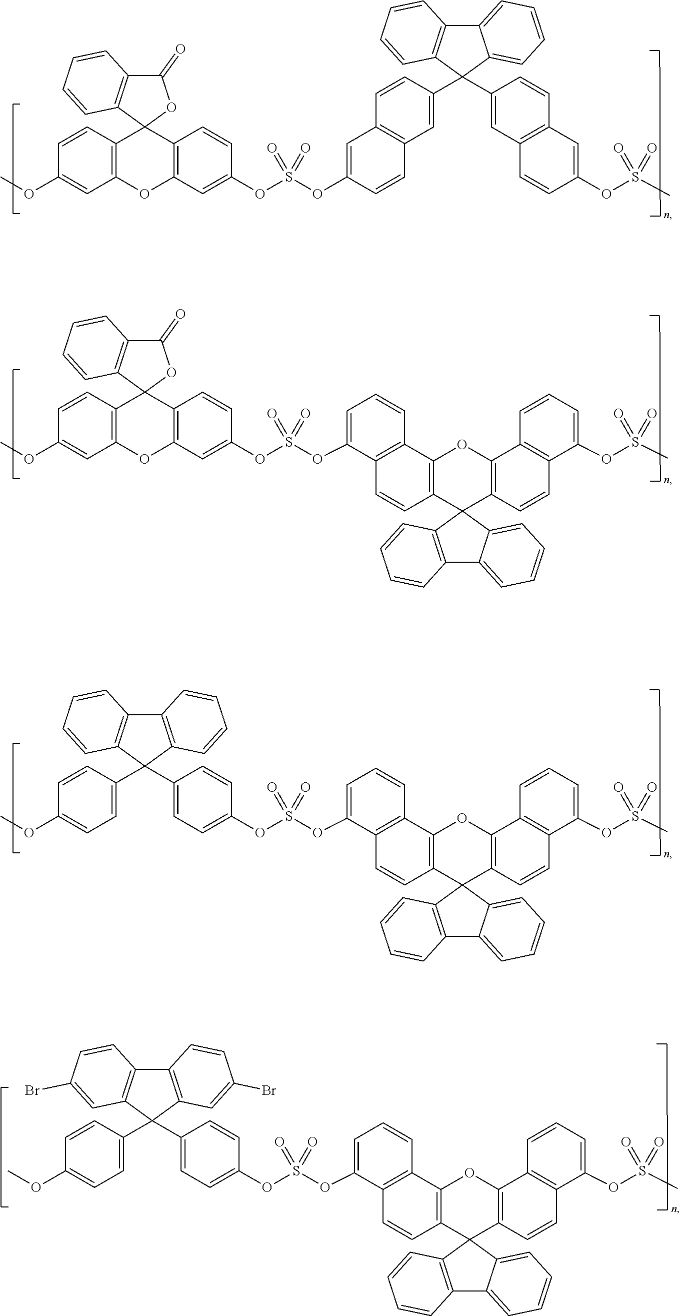

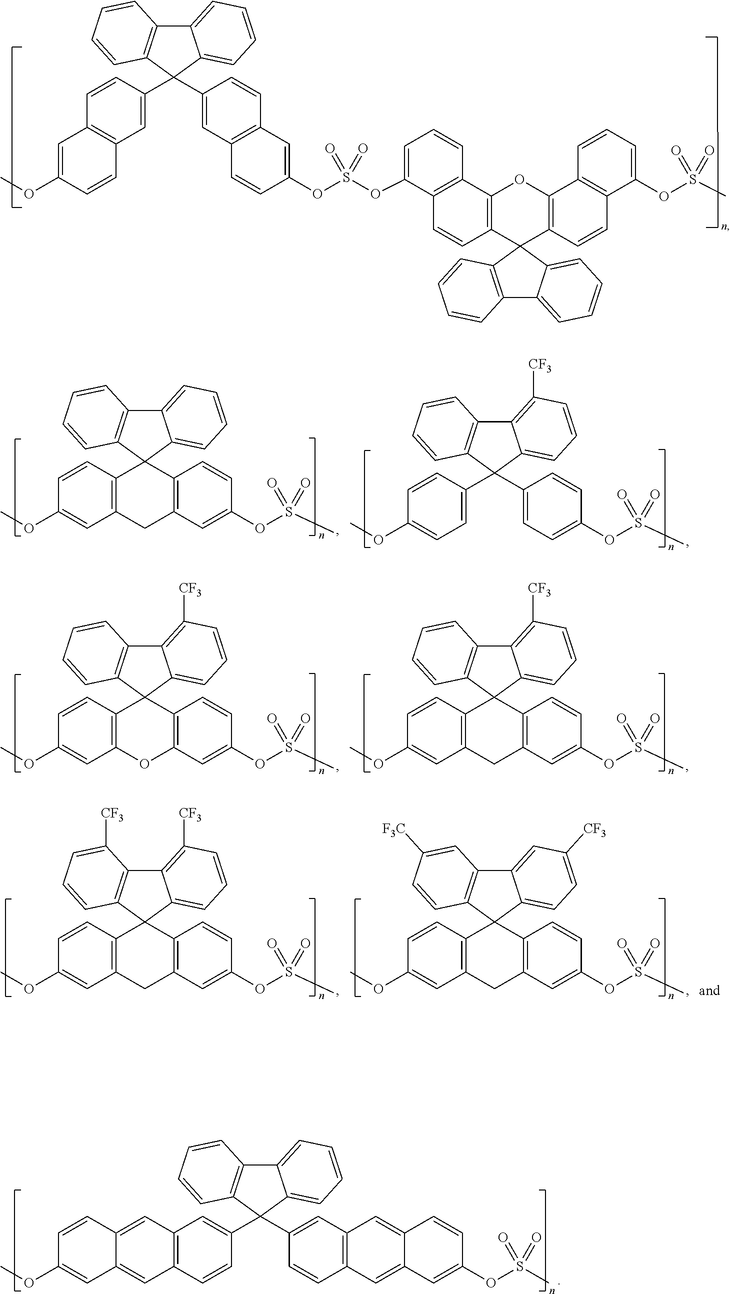

14. The dielectric film of any one of claims 1 to 6, wherein the polymer of Formula I is a polymer of Formula IV: 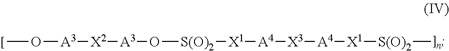
wherein:
A³ and A⁴ independently are divalent aryl moieties;
X¹ is O or a covalent bond;
X² is selected from S(O)₂, O, S, C(═O), a covalent bond, and Z(R¹)(R²)
X³ is selected from S(O)₂, O, S, C(═O), a covalent bond, and Z(R³)(R⁴);
Z is carbon or silicon;
R¹ is selected from the group consisting of aryl, arylalkyl, alkylaryl, and an alkyl comprising at least four carbons; R² is selected from the group consisting of H, halogen, alkyl, aryl, arylalkyl, and alkylaryl; or R¹ and R² together constitute a first divalent substituent, and the first divalent substituent together with Z constitutes a hydrocarbon ring or heterocyclic ring;
R³ is selected from the group consisting of aryl, arylalkyl, alkylaryl, and an alkyl comprising at least four carbons; R⁴ is selected from the group consisting of H, halogen, alkyl, aryl, arylalkyl, and alkylaryl; or R³ and R⁴ together constitute a second divalent substituent, and the second divalent substituent together with Z constitutes hydrocarbon ring or heterocyclic ring;
n is the average number of repeating units within the brackets of the formula and has a value sufficient to provide a number average molecular weight (Mₙ) of at least about 7,000 g mol⁻¹, as determined by SEC using styrene-divinyl benzene columns, DMF/0.2% LiBr elution solvent, and polystyrene molecular weight standards; and
each divalent aryl group and divalent substituent independently is unsubstituted or is substituted by one or more substituent selected from halogen, alkyl, aryl, arylalkyl, alkylaryl, alkoxy, and aryloxy.

15. The dielectric film of claim 14, wherein Z is carbon.

16. The dielectric film of any one of claims 1 to 15, wherein the polymer has a glass transition temperature (T_{g}) of at least about 120° C.; a dielectric constant (k) of at least about 3, and a dielectric loss tangent (tan δ) of not more than about 0.5 as measured at 30° C. and 10⁴ Hz.

17. The dielectric film of any one of claims 1 to 15, wherein the T_{g} is at least about 150° C., and/or tan δ is at least about 0.02, and/or k is at least about 3.3.

18. The dielectric film of any one of claims 1 to 17, wherein the inorganic dielectric material is selected from the group consisting of Al₂O₃, HfO₂, ZrO₂, SnN, TaN, Y₂O₃, TiO₂, ZnO, SnO₂, SiO₂, MgO, BN, and AlN.

19. The dielectric film of any one of claims 1 to 17, wherein the inorganic dielectric material is Al₂O₃.

20. The dielectric film of any one of claims 1 to 19, wherein the coating has a thickness in the range of about 4 to about 6 nm.

21. The dielectric film of any one of claims 1 to 20, wherein the polymer film has a thickness in the range of about 1 to about 15 μm.

22. An electrostatic energy storage device comprising a first conductive layer and a second conductive layer, with a layer of the dielectric film of any one of claims 1 to 21 between the conductive layers thereby constituting a multilayer structure; wherein the layer of dielectric film electrically insulates the first and second conductive layers from each other.

23. The electrostatic energy storage device of claim 22, wherein the conductive layers are metal films coated on the dielectric polymer film.

24. The electrostatic energy storage device of claim 22, wherein the conductive layers are metal foils.

25. The electrostatic energy storage device of any one of claims 22 to 24, wherein the multilayer structure is in the form of a rolled cylinder, with an electrically insulating layer comprising a second dielectric film of any one of claims 1 to 21 disposed in the roll between turns of the multilayer structure.

26. An electrostatic energy storage device comprising a plurality of stacked, electrically connected first conductive layers; and a plurality of stacked, electrically connected second conductive layers; wherein the first conductive layers are interleaved with the second conductive layers in alternating sequence; and wherein each of the first conductive layers is electrically insulated from each adjacent second conductive layer by an intervening layer of the dielectric film of any one of claims 1 to 21.

27. The electrostatic energy storage device of claim 26, wherein the conductive layers are metal foils.

28. The electrostatic energy storage device of claim 27, wherein the conductive layers comprise a metal selected from the group consisting of Al, Ta, Nb, Au, Pt, and Cu.

29. The electrostatic energy storage device of claim 27 or claim 28, wherein the conductive layers are metal coatings on the layers of the dielectric film.

30. An electrostatic energy storage device comprising a first conductive layer and a second conductive layer, with a layer of a first polymeric dielectric film between the conductive layers, thereby constituting a multilayer structure; wherein the layer of the first polymeric dielectric film comprises a polymer of Formula I, which electrically insulates the first and second conductive layers from each other: 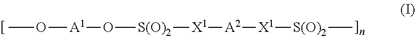
wherein:
A¹ is a first divalent aryl group;
A² is a second divalent aryl group;
X¹ is O or a covalent bond;
n is the average number of repeating units within the brackets of the formula and has a value sufficient to provide a number average molecular weight (Mₙ) of at least about 7,000 g mol⁻¹, as determined by size exclusion chromatography (SEC) using styrene-divinyl benzene columns, DMF/0.2% LiBr elution solvent, and polystyrene molecular weight standards; and
each divalent aryl group independently is unsubstituted or is substituted by one or more substituent selected from halogen, alkyl, aryl, arylalkyl, alkylaryl, alkoxy, and aryloxy.

31. The electrostatic energy storage device of claim 30, wherein A¹ and A² are the same.

32. The electrostatic energy storage device of claim 30, wherein A¹ and A² are different.

33. The electrostatic energy storage device of any one of claims 30 to 32, wherein n has a value sufficient to provide a number average molecular weight (Mₙ) of at least about 20,000 g mol⁻¹.

34. The electrostatic energy storage device of claim 33, n has a value sufficient to provide a number average molecular weight (Mₙ) of at least about 30,000 g mol⁻¹.

35. The electrostatic energy storage device of any one of claims 30 to 33, wherein the polymer has a glass transition temperature (T_{g}) of at least about 120° C.; a dielectric constant (k) of at least about 3, and a dielectric loss tangent (tan δ) of not more than about 0.5 as measured at 30° C. and 10⁴ Hz.

36. The electrostatic energy storage device of any one of claims 30 to 34, wherein the T_{g} is at least about 140° C., and/or tan δ is at least about 0.02, and/or k is at least about 3.3.

37. The electrostatic energy storage device of any one of claims 30 to 36, wherein X¹ is O.

38. The electrostatic energy storage device of claim 37, wherein the polymer of Formula I is:

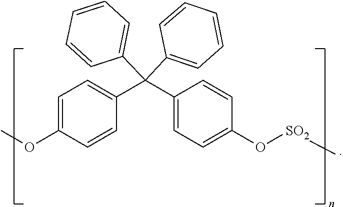

39. The electrostatic energy storage device of claim 37, wherein the polymer of Formula I is:

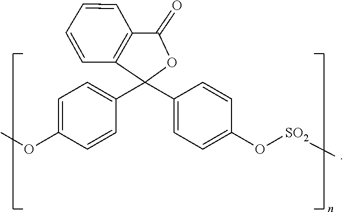

40. The electrostatic energy storage device of claim 37, wherein the polymer of Formula I is:

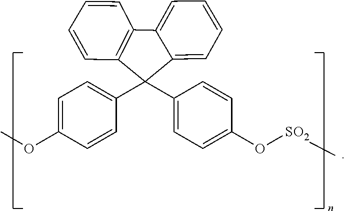

41. The electrostatic energy storage device of claim 37, wherein the polymer of Formula I:

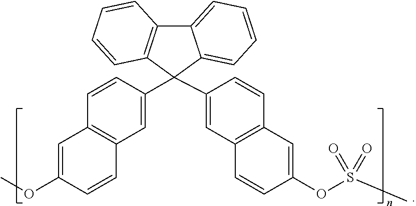

42. The electrostatic energy storage device of any one of claims 30 to 36, wherein X¹ is a covalent bond.

43. The electrostatic energy storage device of claim 42, wherein the polymer of Formula I is:

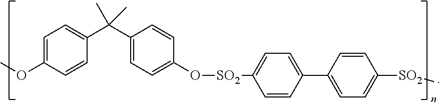

44. The electrostatic energy storage device of claim 30, wherein the polymer of Formula I is selected from the group consisting of:

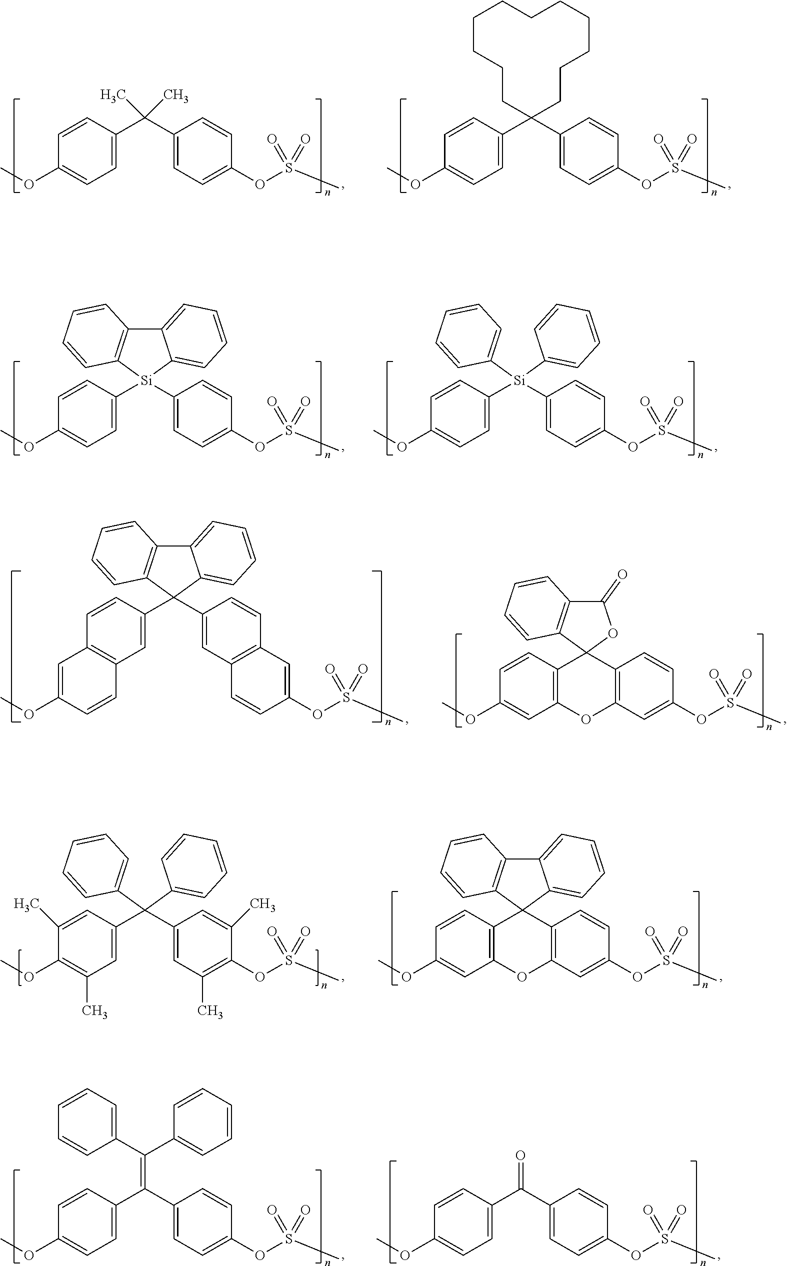

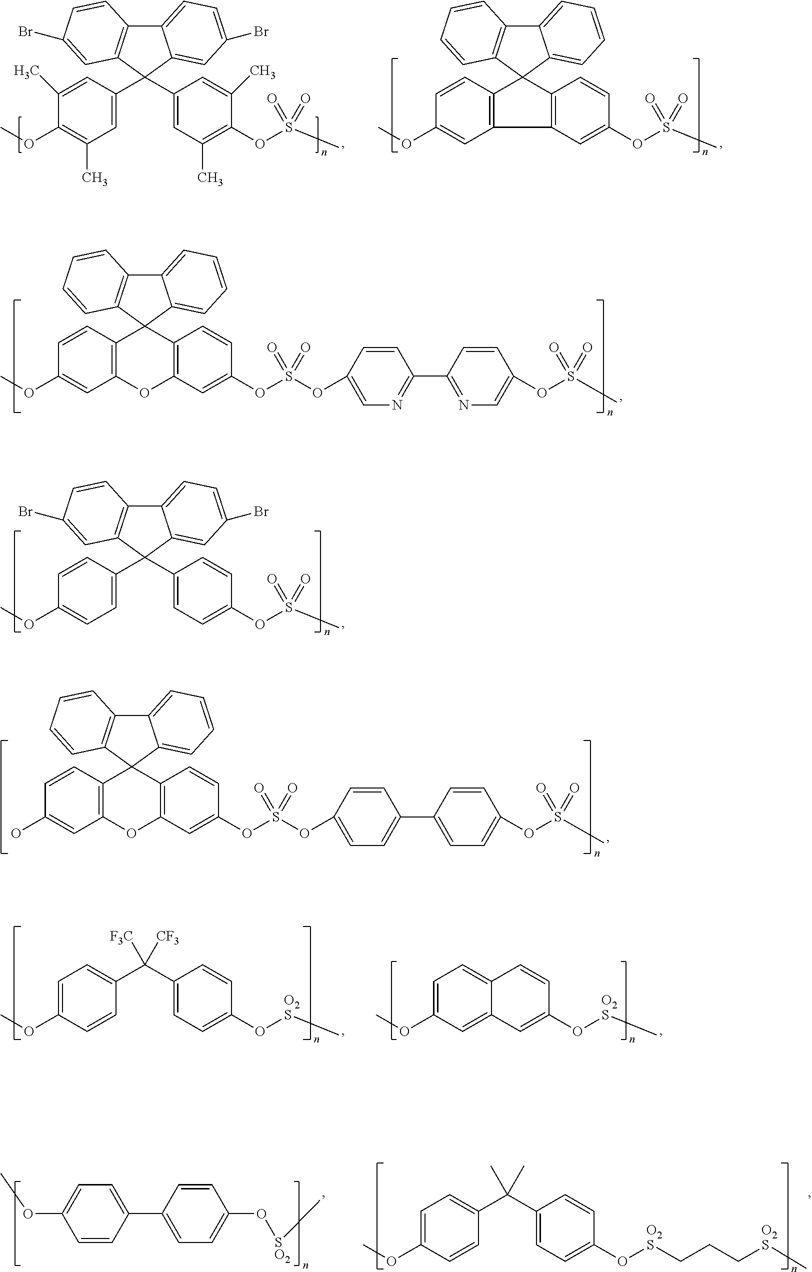

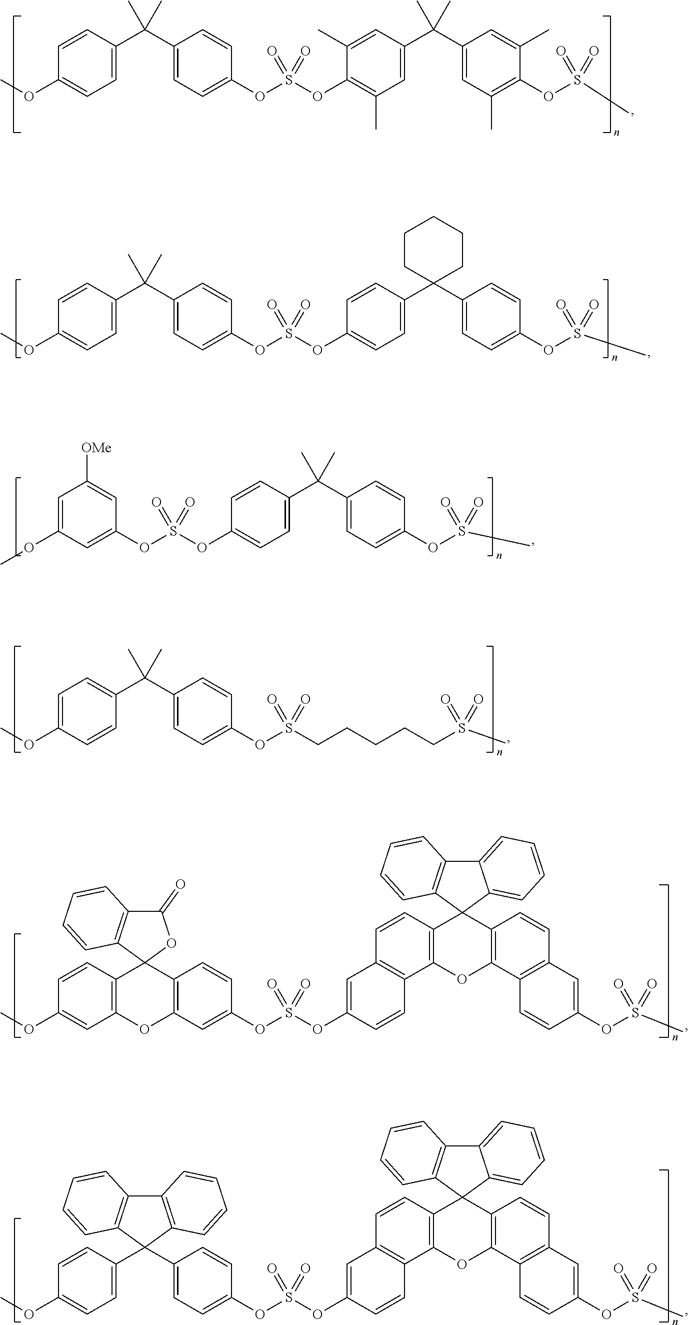

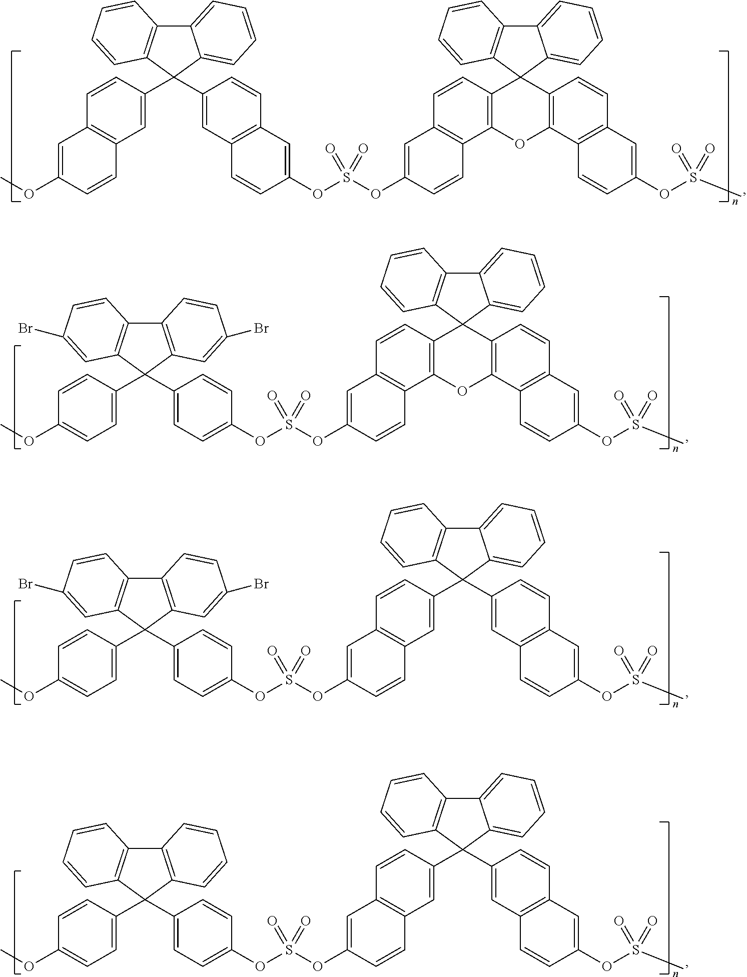

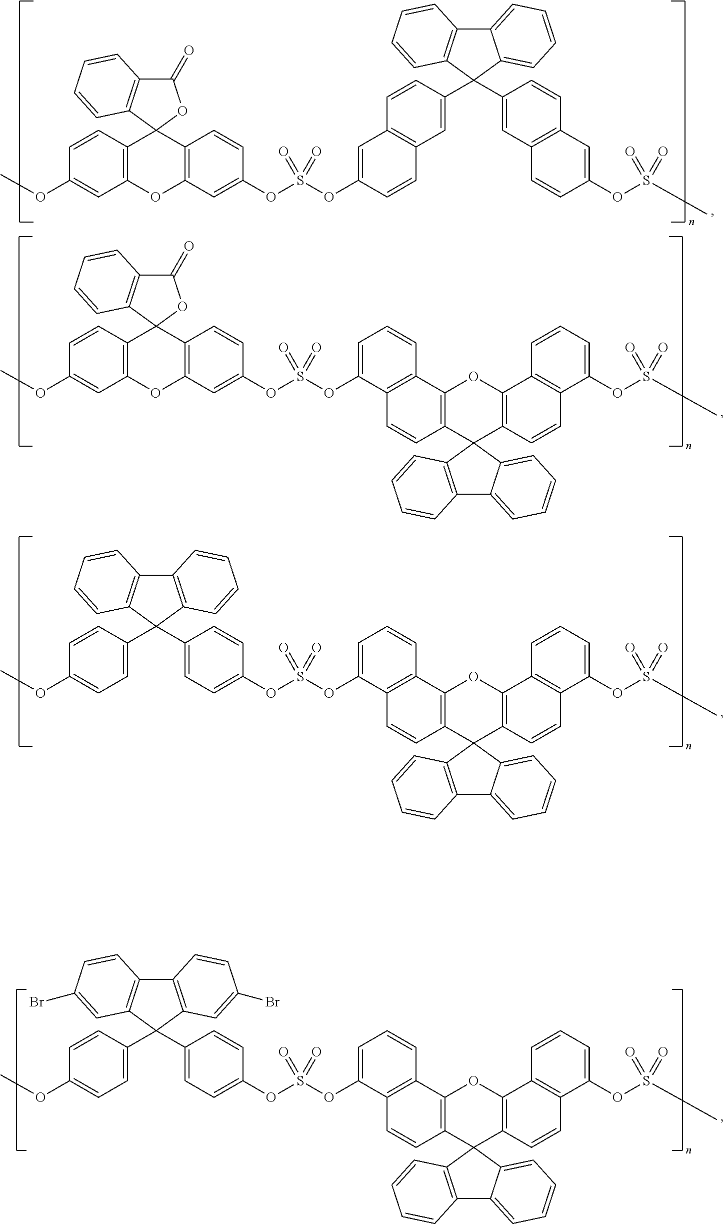

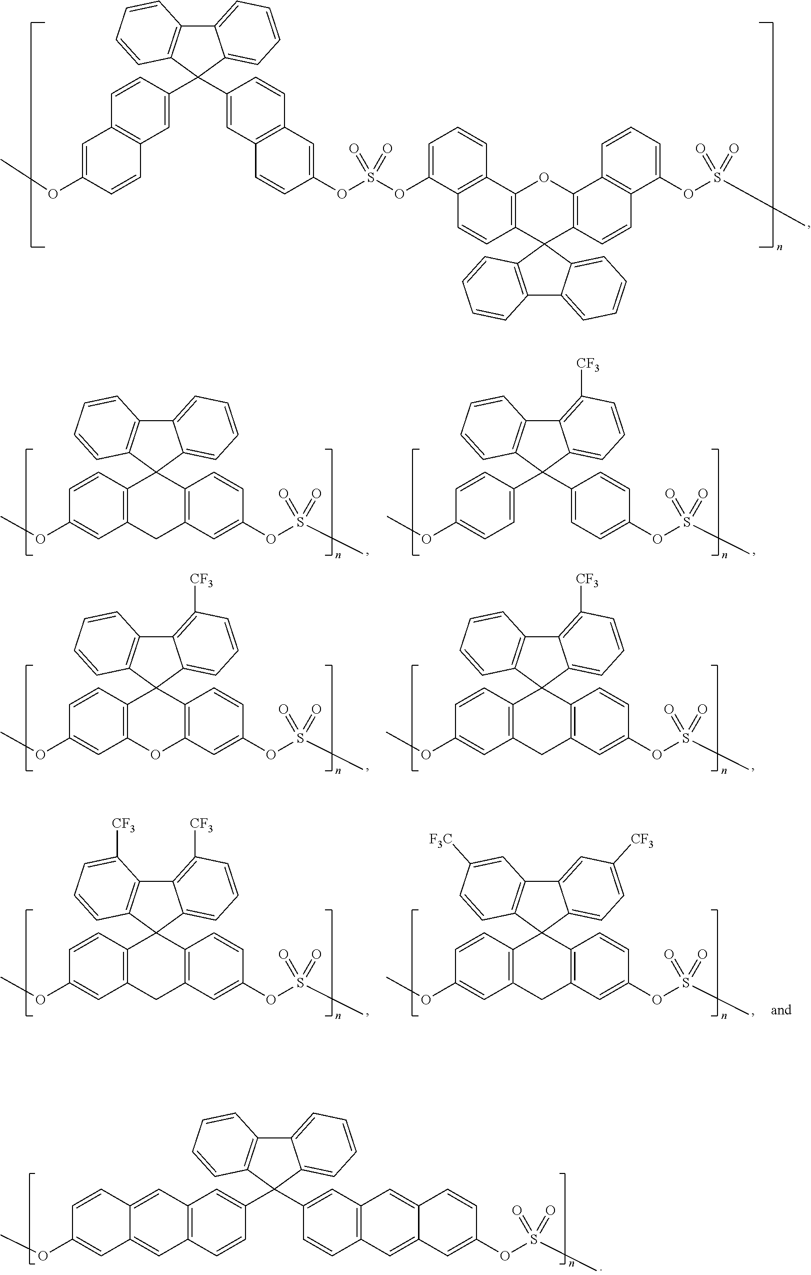

45. The electrostatic energy storage device of any one of claims 30 to 36, wherein the polymer or Formula I is a polymer of Formula IV: 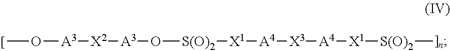
wherein:
A³ and A⁴ independently are divalent aryl moieties;
X¹ is O or a covalent bond;
X² is selected from S(O)₂, O, S, C(═O), a covalent bond, and Z(R¹)(R²)
X³ is selected from S(O)₂, O, S, C(═O), a covalent bond, and Z(R³)(R⁴);
Z is carbon or silicon;
R¹ is selected from the group consisting of aryl, arylalkyl, alkylaryl, and an alkyl comprising at least four carbons; R² is selected from the group consisting of H, halogen, alkyl, aryl, arylalkyl, and alkylaryl; or R¹ and R² together constitute a first divalent substituent, and the first divalent substituent together with Z constitutes a hydrocarbon ring or heterocyclic ring;
R³ is selected from the group consisting of aryl, arylalkyl, alkylaryl, and an alkyl comprising at least four carbons; R⁴ is selected from the group consisting of H, halogen, alkyl, aryl, arylalkyl, and alkylaryl; or R³ and R⁴ together constitute a second divalent substituent, and the second divalent substituent together with Z constitutes hydrocarbon ring or heterocyclic ring;
n is the average number of repeating units within the brackets of the formula and has a value sufficient to provide a number average molecular weight (Mₙ) of at least about 7,000 g mol⁻¹, as determined by SEC using styrene-divinyl benzene columns, DMF/0.2% LiBr elution solvent, and polystyrene molecular weight standards; and
each divalent aryl group and divalent substituent independently is unsubstituted or is substituted by one or more substituent selected from halogen, alkyl, aryl, arylalkyl, alkylaryl, alkoxy, and aryloxy.

46. The electrostatic energy storage device of claim 45, wherein Z is carbon.

46. The electrostatic energy storage device of any one of claims 22 to 45 wherein the dielectric polymer film has a thickness in the range of about 1 to about 15 μm.

47. The electrostatic energy storage device of any one of claims 30 to 46, wherein the conductive layers are metal films coated on the dielectric polymer film.

48. The electrostatic energy storage device of any one of claims 30 to 46, wherein the conductive layers are metal foils.

49. The electrostatic energy storage device of any one of claims 30 to 46, wherein the multilayer structure is in the form of a rolled cylinder, with an electrically insulating layer of a second dielectric polymer film comprising the polymer of Formula I disposed in the roll between turns of the multilayer structure.

50. An electrostatic energy storage device comprising a plurality of stacked, electrically connected first conductive layers; and a plurality of stacked, electrically connected second conductive layers; wherein the first conductive layers are interleaved with the second conductive layers in alternating sequence; and wherein each of the first conductive layers is electrically insulated from each adjacent second conductive layer by an intervening layer of the dielectric film of any one of claims 1 to 21 that lacks the coating of the inorganic dielectric material.
